(19) United States
(12) Patent Application Publication
(10) Pub. No.: US 2026/0268360 A1
(43) Pub. Date: Sep. 10, 2026

(54) INFORMATION PROCESSING DEVICE, INFORMATION PROCESSING METHOD, AND PROGRAM

(71) Applicant: Sony Group Corporation, Tokyo (JP)

(72) Inventors: Satoru Okamoto, Kanagawa (JP); Godai Suzuki, Kanagawa (JP); Masatoshi Funabashi, Tokyo (JP); Tomoyuki Minami, Tokyo (JP)

(73) Assignee: Sony Group Corporation, Tokyo (JP)

(21) Appl. No.: 19/165,664

(22) PCT Filed: Sep. 21, 2023
(86) PCT No.: PCT/JP2023/034202

§ 371 Date: Sep. 16, 2025

(30) Foreign Application Priority Data
Mar. 30, 2023 (JP) 2023-054924

(51) Int. Cl. G06Q 30/0201

(52) U.S. Cl. CPC G06Q 30/0206

(57) ABSTRACT

The present technology relates to an information processing device, an information processing method, and a program that enable appropriate evaluation of a place such as a farm field.

The evaluation unit evaluates a transition degree of index values, based on a plurality of the index values relating to soil or organisms at a predetermined time point of a predetermined target place and a plurality of the index values at a time point later than the predetermined time point. The present technology can be applied to the case of evaluating a place such as a farm field where various agricultural methods are implemented.

### TECHNICAL FIELD

The present technology relates to an information processing device, an information processing method, and a program, and particularly relates to an information processing device, an information processing method, and a program that enable appropriate evaluation of a place such as a farm field, for example.

### BACKGROUND ART

As an evaluation method for evaluating a farm field of a prevalent farming (conventional farming, organic farming, natural farming, and the like), there is a method of examining whether the farm field is suitable for growth of a specific plant species using an index value related to soil.

For example, in a conventional farming using a chemical fertilizer, a value of a physical or chemical characteristic of soil such as the concentration or pH of various inorganic ions is used as an index value, and whether the index value is within a target range is evaluated. In addition, for example, in the case of organic farming or natural farming, substance metabolism by soil microorganism activity is evaluated in order to examine whether so-called soil making is successfully performed. For example, PTL 1 describes a method of using values relating to the number of soil bacteria, nitrogen, phosphorus, and potassium as index values.

In any of the evaluation methods, whether the index value falls within a certain range in the farm field is evaluated.

### CITATION LIST

### Patent Literature

[PTL 1]
WO 2010/107121

### SUMMARY

### Technical Problem

In recent years, Synecoculture (registered trademark) has been attracting attention, which produces useful plants in an ecologically optimized state while species diversity is realized that exceeds a natural state by vegetation arrangement on the basis of thinned harvest from mixed dense under constraint conditions that no tillage, no fertilization, no pesticide, and nothing other than seed or seedling are brought in at all. In accordance with Synecoculture (registered trademark), it is possible to construct an extended ecosystem in which various plant species are introduced and in which biological diversity and an ecosystem function are enhanced.

In Synecoculture (registered trademark), the growth of plants does not depend on residual fertilizer, but depends on substance metabolism caused by a biological interaction due to biological diversity. In addition, in Synecoculture (registered trademark), no plowing, no fertilization, and no pesticide are used as a principle, and large-scale soil improvement or the like is not performed except for initial construction, and the productivity is improved depending on the self-organization of the ecosystem. As a result, the index value may vary according to various environmental conditions and vegetation transition of the farm field. Therefore, it is difficult to appropriately evaluate the farm field by evaluating whether the index value falls within a certain range in the farm field.

There is a demand for proposal of a technique capable of appropriately evaluating not only the farm field of Synecoculture (registered trademark) but also various places.

The present technology has been made in view of such a situation, and makes it possible to appropriately evaluate a place such as a farm field.

### Solution to Problem

An information processing device or a program of the present technology is an information processing device including an evaluation unit that evaluates a transition degree of an index value, based on a plurality of index values related to soil or an organism at a predetermined time point in a predetermined target place and the plurality of index values at a time point later than the predetermined time point, or a program for causing a computer to function as such an information processing device.

An information processing method of the present technology is an information processing method including evaluating a transition degree of index values, based on a plurality of the index values relating to soil or organisms at a predetermined time point of a predetermined target place and a plurality of the index values at a time point later than the predetermined time point.

In the information processing device, the information processing method, and the program of the present technology, a transition degree of index values is evaluated based on a plurality of the index values relating to soil or organisms at a predetermined time point of a predetermined target place and a plurality of the index values at a time point later than the predetermined time point.

The information processing device may be an independent device or an internal block constituting one device.

The program can be provided by being recorded in a recording medium or by being transmitted over a transmission medium.

### BRIEF DESCRIPTION OF DRAWINGS

FIG. 1 is a diagram illustrating an example of the configuration of an embodiment of an information processing system to which the present technology is applied.

FIG. 2 is a diagram illustrating an example of the hardware configuration of a terminal 11.

FIG. 3 is a diagram illustrating an example of the hardware configuration of a server 12.

FIG. 4 is a diagram for explaining an outline of an example of processing of the server 12.

FIG. 5 is a block diagram illustrating an example of a first functional configuration of the server 12.

FIG. 6 is a flowchart for explaining an example of processing of the server 12.

FIG. 7 is a block diagram illustrating a configuration example of an evaluation unit 42.

FIG. 8 is a diagram for explaining an example of calculation of a degree of difference between two distributions as a deviation degree.

FIG. 9 is a diagram illustrating an example of acquisition of index values (an attention index value, a pre-transition index value, and the like).

FIG. 10 is a diagram illustrating an example of a data set of index values transmitted from the terminal 11 to the server 12.

FIG. 11 is a diagram for explaining an example of calculation of distribution information regarding distribution of index values by a distribution estimation unit 51.

FIG. 12 is a diagram illustrating an example of distribution of index average values respectively for the attention index values and the pre-transition index values.

FIG. 13 is a diagram illustrating an example of distribution of index deviations respectively for the attention index values and the pre-transition index values.

FIG. 14 is a flowchart for explaining a first example of processing of evaluating a transition degree of an index value in step S12.

FIG. 15 is a diagram illustrating an example of transition of ecosystem management and distribution of index values.

FIG. 16 is a flowchart for explaining a second example of processing of evaluating a transition degree of the index value in step S12.

FIG. 17 is a flowchart for explaining an example of processing of evaluating a transition degree based on a variation of distribution of index values in step S32.

FIG. 18 is a flowchart for explaining an example of processing of evaluating a transition degree based on a center and variation of distribution of index values in step S33.

FIG. 19 is a flowchart for explaining an example of processing of evaluating a transition degree based on both a difference between the centers and a difference between variations of distribution of the attention index values and distribution of the pre-transition index values in step S54.

FIG. 20 is a flowchart for explaining an example of processing of evaluating a transition degree based on a difference between variations of the distribution of the attention index values and the distribution of the pre-transition index values in step S55.

FIG. 21 is a block diagram illustrating an example of a second functional configuration of the server 12.

FIG. 22 is a diagram illustrating an example of a land use history.

FIG. 23 is a diagram illustrating an example of an index information DB.

FIG. 24 is a block diagram illustrating a configuration example of an evaluation unit 72.

FIG. 25 is a block diagram illustrating an example of a third functional configuration of the server 12.

FIG. 26 is a block diagram illustrating a configuration example of an evaluation unit 92.

FIG. 27 is a diagram illustrating an example of processing of calculating a transition degree by a comparison unit 112.

FIG. 28 is a block diagram illustrating an example of a fourth functional configuration of the server 12.

FIG. 29 is a block diagram illustrating a configuration example of an evaluation unit 121.

FIG. 30 is a diagram illustrating an example of a vegetation profile generated by a vegetation profile generation unit 131.

FIG. 31 is a diagram illustrating an example of a fertilizer removal stage table referred to by a similarity calculation unit 132.

FIG. 32 is a block diagram illustrating an example of a fifth functional configuration of the server 12.

FIG. 33 is a block diagram illustrating a configuration example of an evaluation unit 141.

FIG. 34 is a diagram illustrating an example of a yield profile generated by a yield profile generation unit 151.

FIG. 35 is a diagram illustrating an example of a fertilizer removal stage table referred to by a similarity calculation unit 152.

FIG. 36 is a block diagram illustrating an example of a sixth functional configuration of the server 12.

FIG. 37 is a block diagram illustrating a configuration example of a combination unit 161 in a case where a test statistic is adopted as a difference degree between the distribution of the attention index values and the distribution of the pre-transition index values indicating the transition degree of the index value.

FIG. 38 is a diagram illustrating an example of distribution of attention index values, distribution of pre-transition index values, and distribution of target index values.

FIG. 39 is a diagram for explaining an example of normalization of a test statistic as a transition degree in a normalization combination unit 173.

FIG. 40 is a diagram for explaining an example of normalization of a fertilizer removal stage by the normalization combination unit 173.

FIG. 41 is a block diagram illustrating an example of a seventh functional configuration of the server 12.

FIG. 42 is a block diagram illustrating an example of an eighth functional configuration of the server 12.

FIG. 43 is a diagram illustrating a first display example of a presentation UI.

FIG. 44 is a diagram illustrating a second display example of the presentation UI.

FIG. 45 is a diagram illustrating a third display example of the presentation UI.

FIG. 46 is a diagram illustrating a display example of the presentation UI functioning as an input I/F for inputting a vegetation survey result.

FIG. 47 is a diagram illustrating a presentation UI 410 in a state in which an individual coverage is input until the total value of the individual coverages input to an individual coverage display unit 414 coincides with the maximum value of the bar of a status display unit 416.

FIG. 48 is a diagram illustrating a presentation UI 410 in a state in which an individual coverage is input until the total value of the individual coverages input to an individual coverage display unit 414 exceeds the maximum value of the bar of a status display unit 416.

FIG. 49 is a diagram illustrating a first display example of a presentation UI that presents functional diversity.

FIG. 50 is a diagram illustrating a second display example of the presentation UI that presents functional diversity.

FIG. 51 is a diagram for explaining a CSR triangle.

FIG. 52 is a diagram illustrating another display example of a presentation UI 430.

FIG. 53 is a diagram illustrating still another display example of the presentation UI 430.

FIG. 54 is a diagram illustrating a third display example of the presentation UI that presents functional diversity.

FIG. 55 is a diagram illustrating a fourth display example of the presentation UI that presents functional diversity.

FIG. 56 is a diagram illustrating a display example of a presentation UI that presents a time series of vegetation survey results.

### DESCRIPTION OF EMBODIMENTS

### <One Embodiment of Information Processing System to Which Present Technology is Applied>

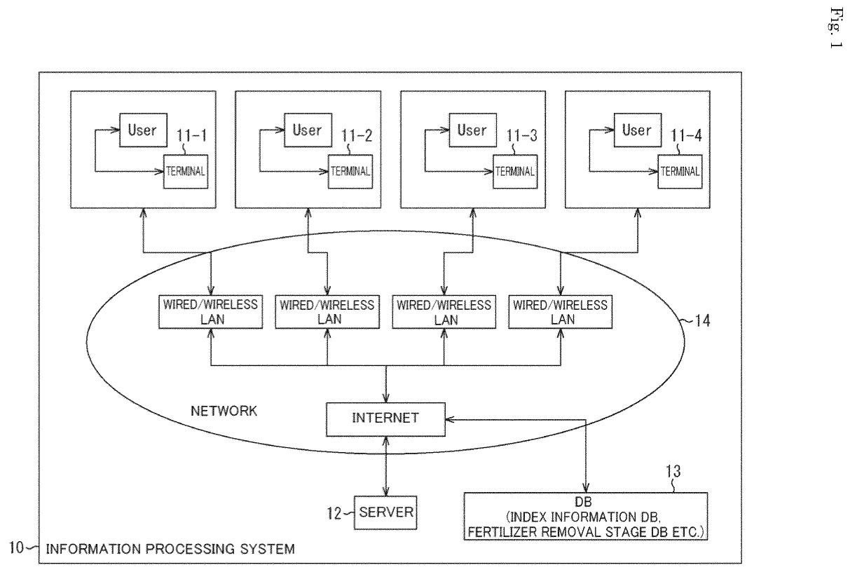

FIG. 1 is a diagram illustrating an example of the configuration of an embodiment of an information processing system to which the present technology is applied.

An information processing system 10 appropriately evaluates a place by evaluating the transition degree of the index value of a predetermined place based on the index value related to the ecosystem of the predetermined place. That is, the information processing system 10 appropriately evaluates the target place by evaluating the transition degree of the index value based on a plurality of index values related to the soil or the organism at a predetermined time point of the target place for which the index value is to be evaluated and a plurality of index values at a time point later than the predetermined time point.

As the target place, for example, a place (farm field) where various agricultural methods such as Synecoculture (registered trademark) are practiced, or any other place can be adopted. In the present embodiment, the farm field is adopted as the target place, and the farm field as the target place is also referred to as a target farm field.

According to the transition degree evaluated in the information processing system 10, for example, in a case where the ecosystem management of the target farm field transitions (changes), the user can easily evaluate (grasp) the degree of the influence of the post-transition ecosystem management on the target farm field. Alternatively, the user can easily evaluate the degree to which the influence of the pre-transition ecosystem management remains in the target farm field.

In addition, for example, in a case where the agricultural method practiced in the target farm field as the ecosystem management transitions from the conventional farming or the organic farming to the Synecoculture (registered trademark), the transition degree can be used for certification regarding Synecoculture (registered trademark). For example, in a case where a certification system for authenticating that the farm field is an agricultural farm (synecoculture farm field) in which Synecoculture (registered trademark) is practiced or that the crop (harvest) of the farm field is a crop (synecoculture crop) grown in Synecoculture (registered trademark) is established, the transition degree can be used for the certification. For example, the transition degree can be used as an index for determining whether the farm or the crop is a synecoculture farm or a synecoculture crop.

Furthermore, the transition degree can be used as a reference for ecosystem management. For example, when the transition degree is large, it can be determined that the specific measures of the post-transition ecosystem management are appropriate and that the measures should be maintained. On the other hand, when the transition degree is small, it is possible to determine that the specific measures of the post-transition ecosystem management are inappropriate and that the measures should be changed.

The information processing system 10 includes one or more terminals 11-i, one or more servers 12, and a database (DB) 13. The terminal 11-i, the server 12, and the DB 13 can communicate with each other via a network 14 including a wired local area network (LAN), a wireless LAN, the Internet, a mobile communication network such as 5G, or the like.

In FIG. 1, four terminals 11-1, 11-2, 11-3, and 11-4 are provided as the terminal 11-i. However, as the number of terminals 11-i, 1 to 3, or 5 or more can be adopted. Hereinafter, the terminals 11-1, 11-2, 11-3, and 11-4 will be referred to as a terminal 11 unless it is particularly necessary to distinguish them.

Furthermore, in FIG. 1, one server 12 is provided as the server 12, but a plurality of servers 12 can be provided. In a case where a plurality of servers 12 are provided, the plurality of servers 12 can be caused to perform processing described below in a distributed manner. In addition, the terminals 11 which the servers 12 handle can be assigned, and each server 12 can be caused to perform processing only for the terminals 11 which that server 12 handles.

In addition, the information processing system 10 can cause the terminal 11 to perform some or all of the processing performed by the server 12. If the terminal 11 is to perform all the processing performed by the server 12, the information processing system 10 can be configured without the server 12.

The terminal 11 includes, for example, a personal computer (PC) or the like, and is operated by the user. In addition, the terminal 11 can be configured by a mobile terminal (device) such as a smartphone or smart glasses.

The user can input necessary information by operating the terminal 11. For example, the user can operate the terminal 11 to input the index value regarding the ecosystem of the target farm field acquired (measured) from the target farm field. As the index value related to the ecosystem, for example, there is an index value related to the soil or the organism of the target farm field.

Examples of the index value related to the soil include values serving as physical, chemical, and biological indexes of the soil. Examples of the physical index of soil include soil hardness and soil water permeability, examples of the chemical index include various ion concentrations, and examples of the biological index include microbial diversity (in soil).

Examples of the index value related to organisms include (organism) diversity of insects, plants, and the like, patterns of plant species constituting vegetation (for example, the coverage of each plant species, and the like), chemical components contained in plants (for example, the type, amount, and the like of the component), and the like.

Note that, in the following description, in order to simplify the description, one kind of index value is treated as the index value related to the ecosystem, but a plurality of kinds of index values can also be treated. In a case where a plurality of types of index values are handled as the index values related to the ecosystem, the index value related to the ecosystem is a vector having a plurality of types of index values as elements.

The user can acquire one or more, for example, a plurality of index values related to the ecosystem of the target farm field from one or more, for example, a plurality of locations of the target farm field at two different time points, and can input the index values by operating the terminal 11.

The terminal 11 transmits (a plurality of) index values and the like at each of the two time points input according to the operation of the user to the server 12 (via the network 14).

The terminal 11 receives, for example, an image as a presentation user interface (UI) that presents the transition degree of the index value of the target farm field and the like transmitted from the server 12 (via the network 14). For example, the terminal 11 presents the transition degree of the index value of the target farm field to the user by displaying the presentation UI (alternatively, it is output by voice).

The server 12 calculates the transition degree of the index value of the target farm field based on the index value (related to the ecosystem) of the target farm field.

For example, the server 12 receives index values and the like at two time points of the target farm field transmitted from the terminal 11 (via the network 14). The server 12 evaluates (calculates) a transition degree which is a degree of change in the index value of the target farm field from a first time point which is a past time point of the two time points to a second time point which is the other (future) time point based on the index values of the two time points from the terminal 11. The server 12 generates a presentation UI that presents the transition degree of the index value of the target farm field and the like, and transmits the presentation UI to the terminal 11 (via the network 14).

The server 12 refers to the DB 13 (via the network 14) as necessary, and performs processing using the information stored in the DB 13.

The DB 13 stores big data as various types of information. For example, the DB 13 includes an index information DB, a fertilizer removal stage DB, and the like.

The index information DB stores various land use methods and index information of an index value related to an ecosystem in a case where the land is used by the land use methods in association with each other.

The fertilizer removal stage DB stores a fertilizer removal stage table in which each stage of fertilizer removal (fertilizer removal stage) is associated with a state of an ecosystem at the stage, for example, a state of vegetation (for example, the coverage of each plant species, and the like) or a state of harvest (for example, the yield (per unit area) of each crop).

### <Example of Hardware Configuration of Terminal 11 and Server 12>

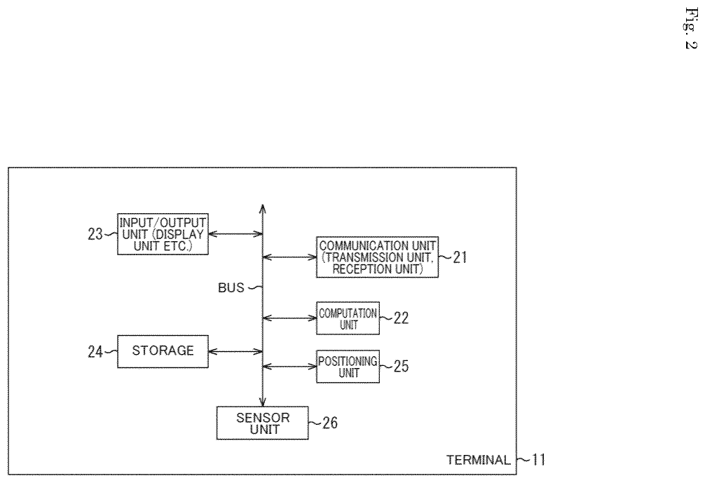

FIG. 2 is a diagram illustrating an example of the hardware configuration of the terminal 11.

The terminal 11 includes a communication unit 21, a computation unit 22, an input/output unit 23, a storage 24, a positioning unit 25, and a sensor unit 26. The units from the communication unit 21 to the sensor unit 26 are connected to each other by a bus such that the units can exchange information.

The communication unit 21 functions as a transmission unit and a reception unit that transmit and receive information, respectively, over the network 14.

The computation unit 22 includes a processor such as a central processing unit (CPU) or a digital signal processor (DSP), and performs various processing by executing a program recorded in the storage 24.

The input/output unit 23 includes a keyboard, a touch panel, a microphone, and the like, and receives various inputs such as an operation from the user. Furthermore, the input/output unit 23 includes a speaker and a display (display unit), and presents information to the user by outputting sound, displaying an image, or the like.

The storage 24 includes a semiconductor memory such as a random access memory (RAM) or a nonvolatile memory, a solid state drive (SSD), a hard disk drive (HDD), or the like. A program executed by the computation unit 22, data necessary for processing of the computation unit 22, and the like are recorded (stored) in the storage 24.

The programs executed by the computation unit 22 can be installed on a computer serving as the terminal 11 from, for example, a removable recording medium such as a digital versatile disc (DVD) or a memory card. Furthermore, for example, the program can be downloaded to the computer as the terminal 11 via the network 14 or the like and installed in the storage 24.

The positioning unit 25 is implemented by a global positioning system (GPS), for example, and measures the position (positioning) of the terminal 11 and outputs position information expressing that position, such as latitude and longitude (and the necessary altitude).

The sensor unit 26 includes, for example, various sensors such as a camera, a distance measuring sensor, a temperature sensor, and a humidity sensor, performs various types of sensing, for example, capturing an image, detecting a distance, detecting a temperature, detecting humidity, and the like, and outputs an image as a sensing result, a distance, a temperature, humidity, and the like.

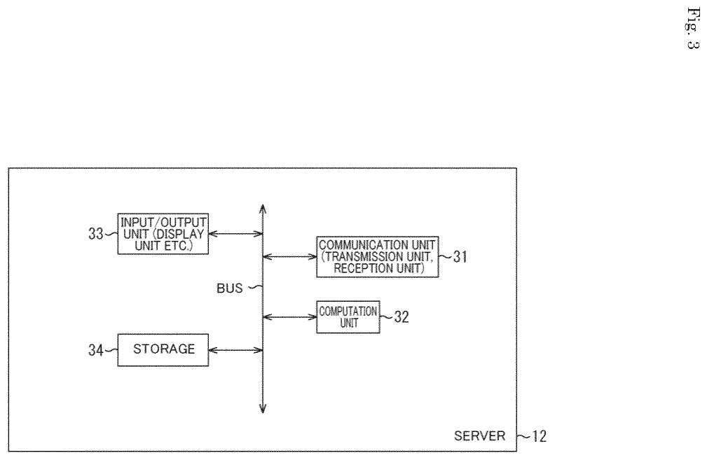

FIG. 3 is a diagram illustrating an example of the hardware configuration of the server 12.

The server 12 includes a communication unit 31, a computation unit 32, an input/output unit 33, and a storage 34. Since the communication unit 31 to the storage 34 are configured similarly to the communication unit 21 to the storage 24 in FIG. 2, the description thereof will be omitted. Note that, as the communication unit 31 to the storage 34, those having higher performance such as capacity and processing speed than the communication unit 21 to the storage 24 can be adopted.

### <Outline of Example of Processing of Server 12>

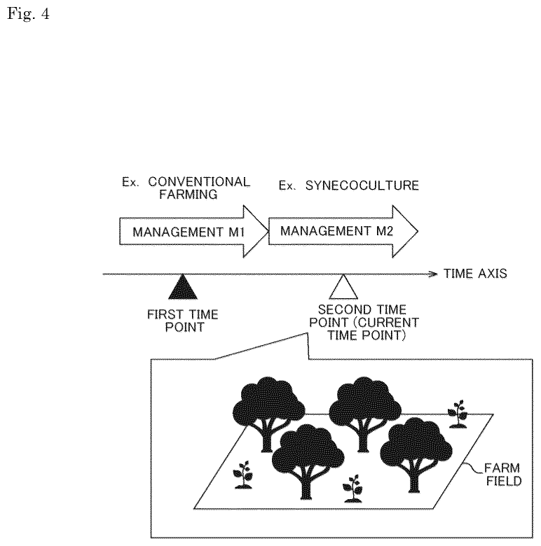

FIG. 4 is a diagram for explaining an outline of an example of processing of the server 12.

The server 12 evaluates (calculates) the transition degree of the index value of the target farm field based on a plurality of (the same type of) index values of the target farm field at the first time point and the second time point as two time points.

The first time point and the second time point are not particularly limited, except that the first time point is a temporally earlier time point and the second time point is a temporally later time point.

As the second time point, for example, the current time point can be adopted.

As the first time point, for example, an arbitrary time point within a period in which an ecosystem management M1 performed immediately before an ecosystem management M2 performed in the target farm field at the current time point being the second time point is performed can be adopted. In FIG. 4, the ecosystem managements M1 and M2 are (implementation of) conventional farming and Synecoculture (registered trademark), respectively.

The transition degree of the index value evaluated based on the index value at a certain time point when the ecosystem management M1 is performed and the index value at a certain time point when the subsequent ecosystem management M2 is performed can also be regarded as the transition degree of the state of the ecosystem of the target farm field from the state influenced by the ecosystem management M1 to the state influenced by the ecosystem management M2 or the degree of influence of the ecosystem management M2 on the ecosystem.

According to the transition degree of the index value, for example, the user can grasp the transition degree of the state of the ecosystem from the state when the ecosystem management M1 is performed on the direction of the state aimed by the ecosystem management M2. Furthermore, the user can compare the degree of influence of the ecosystem management M2 received by the two farm fields by referring to the transition degree of the two farm fields in which the ecosystem management transitions from the ecosystem management M1 to the ecosystem management M2.

Note that, in FIG. 4, a time point at which the ecosystem management M1 is performed and a time point at which the ecosystem management M2 transitioned from the ecosystem management M1 is performed are adopted as the first time point and the second time point, respectively. As the first time point and the second time point, for example, different time points at which the same management is performed can be adopted. For example, the current time point and the time point immediately after the start of the ecosystem management performed at the current time point can be adopted as the first time point and the second time point, respectively. In this case, according to the transition degree, it is possible to evaluate (grasp) how much the influence of the ecosystem management performed at the present time has reached the target farm field.

Hereinafter, a time point at which a certain ecosystem management is performed is adopted as the first time point, and a time point at which the next ecosystem management (another ecosystem management) transferred from the ecosystem management is performed is adopted as the second time point.

### <Example of First Functional Configuration of Server 12>

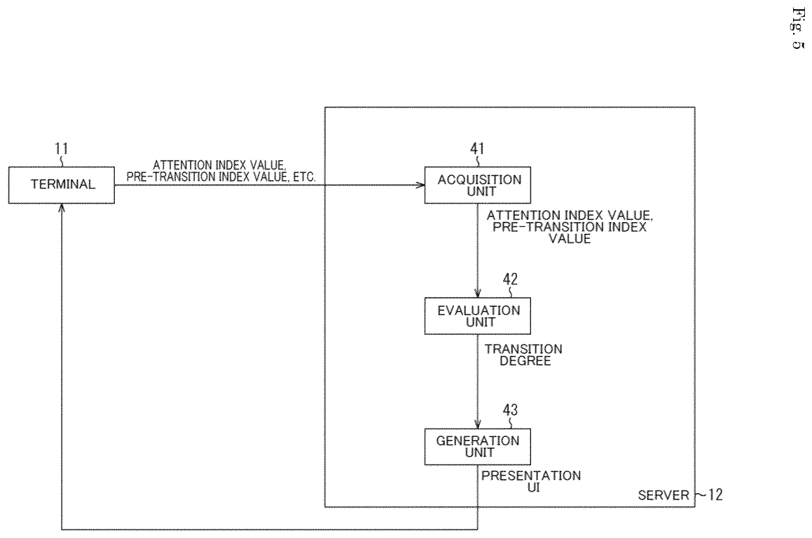

FIG. 5 is a block diagram illustrating an example of a first functional configuration of the server 12.

The functional configuration of the server 12 is implemented functionally by the computation unit 32 in FIG. 3 executing a program.

In FIG. 5, the server 12 includes an acquisition unit 41, an evaluation unit 42, and a generation unit 43.

The acquisition unit 41 receives and acquires various types of information such as the attention index value and the pre-transition index value transmitted from the terminal 11.

The attention index value is an index value related to an ecosystem of a target farm field at an arbitrary attention time point within a period in which a certain ecosystem management is performed on the target farm field, for example, a current time point. The pre-transition index value is an index value related to the ecosystem of the target farm field at an arbitrary time point (hereinafter, also referred to as pre-transition time point) within a period in which the ecosystem management immediately before the transition to the ecosystem management at the attention time point is performed on the target farm field. The ecosystem management at the attention time point is also referred to as attention management, and the ecosystem management immediately before transitioning to the attention management is also referred to as pre-transition management.

The acquisition unit 41 supplies the acquired information to a necessary block. For example, the acquisition unit 41 supplies the attention index value and the pre-transition index value to the evaluation unit 42.

The evaluation unit 42 evaluates (calculates) the transition degree of the index value based on the attention index value and the pre-transition index value from the acquisition unit 41, and supplies the transition degree as an evaluation result to the generation unit 43.

The generation unit 43 generates a presentation UI that presents various types of information to the user. For example, the generation unit 43 generates a presentation UI that presents the transition degree of the index value from the evaluation unit 42 and information regarding other target farm field, and transmits the presentation UI to the terminal 11.

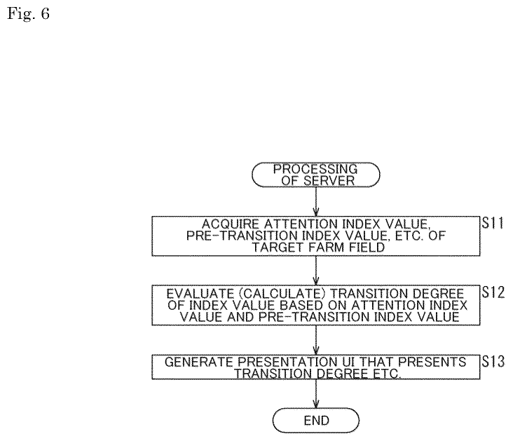

FIG. 6 is a flowchart for explaining an example of processing of the server 12 in FIG. 5.

In step S11, the acquisition unit 41 acquires the attention index value, the pre-transition index value, and the like transmitted from the terminal 11, supplies the attention index value, the pre-transition index value, and the like to the evaluation unit 42, and the process proceeds to step S12.

In step S12, the evaluation unit 42 evaluates (calculates) the transition degree of the index value based on the attention index value and the pre-transition index value from the acquisition unit 41 and supplies the transition degree to the generation unit 43, and the process proceeds to step S13.

In step S13, the generation unit 43 generates a presentation UI that presents the transition degree of the index value from the evaluation unit 42 and the like and transmits the presentation UI to the terminal 11, and the process ends.

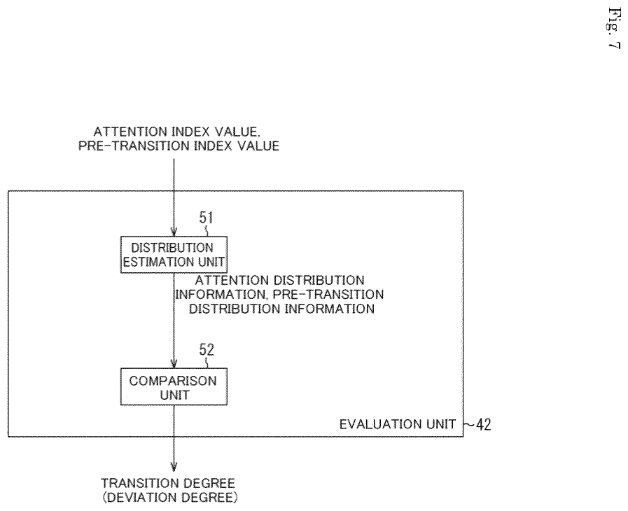

FIG. 7 is a block diagram illustrating a configuration example of the evaluation unit 42 in FIG. 5.

In FIG. 7, the evaluation unit 42 includes a distribution estimation unit 51 and a comparison unit 52.

The attention index value and the pre-transition index value from the acquisition unit 41 (FIG. 5) are supplied to the distribution estimation unit 51. Based on the attention index value, the distribution estimation unit 51 calculates (estimates) the attention distribution information regarding the distribution of the attention index values, and supplies the attention distribution information to the comparison unit 52. In addition, the distribution estimation unit 51 calculates (estimates) pre-migration distribution information regarding the distribution of the pre-migration index value based on the pre-migration index value, and supplies the pre-migration distribution information to the comparison unit 52.

As the attention distribution information, information of the distribution itself of the attention index value can be adopted. In addition, as the attention distribution information, information regarding the distribution of the average values of the attention index values and information regarding the distribution of the standard deviations (or variance) as the variation of the attention index values can be adopted. For example, in a case where the normal distribution is adopted as the distribution, for example, the information of the distribution itself of the attention index value as the attention distribution information is the average value and the standard deviation (or variance) of the normal distribution representing the distribution of the attention index values. The point described above similarly applies to the pre-transition distribution information. The distribution information can include information of a distribution type such as a normal distribution.

The comparison unit 52 compares the distribution of the attention index values with the distribution of the pre-transition index values based on the attention distribution information and the pre-transition distribution information from the distribution estimation unit 51, and calculates the degree of difference between the distribution of the attention index values and the distribution of the pre-transition index values. That is, the comparison unit 52 calculates the degree of difference between the distribution of the attention index values and the distribution of the pre-transition index values as the deviation degree in which the distribution of the attention index values deviates from the distribution of the pre-transition index values based on the attention distribution information and the pre-transition distribution information. As the deviation degree (degree of difference in distribution), for example, 1 or 0 indicating that the distribution of the attention index values deviates from or does not deviate from the distribution of the pre-transition index values (the distribution is not different or different) can be adopted. As the deviation degree, for example, a value corresponding to the degree to which the distribution of the attention index values deviates from the distribution of the pre-transition index values can be adopted. The comparison unit 52 outputs the deviation degree as the transition degree.

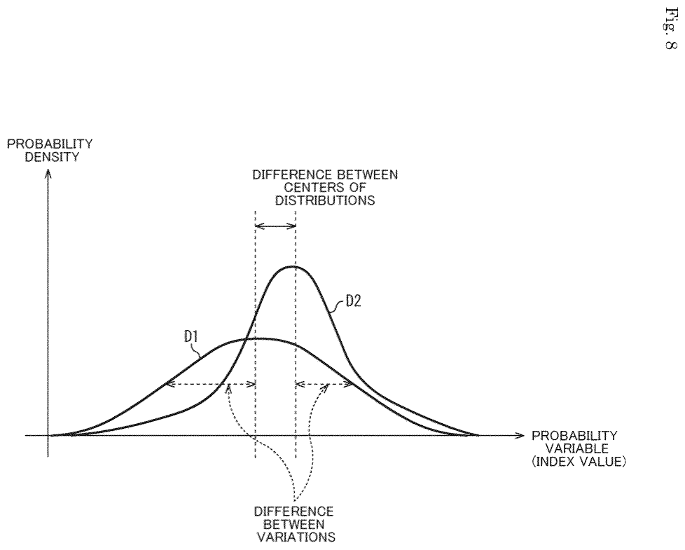

FIG. 8 is a diagram for explaining an example of calculation of a degree of difference between two distributions as a deviation degree.

FIG. 8 illustrates distributions D1 and D2 as examples of two distributions.

A difference between the two distributions D1 and D2 includes a difference between centers of the two distributions D1 and D2 and a difference between variations of the two distributions D1 and D2. The center of the distribution is, for example, a representative value representing the distribution such as an average value, a mode value, and a median value.

In the calculation of the deviation degree at which one of the two distributions D1 and D2 deviates from the other distribution, that is, the degree of difference between the two distributions D1 and D2, a value based on one of the degree of difference between the centers of the two distributions D1 and D2 and the degree of difference between the variations of the two distributions D1 and D2 can be calculated, or a value based on both of the degrees can be calculated.

As the degree of difference (hereinafter, also referred to as a difference degree) between the two distributions D1 and D2, for example, (the magnitude of) the difference between the average values of the two distributions D1 and D2 as the difference degree between the centers of the two distributions D1 and D2, or (the magnitude of) the difference between the standard deviations (or variances) of the two distributions D1 and D2 as the difference degree between the variations of the two distributions D1 and D2, for example, can be adopted. Furthermore, as the difference degree between the two distributions D1 and D2, the product of the difference between the average values of the two distributions D1 and D2 as the difference degree between the centers of the two distributions D1 and D2 and the difference between the standard deviations of the two distributions D1 and D2 as the difference degree between the variations of the two distributions D1 and D2, and the like can be adopted.

In addition, as the difference degree between the two distributions D1 and D2, for example, the presence or absence of a significant difference between the two distributions D1 and D2 by a statistical test (statistical hypothesis test), that is, whether the P value obtained by the statistical test of the difference between the two distributions D1 and D2 is the significance level or less can be adopted. In this case, for example, if there is a significant difference, the difference degree can be set to 1, and if there is no significant difference, the difference degree can be set to 0. In addition, as the difference degree between the two distributions D1 and D2, for example, a test statistic (for example, t-value of t-test, etc.) calculated by a statistical test can be adopted. The larger the value, the larger the difference degree between the two distributions D1 and D2.

Here, in the statistical test of the difference between the two distributions D1 and D2, for example, the t-test, the presence or absence of a significant difference between the average values of the two distributions D1 and D2 is determined. Therefore, in a case where the presence or absence of a significant difference (between the two distributions D1 and D2) by the statistical test is adopted as the difference degree between the two distributions D1 and D2, the difference between the centers of the two distributions D1 and D2 is reflected as the presence or absence of a significant difference between the average values of the two distributions D1 and D2. However, the difference between the variations of the two distributions D1 and D2 is not (substantially) reflected.

Therefore, in a case where the statistical test is adopted to calculate the difference degree between the two distributions D1 and D2, when it is desired to reflect the difference between the variations of the two distributions D1 and D2 in the difference degree, the distributions of the standard deviations as the variations of the distributions D1 and D2 are calculated (estimated), and the statistical test for the distribution of the standard deviations can be used.

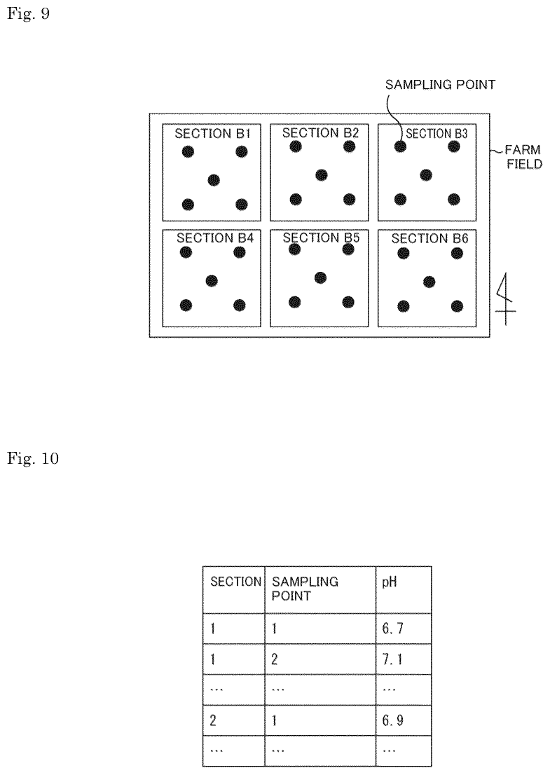

FIG. 9 is a diagram illustrating an example of acquisition of index values (an attention index value, a pre-transition index value, and the like).

In the processing in the information processing system 10, a plurality of sections can be set in the target farm field. The manner of setting the section can be set by the user operating the terminal 11 or can be set by the server 12. In FIG. 9, six sections B1 to B6 having the same shape and size are set in the target farm field.

The user sets a plurality of sampling points at which the index value is acquired (measured) for each section, and acquires the index value at the plurality of sampling points. For example, when the soil pH is adopted as the index value, the user measures the soil pH at the sampling point using a plurality of locations on the soil surface or in the soil of each section as sampling points. As a result, the user acquires a plurality of index values (here, the soil pH) for each section.

The user operates the terminal 11 to input the index value acquired from each section. The terminal 11 transmits the index value input by the user to the server 12.

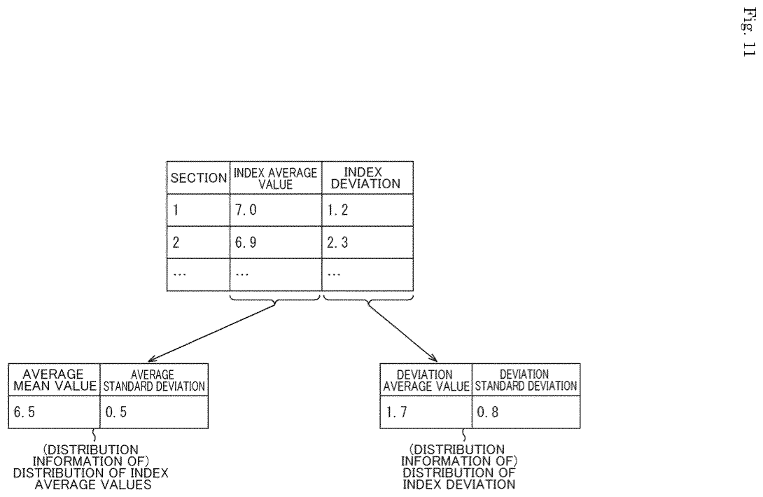

FIG. 10 is a diagram illustrating an example of a data set of index values transmitted from the terminal 11 to the server 12.

In the terminal 11, for example, the soil pH as the index value can be transmitted in association with the information of the section where the soil pH is acquired (measured) and the sampling point as illustrated in FIG. 10. The sampling point information may be omitted.

Note that the user can acquire the index value without setting a section in the target farm field. In this case, the index value is not associated with the section information.

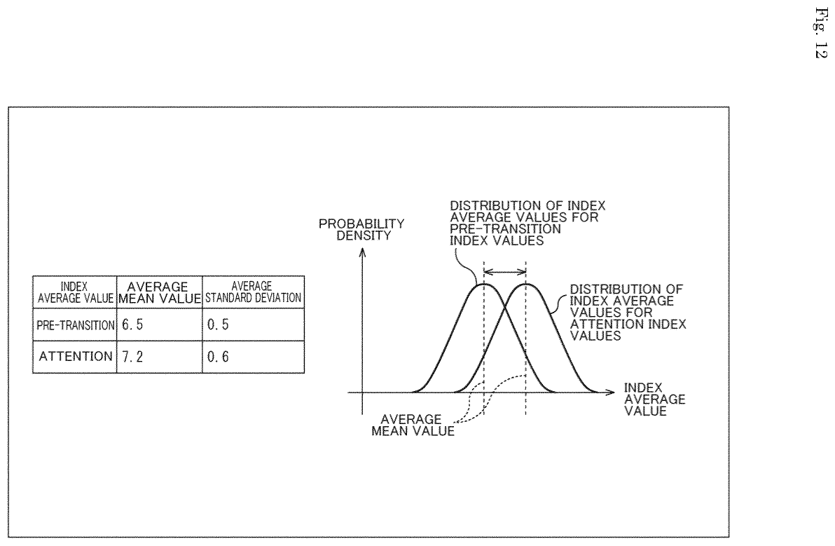

FIG. 11 is a diagram for explaining an example of calculation of distribution information regarding distribution of index values by the distribution estimation unit 51 in FIG. 7.

The distribution estimation unit 51 can calculate the distribution of the index values assuming a predetermined distribution, for example, a normal distribution, as the distribution of the index values of the target farm field. In this case, the average value and the standard deviation (or variance) of the index values defining the distribution of the index values of the target farm field are calculated as the distribution information.

In addition, instead of the distribution of the index values of the target farm field (alternatively, together with the distribution of the index values), the distribution estimation unit 51 can calculate the distribution of the average values of the index values of the target farm field and the distribution of the standard deviations of the index values of the target farm field.

Hereinafter, the average value of the index values is also referred to as an index average value, and the standard deviation of the index values is also referred to as an index deviation.

For example, assuming a normal distribution as the distribution of the index average values, the distribution estimation unit 51 calculates, as the distribution information, the average value of the index average value (hereinafter, also referred to as average mean value) and the standard deviation of the index average value (hereinafter, also referred to as average standard deviation) that define the distribution of the index average values. In addition, the distribution estimation unit 51 calculates, as the distribution of the index deviations, for example, an average value (hereinafter, also referred to as a deviation average value) of the index deviations and a standard deviation (hereinafter, also referred to as a deviation standard deviation) of the index deviations, which define the distribution of the index deviations assuming a normal distribution, as the distribution information.

Specifically, as illustrated in FIG. 11, the distribution estimation unit 51 calculates the average value of the index values as the index average value and calculates the standard deviation of the index values as the index deviation for each section. Then, the distribution estimation unit 51 calculates an average value of the index average values for all the sections as an average mean value, and calculates a standard deviation of the index average values for all the sections as an average standard deviation. Further, the distribution estimation unit 51 calculates an average value of the index deviations for all the sections as a deviation average value, and calculates a standard deviation of the index deviations for all the sections as a deviation standard deviation.

As described above, the distribution estimation unit 51 calculates (the distribution information of) the distribution of the index average values and (the distribution information of) the distribution of the index deviations respectively for the attention index values and the pre-transition index values.

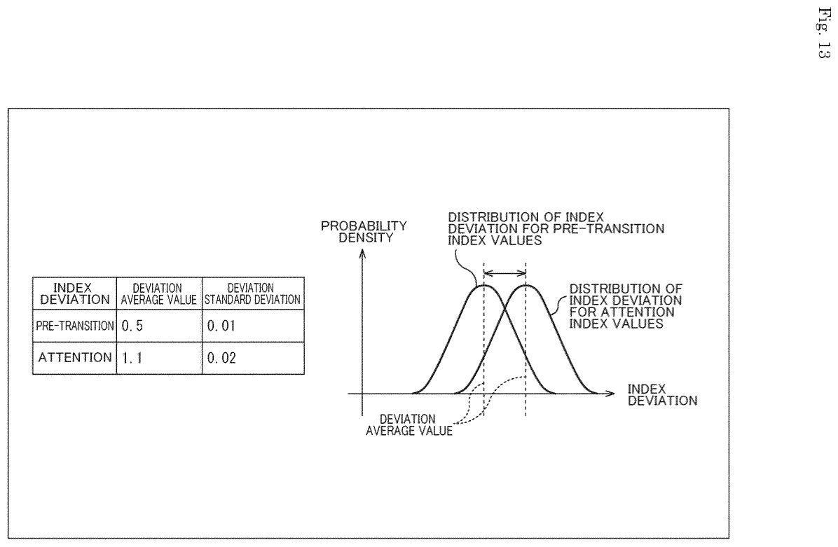

FIG. 12 is a diagram illustrating an example of the distribution of the index average values respectively for the attention index values and the pre-transition index values.

FIG. 13 is a diagram illustrating an example of the distribution of the index deviations respectively for the attention index values and the pre-transition index values.

In the comparison unit 52, the calculation of the difference degree between the distribution of the attention index values and the distribution of the pre-transition index values using the statistical test can be performed based on the distribution itself of the attention index values and the distribution itself of the pre-transition index values, and can be performed based on one or both of the distribution of the index average values respectively for the attention index values and the pre-transition index values and the distribution of the index deviations respectively for the attention index values and the pre-transition index values.

The difference degree between the distribution of the attention index values and the distribution of the pre-transition index values includes the difference degree between the centers of the distribution of the attention index values and the distribution of the pre-transition index values, and the difference degree between the variations (standard deviation or the like) of the distribution of the attention index values and the distribution of the pre-transition index values. Here, the difference degree between the centers and the difference degree between the variations are also referred to as a center difference degree and a variation difference degree, respectively. The difference degree between the distribution of the attention index values and the distribution of the pre-transition index values includes, in addition to each of the center difference degree and the variation difference degree, a difference degree obtained by adding both the center difference degree and the variation difference degree, for example, a difference degree calculated as a product of the center difference degree and the variation difference degree.

The center difference degree can be calculated by a statistical test of the difference between the distributions of the index average values based on the distribution of the index average values respectively for the attention index values and the pre-transition index values. When the statistical test is not used, (a value based on) the difference between the average mean values, which are the average values of the distributions of the index average values respectively for the attention index values and the pre-transition index values, can be calculated as the center difference degree.

The variation difference degree can be calculated by a statistical test of a difference between distributions of the index deviations based on the distribution of the index deviations respectively for the attention index values and the pre-transition index values. When the statistical test is not used, it is possible to calculate, as the variation difference degree, (a value based on) a difference between deviation average values that are average values of distributions of index deviations respectively for the attention index values and the pre-transition index values, or a difference between average standard deviations that are standard deviations of distributions of index average values respectively for the attention index values and the pre-transition index values.

### <First Example of Processing of Evaluating TransitionDegree of Index Value>

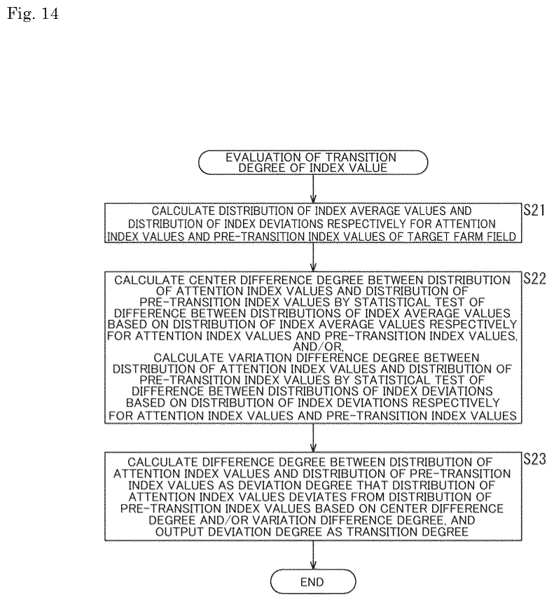

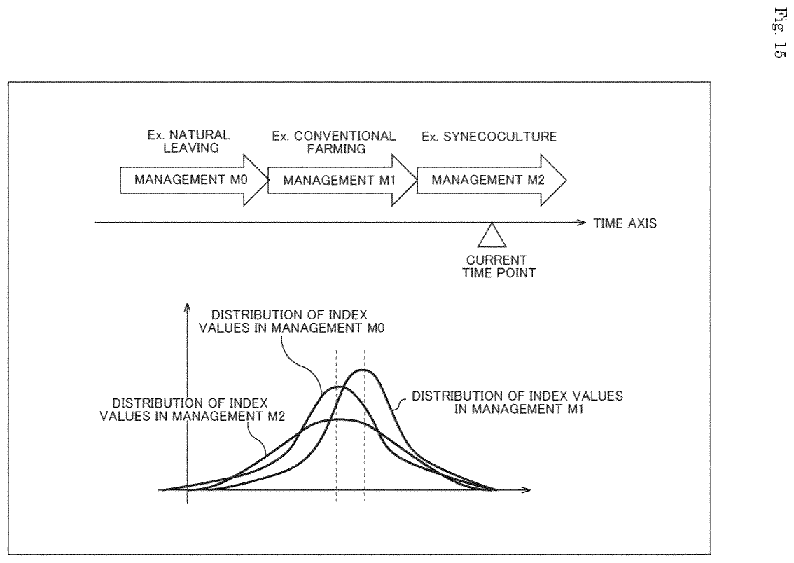

FIG. 14 is a flowchart for explaining a first example of processing of evaluating the transition degree of the index value in step S12 of FIG. 6.

In the evaluation unit 42 (FIG. 7), in step S21, the distribution estimation unit 51 calculates (estimates) the distribution of the index average values and the distribution of the index deviations respectively for the attention index values and the pre-transition index values of the target farm field, and supplies the distribution to the comparison unit 52, and the process proceeds to step S22.

In step S22, based on the distribution of the index average values respectively for the attention index values and the pre-transition index values from the distribution estimation unit 51, the comparison unit 52 calculates the center difference degree between the distribution of the attention index values and the distribution of the pre-transition index values by statistical test of the difference between the distributions of the attention index values. In addition or alternatively, the comparison unit 52 calculates the variation difference degree between the distribution of the attention index values and the distribution of the pre-transition index values by the statistical test of the difference between the distributions of the index deviations based on the distribution of the index deviations respectively for the attention index values and the pre-transition index values. After the center difference degree between the distribution of the attention index values and the distribution of the pre-transition index values and/or the variation difference degree between the distribution of the attention index values and the distribution of the pre-transition index values is calculated, the process proceeds from step S22 to step S23.

In step S23, the comparison unit 52 calculates the difference degree between the distribution of the attention index values and the distribution of the pre-transition index values as the deviation degree that the distribution of the attention index values deviates from the distribution of the pre-transition index values based on the center difference degree and/or the variation difference degree. In the calculation of the difference degree between the distribution of the attention index values and the distribution of the pre-transition index values, the center difference degree, the variation difference degree, or a value (product or the like) based on the center difference degree and the variation difference degree is calculated as the difference degree between the distribution of the attention index values and the distribution of the pre-transition index values. The comparison unit 52 outputs the deviation degree as the transition degree, and the process ends.

### <Second Example of Processing of Evaluating TransitionDegree of Index Value>

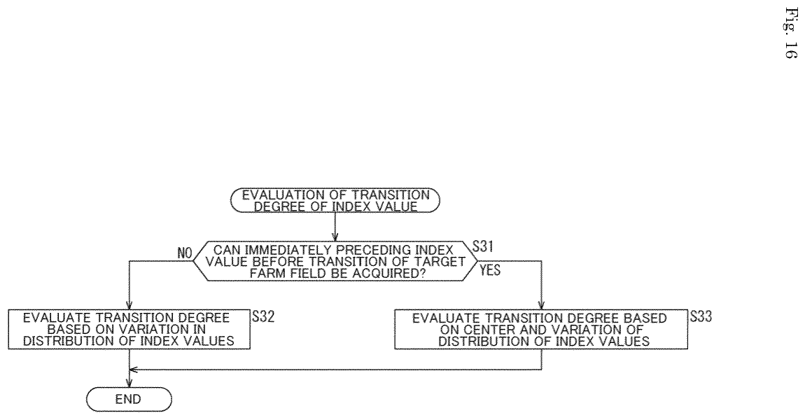

FIG. 15 is a diagram illustrating an example of the transition of the ecosystem management and the distribution of the index values.

In FIG. 15, the current time point is set as the attention time point, and the ecosystem management M2 is performed as the attention management in the target farm field. The ecosystem management M1 is performed as pre-transition management which is the ecosystem management immediately before transitioning to the attention management. Then, an ecosystem management M0 is performed as the ecosystem management (hereinafter, also referred to as immediately preceding management before transition) immediately before the ecosystem management M1 as the pre-transition management.

For example, in a case where the ecosystem managements M0 to M2 are natural leaving, conventional farming (or organic farming), and

Synecoculture (registered trademark), respectively, the distribution of the index values related to the soil is as illustrated in FIG. 15, for example.

In the ecosystem management M0 of natural leaving, the distribution of the index values has distribution with a moderate variation (standard deviation).

In the ecosystem management M1 of the conventional farming transitioned from the ecosystem management M0, the distribution of the index values is distribution with a small variation. This is because, in the ecosystem management M1 of the conventional farming, the soil improvement, the fertilizer application, and the work (operation) of the necessary pesticide application are performed, whereby the distribution of the index values related to the soil converges to a range more optimal for the growth of the specific plant species than in the case of the ecosystem management M0 of natural leaving. Furthermore, in the ecosystem management M1 of the conventional farming, the center of the distribution of the index values may deviate from the center of the distribution of the index values in the ecosystem management M0 of natural leaving. However, in a case where the target farm field is, for example, a fertile land even if the target farm field is naturally left due to original soil property or soil quality, there is a case where the fertility (for example, a nitric acid value, an electric conductivity (EC) value, or the like) of the land is not (almost) affected by fertilization or the like of conventional farmings (or organic farmings), and the center of the distribution of the index values does not (almost) transition.

In the ecosystem management M2 of Synecoculture (registered trademark) transitioned from the ecosystem management M1, the distribution of the index values becomes a distribution having a large variation as the biological diversity increases more than the natural state due to the ecosystem expansion. Furthermore, in a case where the center of the distribution of the index values in the ecosystem management M1 of the conventional farming deviates from the center of the distribution of the index values in the ecosystem management M0 of natural leaving, the center of the distribution of the index values approaches the center of the distribution of the index values in the ecosystem management M0 of natural leaving. This is because, by Synecoculture (registered trademark), the influence of conventional farming (or organic farming) is removed, so that the soil property and the soil quality approach the original soil property and the soil quality before the conventional farming is performed (implemented), that is, when natural leaving is performed.

From the above, when the attention management (ecosystem management M2) and the pre-transition management (ecosystem management M1) are Synecoculture (registered trademark) and conventional farming (or organic farming), respectively, the calculation of the difference degree between the distribution of the index values (attention index values) in the attention management, that is, the index value in Synecoculture (registered trademark) and the distribution of the index values (pre-transition index values) in the pre-transition management, that is, the distribution of the index values in the conventional farming can be performed, for example, as follows.

Here, the index value at a certain time point (hereinafter, also referred to as an immediately preceding time point before transition) within the period during which the immediately preceding management before transition (ecosystem management M0) has been performed is also referred to as an immediately preceding index value before transition.

As described above, in a case where the pre-transition management and the attention management are the conventional farming and the Synecoculture (registered trademark), respectively, there is a large difference between the variations of the distribution of the index values in the Synecoculture (registered trademark) and the distribution of the index values in the conventional farming. Therefore, as the difference degree between the distribution of the attention index values and the distribution of the pre-transition index values, it is appropriate to use at least the variation difference degree between the distribution of the attention index values and the distribution of the pre-transition index values.

In addition, the distribution of the index values in Synecoculture (registered trademark) and the distribution of the index values in the conventional farming may or may not have a difference (deviation) in the center. For example, as described above, there is a case where the center of the distribution of the index values does not deviate without being affected by fertilization or the like of the conventional farmings even when the conventional farmings are performed on the fertile land.

Therefore, in a case where (the distribution of) the immediately preceding index values before transition can be acquired (obtained), the evaluation unit 42 can determine whether there is a (significant) difference between the centers of the distribution of the immediately preceding index values before transition and the distribution of the pre-transition index values.

When there is (almost) no difference between the centers of the distribution of the immediately preceding index values before transition and the distribution of the pre-transition index values, the evaluation unit 42 calculates a value based on the variation difference degree between the distribution of the attention index values and the distribution of the pre-transition index values as the difference degree between the distribution of the attention index values and the distribution of the pre-transition index values (the deviation degree that the distribution of the attention index values deviates from the distribution of the pre-transition index values).

As described above, in a case where the immediately preceding management before transition, the pre-transition management, and the attention management are the natural leaving, the conventional farming, and the Synecoculture (registered trademark), respectively, when there is no difference between the centers of the distribution of the index values (the immediately preceding index value before transition) at the time of the natural leaving and the distribution of the index values (the pre-transition index values) at the time of the conventional farming because the target farm field is fertile land, there is a high possibility that there is also (almost) no difference between the centers of the distribution of the index values at the time of the conventional farming and the distribution of the index values (the attention index value) at the time of the Synecoculture (registered trademark). Therefore, when both the center difference degree and the variation difference degree between the distribution of the attention index values and the distribution of the pre-transition index values are used to calculate the difference degree between the distribution of the attention index values and the distribution of the pre-transition index values, there is a high possibility that the center difference degree affects the difference degree between the distribution of the attention index values and the distribution of the pre-transition index values as noise.

Therefore, the difference degree between the distribution of the attention index values and the distribution of the pre-transition index values can be calculated using the variation difference degree without using the center difference degree between the distribution of the attention index values and the distribution of the pre-transition index values. In this case, it is possible to prevent the center difference degree between the distribution of the eye index values and the distribution of the pre-transition index values from affecting the difference degree between the distribution of the attention index values and the distribution of the pre-transition index values as noise, and an appropriate value can be calculated as the difference degree between the distribution of the attention index values and the distribution of the pre-transition index values.

When there is a difference between the centers of the distribution of the immediately preceding index values before transition and the distribution of the pre-transition index values, the evaluation unit 42 can calculate a value based on both the center difference degree and the variation difference degree between the distribution of the attention index values and the distribution of the pre-transition index values as the difference degree between the distribution of the attention index values and the distribution of the pre-transition index values.

As described above, in a case where the immediately preceding management before transition, the pre-transition management, and the attention management are the natural leaving, the conventional farming, and the Synecoculture (registered trademark), respectively, when there is a difference between the centers of the distribution of the index values (immediately preceding index values before transition) at the time of the natural leaving and the distribution of the index values (pre-transition index values) at the time of the conventional farming, there is a high possibility that there is a difference between the centers of the distribution of the index values at the time of the conventional farming and the distribution of the index values (attention index values) at the time of the Synecoculture (registered trademark). That is, in a case where the center of the distribution of the index values deviates due to the transition from the natural leaving to the conventional farming, there is a high possibility that the center of the distribution of the index values deviates toward the center of the distribution of the index values at the time of the natural leaving due to the transition from the conventional farming to Synecoculture (registered trademark). Therefore, in this case, for the calculation of the difference degree between the distribution of the attention index values and the distribution of the pre-transition index values, it is appropriate to consider the difference between the centers of the distribution of the attention index values and the distribution of the pre-transition index values.

Therefore, the difference degree between the distribution of the attention index values and the distribution of the pre-transition index values can be calculated using both the center difference degree and the variation difference degree between the distribution of the attention index values and the distribution of the pre-transition index values. In this case, an appropriate value can be calculated as the difference degree between the distribution of the attention index values and the distribution of the pre-transition index values.

On the other hand, when the immediately preceding index value before transition cannot be obtained, it is not possible to specify (determine) whether there is a difference between the centers of the distribution of the immediately preceding index values before transition and the distribution of the pre-transition index values. Therefore, as in the case where there is no difference between the centers of the distribution of the immediately preceding index values before transition and the distribution of the pre-transition index values, it is possible to calculate a value based on the variation difference degree between the distribution of the attention index values and the distribution of the pre-transition index values as the difference degree between the distribution of the attention index values and the distribution of the pre-transition index values. As a result, it is possible to eliminate the possibility that the center difference degree between the distribution of the attention index values and the distribution of the pre-transition index values affects the difference degree between the distribution of the attention index values and the distribution of the pre-transition index values as noise, and an appropriate value can be calculated as the difference degree between the distribution of the attention index values and the distribution of the pre-transition index values.

Here, as illustrated in FIG. 15, in a case where the attention management is Synecoculture (registered trademark), the pre-transition management is conventional farming (or organic farming), and the index value is an index value related to the soil, the difference degree between the distribution of the attention index values and the distribution of the pre-transition index values represents the degree to which the influence of conventional farming as the pre-transition management is weakened and the influence of Synecoculture (registered trademark) as the attention management is strengthened in the soil.

FIG. 16 is a flowchart for explaining a second example of processing of evaluating the transition degree of the index value in step S12 of FIG. 6.

In the second example of processing of evaluating the transition degree of the index value, as described with reference to FIG. 15, the difference degree between the distribution of the attention index values and the distribution of the pre-transition index values (the deviation degree in which the distribution of the attention index values deviates from the distribution of the pre-transition index values) is calculated.

In step S31, the evaluation unit 42 determines whether the immediately preceding index value before transition of the target farm field can be acquired (obtained).

In a case where it is determined in step S31 that the immediately preceding index value before transition of the target farm field cannot be acquired, the process proceeds to step S32. In step S32, the evaluation unit 42 evaluates the transition degree based on the variation in the distribution of the index values, and the process ends.

On the other hand, in a case where it is determined in step S31 that the immediately preceding index value before transition of the target farm field can be acquired, the process proceeds to step S33. In step S33, the evaluation unit 42 evaluates the transition degree based on the center and the variation of the distribution of the index values, and the process ends.

Here, in a case where the user has acquired the immediately preceding index value before transition in the target farm field in the past, the user can transmit the immediately preceding index value before transition from the terminal 11 to the server 12 by operating the terminal 11. In addition, in a case where there is a place that has been naturally left in the periphery of the target farm field, the user can acquire the index value from the place that has been naturally left in the periphery of the target farm field and transmit the index value from the terminal 11 to the server 12 as the immediately preceding index value before transition, assuming that the immediately preceding management before transition is performed on the place that has been naturally left. In addition, in a case where the immediately preceding index value before transition of the target farm field is stored in the public DB, the server 12 can acquire (download) the immediately preceding index value before transition of the target farm field from the DB.

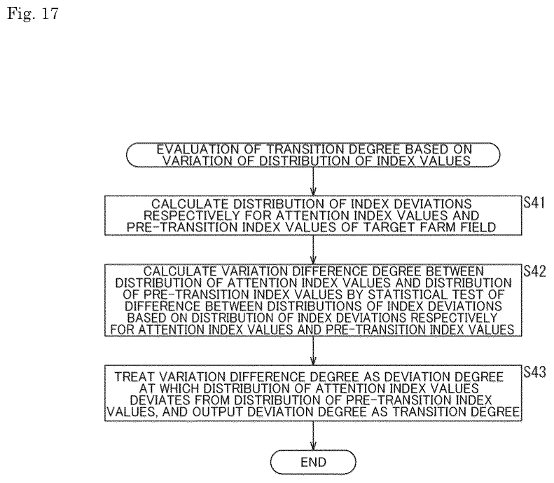

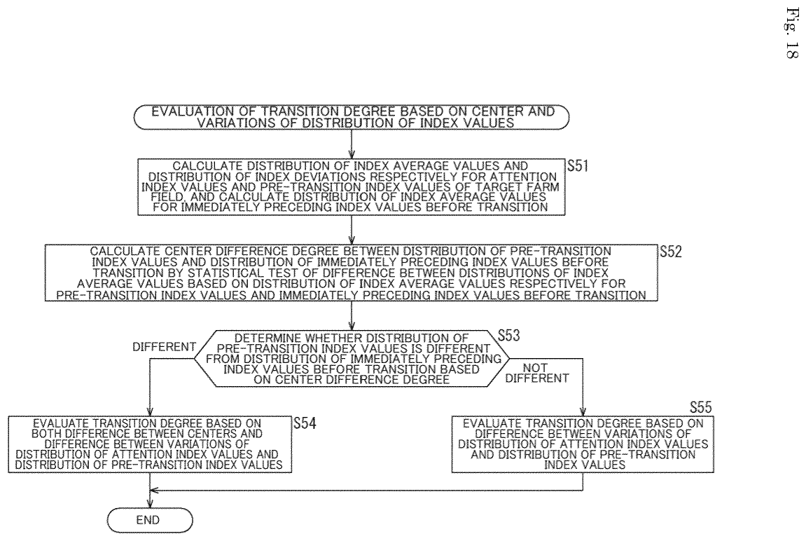

FIG. 17 is a flowchart for explaining an example of processing of evaluating the transition degree based on the variation in the distribution of the index values in step S32 of FIG. 16.

In step S41, the distribution estimation unit 51 of the evaluation unit 42 (FIG. 7) calculates the distribution of the index deviations respectively for the attention index values and the pre-transition index values of the target farm field and supplies the distribution to the comparison unit 52, and the process proceeds to step S42.

In step S42, based on the distribution of the index deviations respectively for the attention index values and the pre-transition index values from the distribution estimation unit 51, the comparison unit 52 calculates the variation difference degree between the distribution of the attention index values and the distribution of the pre-transition index values by statistical test of the difference between the distributions of the index deviations.

Then, the process proceeds from step S42 to step S43, and the comparison unit 52 treats the variation difference degree as the difference degree between the distribution of the attention index values and the distribution of the pre-transition index values, that is, the deviation degree at which the distribution of the attention index values deviates from the distribution of the pre-transition index values, and outputs the deviation degree as the transition degree, and the process ends.

FIG. 18 is a flowchart for explaining an example of processing of evaluating the transition degree based on the center and the variation of the distribution of the index values in step S33 of FIG. 16.

In step S51, the distribution estimation unit 51 of the evaluation unit 42 (FIG. 7) calculates the distribution of the index average values and the distribution of the index deviations respectively for the attention index values and the pre-transition index values of the target farm field, and calculates the distribution of the index average values for the immediately preceding index values before transition. The distribution estimation unit 51 supplies the distribution of the index average values and the distribution of the index deviations respectively for the attention index values and the pre-transition index values, and the distribution of the index average values for the immediately preceding index values before transition to the comparison unit 52, and the process proceeds from step S51 to step S52.

In step S52, the comparison unit 52 performs the statistical test of the difference between the distributions of the index average values based on the distribution of the index average values respectively for the pre-transition index values and the immediately preceding index values before transition from the distribution estimation unit 51. The comparison unit 52 calculates the center difference degree between the distribution of the pre-transition index values and the distribution of the immediately preceding index values before transition by the statistical test, and the process proceeds from step S52 to step S53.

In step S53, the comparison unit 52 determines whether the distribution of the pre-transition index values is different from the distribution of the immediately preceding index values before transition based on the center difference degree between the distribution of the pre-transition index values and the distribution of the immediately preceding index values before transition. Then, hereinafter, the transition degree is evaluated based on whether the distribution of the pre-transition index values is different from the distribution of the immediately preceding index values before transition.

In step S53, when it is determined that the distribution of the pre-transition index values is different from the distribution of the immediately preceding index values before transition, that is, when there is a significant deviation in the centers between the distribution of the pre-transition index values and the distribution of the immediately preceding index values before transition, the process proceeds to step S54. In step S54, the comparison unit 52 evaluates the transition degree based on both the difference between the centers and the difference between the variations of the distribution of the attention index values and the distribution of the pre-transition index values, the process ends.

On the other hand, when it is determined in step S53 that the distribution of the pre-transition index values is not different from the distribution of the immediately preceding index values before transition, that is, when there is no significant deviation in the centers between the distribution of the pre-transition index values and the distribution of the immediately preceding index values before transition, the process proceeds to step S55. In step S55, the comparison unit 52 evaluates the transition degree based on the difference between the variations of the distribution of the attention index values and the distribution of the pre-transition index values, and the process ends.

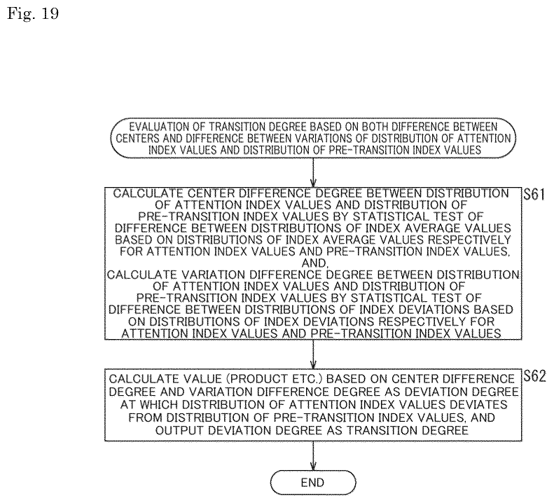

FIG. 19 is a flowchart for explaining an example of processing of evaluating the transition degree based on both the difference between the centers and the difference between the variations of the distribution of the attention index values and the distribution of the pre-transition index values in step S54 of FIG. 18.

In step S61, based on the distributions of the index average values respectively for the attention index values and the pre-transition index values, the comparison unit 52 calculates the center difference degree between the distribution of the attention index values and the distribution of the pre-transition index values by statistical test of the difference between the distributions of the index average values. Further, based on the distributions of the index deviations respectively for the attention index values and the pre-transition index values, the comparison unit 52 calculates the variation difference degree between the distribution of the attention index values and the distribution of the pre-transition index values by the statistical test of the difference between the distributions of the index deviations. Then, the process proceeds from step S61 to step S62.

In step S62, the comparison unit 52 calculates a value (product or the like) based on the center difference degree and the variation difference degree calculated in step S61 as the difference degree between the distribution of the attention index values and the distribution of the pre-transition index values, that is, the deviation degree at which the distribution of the attention index values deviates from the distribution of the pre-transition index values. The comparison unit 52 outputs the deviation degree as the transition degree, and the process ends.

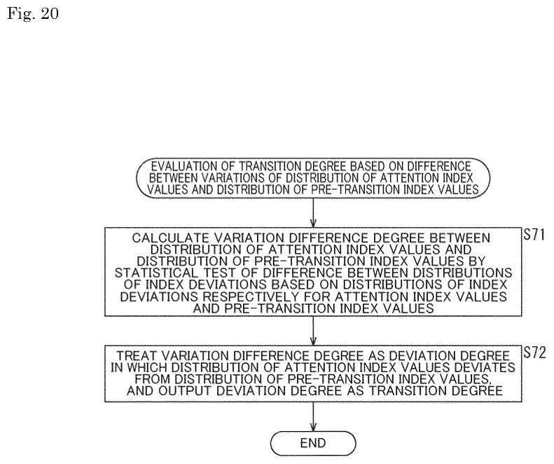

FIG. 20 is a flowchart for explaining an example of processing of evaluating the transition degree based on the difference between the variations of the distribution of the attention index values and the distribution of the pre-transition index values in step S55 of FIG. 18.

In step S71, based on the distributions of the index deviations respectively for the attention index values and the pre-transition index values, the comparison unit 52 calculates the variation difference degree between the distribution of the attention index values and the distribution of the pre-transition index values by the statistical test of the difference between the distributions of the index deviations. Then, the process proceeds from step S71 to step S72.

In step S72, the comparison unit 52 treats the variation difference degree calculated in step S71 as the difference degree between the distribution of the attention index values and the distribution of the pre-transition index values, that is, the deviation degree in which the distribution of the attention index values deviates from the distribution of the pre-transition index values, and outputs the deviation degree as the transition degree, and the process ends.

### <Example of Second Functional Configuration of Server 12>

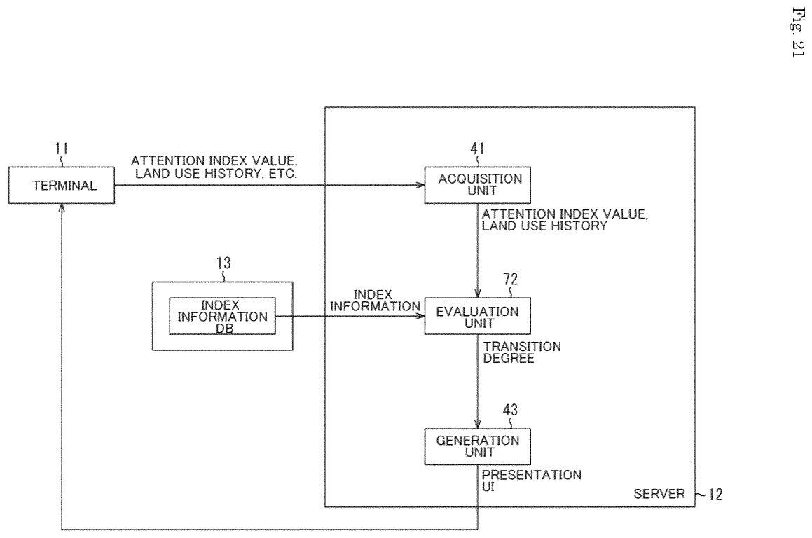

FIG. 21 is a block diagram illustrating an example of a second functional configuration of the server 12.

In the drawing, the elements corresponding to those in FIG. 5 are designated by the same characters and their description will not be repeated.

In FIG. 21, the server 12 includes an acquisition unit 41, a generation unit 43, and an evaluation unit 72. Therefore, the server 12 of FIG. 21 is common to the case of FIG. 5 in including the acquisition unit 41 and the generation unit 43, and is different from the case of FIG. 5 in that the evaluation unit 72 is provided instead of the evaluation unit 42.

In FIG. 21, the user inputs the land use history of the target farm field by operating the terminal 11 instead of the (plurality of) pre-transition index values, and the terminal 11 transmits the attention index value and the land use history to the server 12. The land use history of the target farm field is a history of a land use method of the target farm field.

The acquisition unit 41 acquires (receives) the attention index value and the land use history from the terminal 11, and supplies the attention index value and the land use history to the evaluation unit 72. Note that, in a case where the land use history of the target farm field is stored in the public DB, the acquisition unit 41 can acquire the land use history of the target farm field from the DB.

The evaluation unit 72 specifies the distribution of the pre-transition index values based on the land use history of the target farm field from the acquisition unit 41. That is, the evaluation unit 72 specifies the land use method when the pre-transition management is performed on the target farm field from the land use history. Further, the evaluation unit 72 acquires (reads) the index information associated with the land use method when the pre-transition management is performed in the target farm field by referring to the index information DB of the DB 13, and specifies the distribution of the pre-transition index values based on the index information.

Thereafter, similarly to the evaluation unit 42, the evaluation unit 72 calculates the transition degree of the index value based on the distributions of the attention index values and the pre-transition index values, and supplies the transition degree to the generation unit 43.

As described above, since the evaluation unit 72 specifies the distribution of the pre-transition index values based on the land use history, it is possible to calculate the transition degree even if the user cannot acquire the pre-transition index value.

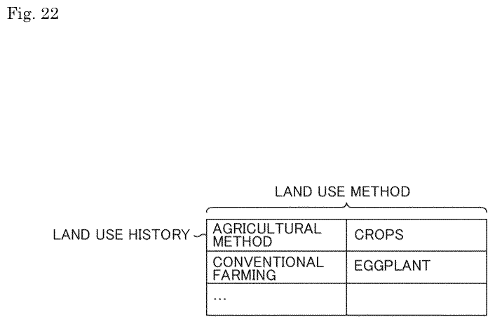

FIG. 22 is a diagram illustrating an example of a land use history.

The land use history is a history of a land use method. The land use method includes (information regarding) an agricultural method practiced in the land and a crop planted by the agricultural method.

Note that the land use history may include (or suffices if it includes) at least a land use method when the pre-transition management has been performed for the target farm field (sufficient).

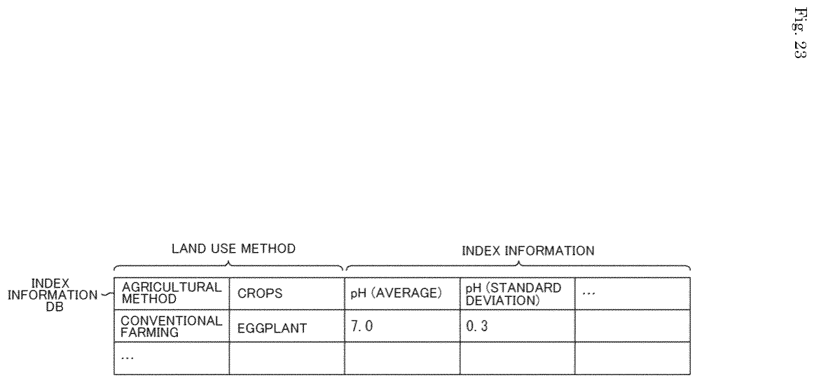

FIG. 23 is a diagram illustrating an example of the index information DB.

In the index information DB, a land use method and index information regarding an ecosystem in a case where the land is used by the land use method are stored in association with each other.

In the index information DB, the land use method includes an agricultural method practiced on the land and a crop planted by the agricultural method, similarly to the land use history. The index information includes information regarding various index values such as the soil pH regarding the ecosystem in a case where the land is used by the use method associated with the index information, for example, an average value, a standard deviation, and the like that define a normal distribution as distribution of the index values.

The evaluation unit 72 specifies a land use method when the pre-transition management is performed on the target farm field from the land use history illustrated in FIG. 22. Then, the evaluation unit 72 refers to the index information DB of the DB 13 illustrated in FIG. 23 to specify the distribution of the pre-transition index values based on the index information regarding the index value of the same type as the attention index value among the index information associated with the land use method when the pre-transition management is performed on the target farm field.

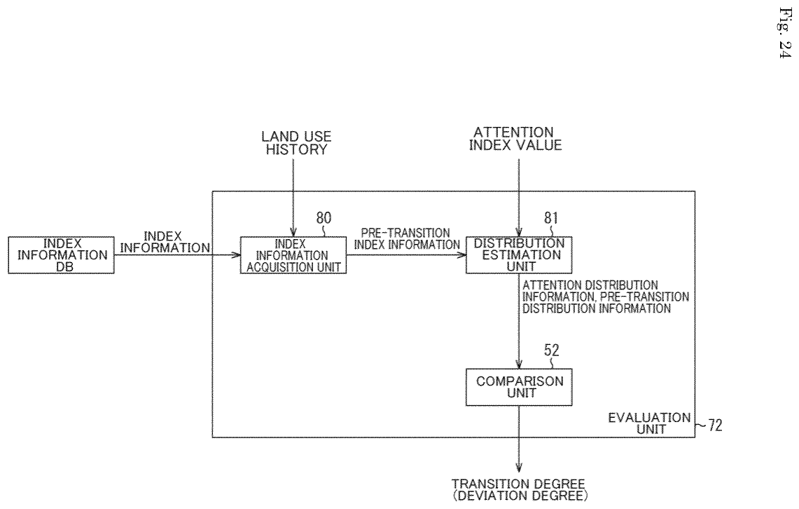

FIG. 24 is a block diagram illustrating a configuration example of the evaluation unit 72 in FIG. 21.

Note that, in the drawing, portions corresponding to those of the evaluation unit 42 in FIG. 7 are denoted by the same reference numerals, and the description thereof will be appropriately omitted below.

In FIG. 24, the evaluation unit 72 includes a comparison unit 52, an index information acquisition unit 80, and a distribution estimation unit 81. Therefore, the evaluation unit 72 is common to the evaluation unit 42 in FIG. 7 in including the comparison unit 52. However, the evaluation unit 72 is different from the evaluation unit 42 in that the index information acquisition unit 80 is newly provided and the distribution estimation unit 81 is provided instead of the distribution estimation unit 51.

The index information acquisition unit 80 is supplied with the land use history from the acquisition unit 41 (FIG. 21). The index information acquisition unit 80 specifies a land use method when the pre-transition management is performed on the target farm field from the land use history (FIG. 22) from the acquisition unit 41. Further, the index information acquisition unit 80 refers to the index information DB (FIG. 23) to acquire index information (hereinafter, also referred to as pre-transition index information) associated with the land use method when the pre-transition management is performed on the target farm field, and supplies the index information to the distribution estimation unit 81.

Similarly to the distribution estimation unit 51 in FIG. 7, the distribution estimation unit 81 calculates the attention distribution information regarding the distribution of the attention index values based on the attention index values and supplies the distribution information to the comparison unit 52. Further, the distribution estimation unit 81 specifies the index information regarding the index value of the same type as the attention index value among the pre-transition index information from the index information acquisition unit 80 as the pre-transition distribution information regarding the distribution of the pre-transition index values, and supplies the pre-transition distribution information to the comparison unit 52.

### <Example of Third Functional Configuration of Server 12>

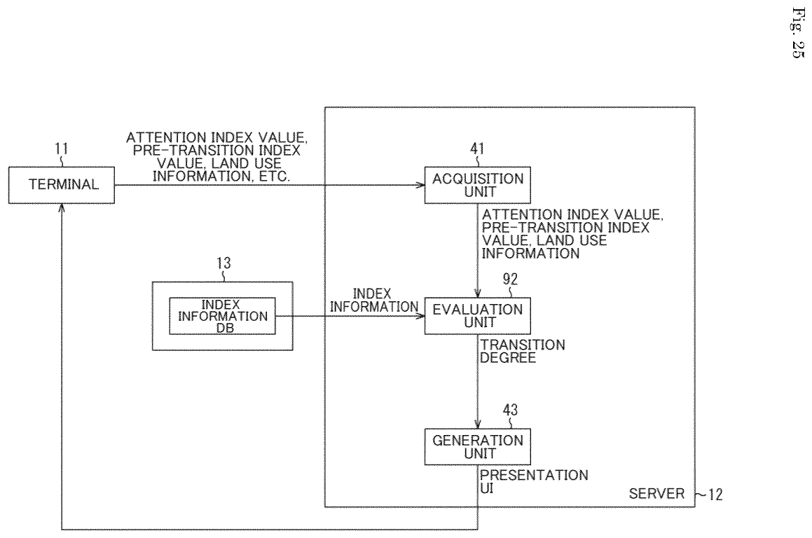

FIG. 25 is a block diagram illustrating an example of a third functional configuration of the server 12.

In the drawing, the elements corresponding to those in FIG. 5 are designated by the same characters and their description will not be repeated.

In FIG. 25, the server 12 includes an acquisition unit 41, a generation unit 43, and an evaluation unit 92. Therefore, the server 12 of FIG. 25 is common to the case of FIG. 5 in including the acquisition unit 41 and the generation unit 43, and is different from the case of FIG. 5 in that the evaluation unit 92 is provided instead of the evaluation unit 42.

In FIG. 25, the user inputs the land use information of the target farm field in addition to the attention index value and the pre-transition index value by operating the terminal 11, and the terminal 11 transmits the attention index value, the pre-transition index value, and the land use information to the server 12. The land use information of the target farm field indicates a land use method of the target farm field when the attention management is performed on the target farm field, that is, a land use method of the target farm field at the attention time point. For example, similarly to the land use history in FIG. 22, the land use information includes (information of) an agricultural method practiced on the land of the target farm field and a crop planted by the agricultural method.

The acquisition unit 41 acquires the attention index value, the pre-transition index value, and the land use information from the terminal 11, and supplies the acquired information to the evaluation unit 92. Note that, in a case where the land use information of the target farm field is stored in the public DB, the acquisition unit 41 can acquire the land use information of the target farm field from the DB.

The evaluation unit 92 specifies distribution of attention index values based on the land use information of the target farm field from the acquisition unit 41. That is, the evaluation unit 92 specifies the land use method when the attention management is performed on the target farm field from the land use information. Further, the evaluation unit 92 acquires index information associated with the land use method when the attention management is performed on the target farm field by referring to the index information DB. Then, the evaluation unit 92 specifies the distribution of the index values aimed (hereinafter, also referred to as a target index values) in the attention management based on the index information. The distribution of the target index values is a general distribution of index values that are expected to be finally reached if the attention management is performed. For example, when the attention management is the cultivation of the eggplant by organic farming, the distribution of the target index values is the distribution of the index values suitable for the cultivation of the eggplant by organic farming.

The evaluation unit 92 calculates the transition degree of the index value based on the distributions of the attention index values, the pre-transition index values, and the target index values, and supplies the transition degree to the generation unit 43.

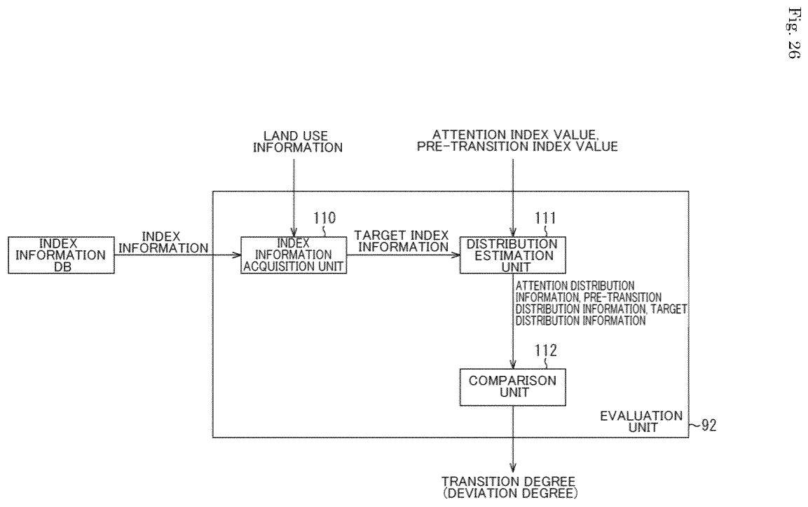

FIG. 26 is a block diagram illustrating a configuration example of the evaluation unit 92 in FIG. 25.

In FIG. 26, the evaluation unit 92 includes an index information acquisition unit 110, a distribution estimation unit 111, and a comparison unit 112.

The index information acquisition unit 110 is supplied with the land use information from the acquisition unit 41 (FIG. 25). The index information acquisition unit 110 refers to the index information DB (FIG. 23) to acquire, as target index information of a target index value of the attention management, index information indicated by the land use information and associated with a land use method of the target farm field when the attention management is performed, and supplies the target index information to the distribution estimation unit 111.

The target index information is supplied from the index information acquisition unit 110, and the attention index value and the pre-transition index value are supplied from the acquisition unit 41 to the distribution estimation unit 111. Similarly to the distribution estimation unit 51 in FIG. 7, the distribution estimation unit 111 calculates, based on the attention index value and the pre-transition index value, the attention distribution information regarding the distribution of the attention index values and the pre-transition distribution information regarding the distribution of the pre-transition index values, and supplies the attention distribution information and the pre-transition distribution information to the comparison unit 112. Furthermore, the distribution estimation unit 111 specifies target distribution information regarding the distribution of the target index values based on the target index information from the index information acquisition unit 80, similarly to the distribution estimation unit 81 in FIG. 24, and supplies the target distribution information to the comparison unit 112.

The comparison unit 112 compares the distribution of the attention index values with each of the distribution of the pre-transition index values and the distribution of the target index values based on the attention distribution information, the pre-transition distribution information, and the target distribution information from the distribution estimation unit 111, and calculates the transition degree of the index value. That is, the comparison unit 112 calculates the transition degree of the attention index value from the pre-transition index value toward the target index value. Then, the comparison unit 112 supplies the transition degree to the generation unit 43.

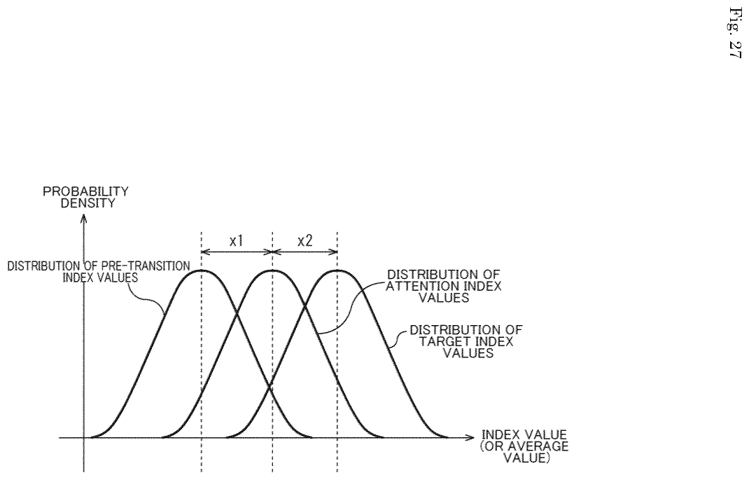

FIG. 27 is a diagram for explaining an example of processing of calculating the transition degree by the comparison unit 112 in FIG. 26.

The comparison unit 112 calculates (evaluates) the transition degree based on the center difference degree between the distribution of the attention index values and the distribution of the pre-transition index values and the center difference degree between the distribution of the attention index values and the distribution of the target index values.

For example, the comparison unit 112 calculates x2/(x1+x2) as the transition degree based on a distance x1 between the centers of the distribution of the attention index values and the distribution of the pre-transition index values and a distance x2 between the centers of the distribution of the attention index values and the distribution of the target index values. This transition degree indicates that the smaller the value, the more the transition of the index value proceeds toward the target index value. According to such a transition degree, the user can grasp whether the attention index value is close to the pre-transition index value or the target index value, and further, whether the influence of the pre-transition management is strong or the influence of the attention management is strong at the attention time point.

Note that, as the center of the distribution of the attention index values, the center of the distribution of the pre-transition index values, and the center of the distribution of the target index values, for example, the average value of each distribution can be adopted. In addition, as the center of the distribution of the attention index values and the center of the distribution of the pre-transition index values, for example, the average value (average mean value (FIG. 11)) of the distribution of the index average values can be adopted.

As described with reference to FIG. 15, when the attention management or the pre-transition management is Synecoculture (registered trademark), it is appropriate to calculate a value based on at least the variation difference degree between the distribution of the attention index values and the distribution of the pre-transition index values as the difference degree between the distribution of the attention index values and the distribution of the pre-transition index values and further as the transition degree.

On the other hand, as illustrated in FIG. 27, calculating the distance between the centers of the distributions of the index values (attention index value, pre-transition index value, and target index value), that is, the value based on the center difference degree as the transition degree is particularly effective in a case where the attention management and the pre-transition management are agricultural methods other than Synecoculture in which the distribution of the index values has a large variation, that is, conventional farming and organic farming in which the distribution of the index values has a small variation. For example, in FIG. 4, it is effective in a case where the ecosystem management M1 is the conventional farming and the ecosystem management M2 is the organic farming.

### <Example of Fourth Functional Configuration of Server 12>

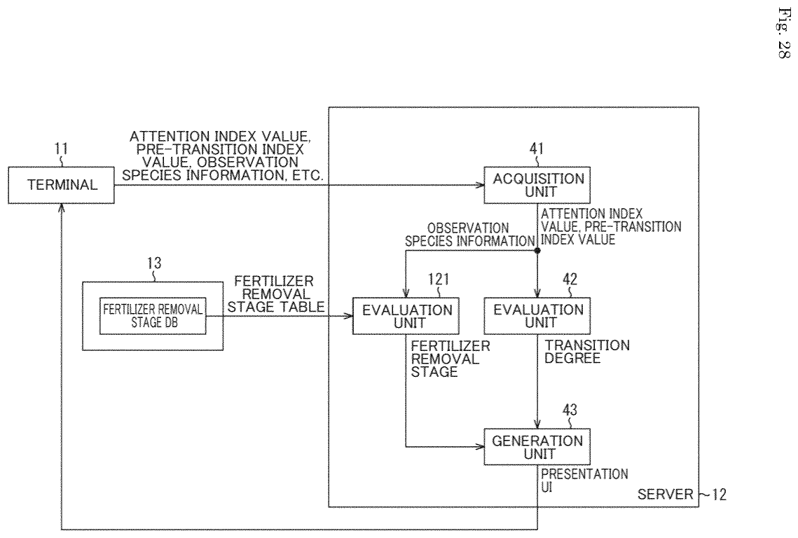

FIG. 28 is a block diagram illustrating an example of a fourth functional configuration of the server 12.

In the drawing, the elements corresponding to those in FIG. 5 are designated by the same characters and their description will not be repeated.

In FIG. 28, the server 12 includes an acquisition unit 41, an evaluation unit 42, a generation unit 43, and an evaluation unit 121. Therefore, the server 12 of FIG. 28 is common to the case of FIG. 5 in including the acquisition unit 41 to the generation unit 43, and is different from the case of FIG. 5 in newly including the evaluation unit 121.

In FIG. 28, the user inputs observation species information in addition to the attention index value and the pre-transition index value by operating the terminal 11, and the terminal 11 transmits the attention index value, the pre-transition index value, and the observation species information to the server 12. The observation species information is information regarding observed species which are plant species observed in the target farm field. As the observation species information, for example, an image obtained by photographing the target farm field, a list in which each observation species of the target farm field is associated with the coverage of the observed species, or the like can be adopted.

The acquisition unit 41 acquires the attention index value, the pre-transition index value, and the observation species information from the terminal 11, supplies the attention index value and the pre-transition index value to the evaluation unit 42, and supplies the observation species information to the evaluation unit 121.

The evaluation unit 121 (another evaluation unit) refers to the fertilizer removal stage table stored in the fertilizer removal stage DB of the DB 13, and evaluates (determines) the fertilizer removal stage indicating the state (stage) of the fertilizer removal in the target farm field based on the observation species information. The evaluation unit 121 supplies the fertilizer removal stage of the target farm field to the generation unit 43.

In FIG. 28, the generation unit 43 generates a presentation UI that presents the fertilizer removal stage or the like of the target farm field from the evaluation unit 121 in addition to the transition degree of the index value from the evaluation unit 42, and transmits the presentation UI to the terminal 11.

Note that, in FIG. 28, the server 12 can be configured without the evaluation unit 42. In a case where the server 12 is configured without the evaluation unit 42, it is not necessary to transmit the attention index value and the pre-transition index value from the terminal 11 to the server 12.

Here, in the abandoned farm land such as the land where the conventional farming or the organic farming has been performed, the vegetation pattern (the pattern of the plant species constituting the vegetation) is a characteristic pattern although it also depends on the geographical conditions and the surrounding vegetation. That is, the vegetation pattern has a correlation with the state of fertilizer removal (fertilizer removal stage), and becomes a characteristic pattern according to the state of fertilizer removal (fertilizer removal stage). Therefore, according to the vegetation pattern of the land, it is possible to evaluate the state (degree) of removal of the fertilizer and the construction degree of the soil structure of the land. The evaluation unit 121 evaluates the fertilizer removal stage of the target farm field from the vegetation pattern of the target farm field indicated by the observation species information.

Regarding the fertilizer removal stage, a high (value as) the fertilizer removal stage indicates a state in which the fertilizer removal has progressed or a state in which the influence of the fertilizer is small, and a low fertilizer removal stage indicates a state in which the fertilizer removal stage has not progressed or a state in which the influence of the fertilizer is large.

For example, in a case where the pre-transition management is conventional farming in which fertilization is performed so that the index value related to the soil falls within the target range, and the attention management is non-fertilized Synecoculture (registered trademark), the fertilizer removal stage increases as the influence of Synecoculture (registered trademark) increases. In addition, for example, in a case where the pre-transition management is non-fertilized Synecoculture (registered trademark) or natural leaving, and the attention management is conventional farming in which fertilization is performed, if the influence of the conventional farming increases, the fertilizer removal stage decreases. Therefore, the fertilizer removal stage can also be regarded as representing the degree of influence of the attention management, similarly to the transition degree of the index value.

When a soil pH, a chemical component of a plant, or the like is adopted as the index value, it is necessary to collect soil or a plant to be a sample for measuring the index value. On the other hand, the evaluation of the fertilizer removal stage in the evaluation unit 121 is performed based on the observation species information. Therefore, the evaluation of the fertilizer removal stage and further the evaluation of the degree of influence of the attention management can be performed non-destructively without collecting a sample.

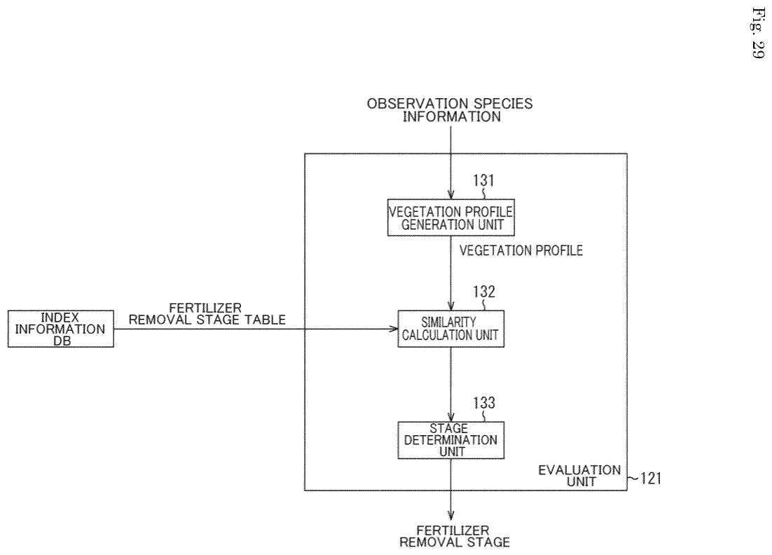

FIG. 29 is a block diagram illustrating a configuration example of the evaluation unit 121 in FIG. 28.

The evaluation unit 121 includes a vegetation profile generation unit 131, a similarity calculation unit 132, and a stage determination unit 133.

The observation species information from the acquisition unit 41 is supplied to the vegetation profile generation unit 131. The vegetation profile generation unit 131 generates a vegetation profile related to the vegetation of the target farm field based on the observation species information from the acquisition unit 41, and supplies the vegetation profile to the similarity calculation unit 132.

Based on the vegetation profile of the vegetation profile generation unit 131, the similarity calculation unit 132 calculates the similarity between the vegetation pattern as the state of each vegetation stored in association with each fertilizer removal stage in the fertilizer removal stage table of the fertilizer removal stage DB and the vegetation pattern of the target farm field. The similarity calculation unit 132 supplies the calculated similarity to the stage determination unit 133.

The stage determination unit 133 determines the fertilizer removal stage associated with the vegetation pattern corresponding to the highest similarity among the similarities from the similarity calculation unit 132 in the fertilizer removal stage table as the fertilizer removal stage of the target farm field, and outputs the fertilizer removal stage of the target farm field.

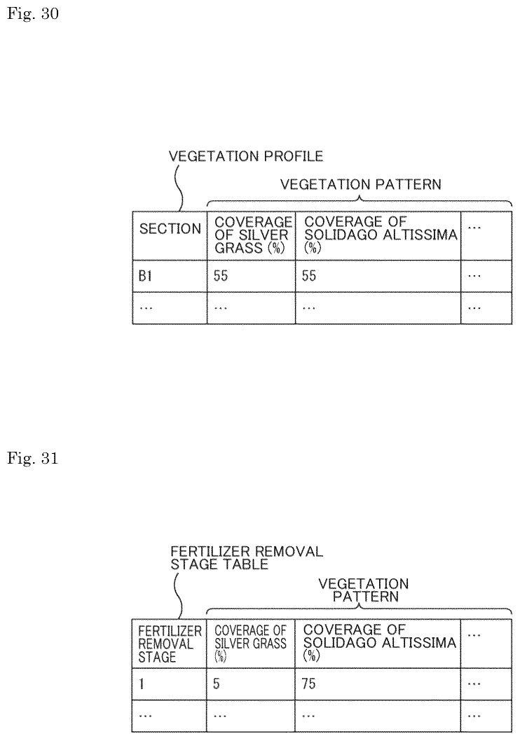

FIG. 30 is a diagram illustrating an example of a vegetation profile generated by the vegetation profile generation unit 131 in FIG. 29.

Based on the observation species information, for example, the vegetation profile generation unit 131 generates a vegetation profile in which the coverage of each plant species growing in each section of the target farm field is described as a vegetation pattern of the section.

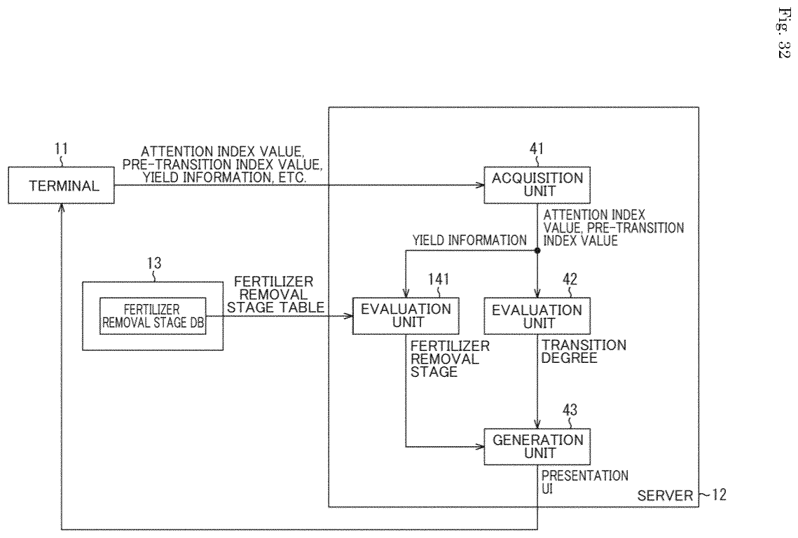

FIG. 31 is a diagram illustrating an example of the fertilizer removal stage table referred to by the similarity calculation unit 132 of FIG. 29.

In the fertilizer removal stage table of FIG. 31, the (general) coverage of each plant species appearing in the fertilizer removal stage is stored as a vegetation pattern in association with each fertilizer removal stage.

The similarity calculation unit 132 handles, as multivariate data, the coverage of each plant species as the vegetation pattern of each section of the vegetation profile and the coverage of each plant species as the vegetation pattern associated with each fertilizer removal stage of the fertilizer removal stage table. The similarity calculation unit 132 calculates the similarity between the vegetation pattern of each section and the vegetation pattern associated with each fertilizer removal stage of the fertilizer removal stage table based on the multivariate data. As the similarity, for example, a reciprocal of a distance between multivariate data in a space of the multivariate data, a correlation coefficient between the multivariate data, or the like can be adopted.

Note that, here, as illustrated in FIG. 30, the vegetation profile generation unit 131 generates, for each section, a vegetation profile in which the coverage of each plant species growing in the section is described as a vegetation pattern of the section. However, as the vegetation profile, it is possible to generate a vegetation profile in which the coverage of each plant species growing in the entire target farm field is described as a vegetation pattern of the target farm field. In this case, the similarity calculation unit 132 calculates the similarity between the vegetation pattern of the target farm field and the vegetation pattern associated with each fertilizer removal stage of the fertilizer removal stage table. Then, the stage determination unit 133 determines the fertilizer removal stage associated with the vegetation pattern corresponding to the highest similarity among the similarities between the vegetation pattern of the target farm field and the vegetation pattern associated with each fertilizer removal stage of the fertilizer removal stage table as the fertilizer removal stage of the target farm field.

Here, since the observation species information is information regarding plant species observed in the target farm field, and the fertilizer removal stage table is information regarding the coverage of each plant species as various vegetation patterns, it can be said that both are information regarding the diversity of plant species, in other words, the biological diversity. Therefore, it can be said that the evaluation (determination) of the fertilizer removal stage of the target farm field performed by the evaluation unit 121 using the observation species information and the fertilizer removal stage table is the evaluation of the fertilizer removal stage using the information regarding the biological diversity.

### <Example of Fifth Functional Configuration of Server 12>

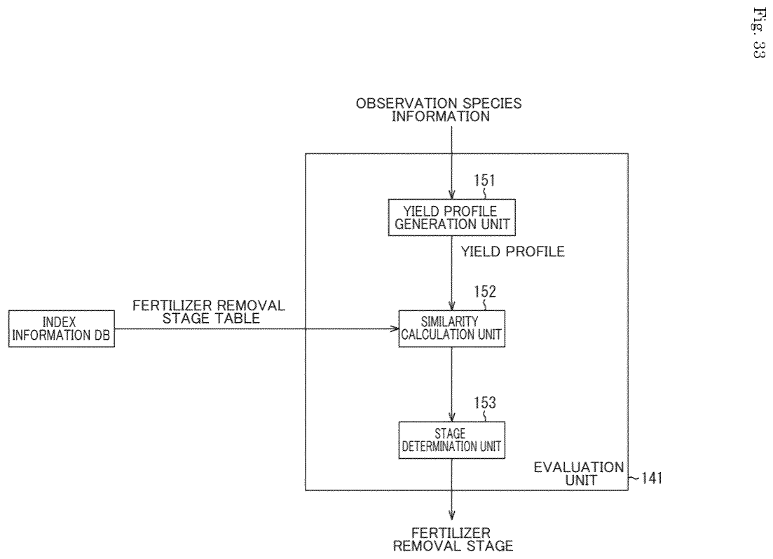

FIG. 32 is a block diagram illustrating an example of a fifth functional configuration of the server 12.

In the drawing, the elements corresponding to those in FIG. 5 are designated by the same characters and their description will not be repeated.

In FIG. 32, the server 12 includes an acquisition unit 41, an evaluation unit 42, a generation unit 43, and an evaluation unit 141. Therefore, the server 12 of FIG. 32 is common to the case of FIG. 5 in including the acquisition unit 41 to the generation unit 43, and is different from the case of FIG. 5 in newly including the evaluation unit 141.

In FIG. 32, the user inputs yield information in addition to the attention index value and the pre-transition index value by operating the terminal 11, and the terminal 11 transmits the attention index value, the pre-transition index value, and the yield information to the server 12. The yield information is information regarding the yield of each crop harvested in the target farm field. As the yield information, for example, a list or the like in which each crop harvested in the target farm field is associated with the yield of the crop can be adopted.

The acquisition unit 41 acquires the attention index value, the pre-transition index value, and the yield information from the terminal 11, supplies the attention index value and the pre-transition index value to the evaluation unit 42, and supplies the yield information to the evaluation unit 141.

The evaluation unit 141 (another evaluation unit) refers to the fertilizer removal stage table stored in the fertilizer removal stage DB of the DB 13, and evaluates (determines) the fertilizer removal stage of the target farm field based on the yield information. The evaluation unit 141 supplies the fertilizer removal stage of the target farm field to the generation unit 43.

In FIG. 32, the generation unit 43 generates a presentation UI that presents the fertilizer removal stage or the like of the target farm field from the evaluation unit 141 in addition to the transition degree of the index value from the evaluation unit 42, and transmits the presentation UI to the terminal 11.

Note that, in FIG. 32, the server 12 can be configured without the evaluation unit 42. In a case where the server 12 is configured without the evaluation unit 42, it is not necessary to transmit the attention index value and the pre-transition index value from the terminal 11 to the server 12.

Here, as described with reference to FIG. 28, since the vegetation pattern has a correlation with the fertilizer removal stage, the yield pattern of each crop harvested from the vegetation of such a vegetation pattern also has a correlation with the fertilizer removal stage. Therefore, it is possible to evaluate the state of fertilizer removal and the construction degree of the soil structure of the land according to the yield pattern of the land. The evaluation unit 141 evaluates the fertilizer removal stage of the target farm field from the yield pattern of the target farm field indicated by the yield information.

The yield information is information inevitably acquired in the practice of various agricultural methods as the ecosystem management, and it is possible to evaluate the fertilizer removal stage from such yield information, and eventually, the degree of influence of the ecosystem management.

FIG. 33 is a block diagram illustrating a configuration example of the evaluation unit 141 in FIG. 32.

The evaluation unit 141 includes a yield profile generation unit 151, a similarity calculation unit 152, and a stage determination unit 153.

The yield information from the acquisition unit 41 is supplied to the yield profile generation unit 151. Based on the yield information from the acquisition unit 41, the yield profile generation unit 151 generates a yield profile related to the yield of each crop in the target farm field, and supplies the yield profile to the similarity calculation unit 152.

Based on the yield profile of the yield profile generation unit 151, the similarity calculation unit 152 calculates the similarity between the yield pattern as the state of the crop stored in association with each fertilizer removal stage in the fertilizer removal stage table of the fertilizer removal stage DB and the yield pattern of the target farm field. The similarity calculation unit 152 supplies the calculated similarity to the stage determination unit 153.

The stage determination unit 153 determines the fertilizer removal stage associated with the yield pattern corresponding to the highest similarity among the similarities from the similarity calculation unit 152 in the fertilizer removal stage table as the fertilizer removal stage of the target farm field, and outputs the fertilizer removal stage of the target farm field.

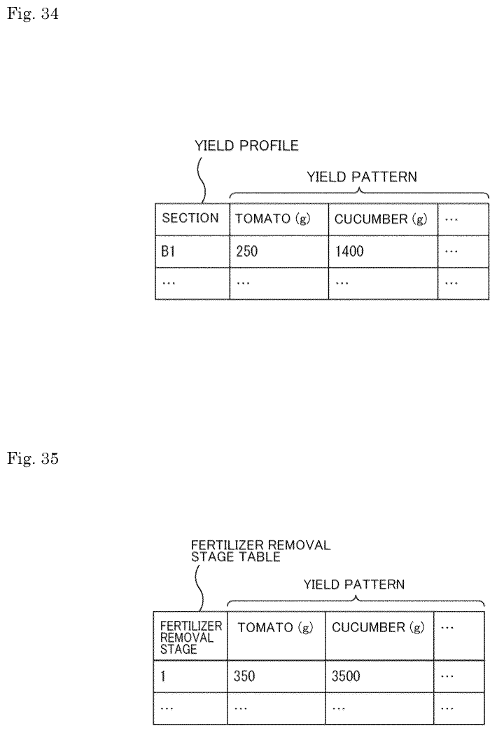

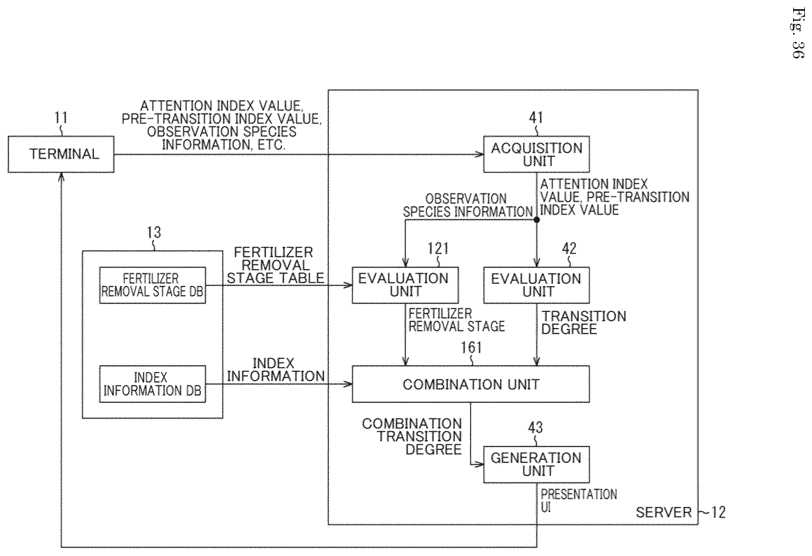

FIG. 34 is a diagram illustrating an example of a yield profile generated by the yield profile generation unit 151 in FIG. 33.

Based on the yield information, for example, for each section of the target farm field, the yield profile generation unit 151 generates a yield profile in which the yield (per unit area) of each crop harvested in the section is described as a yield pattern of the section.

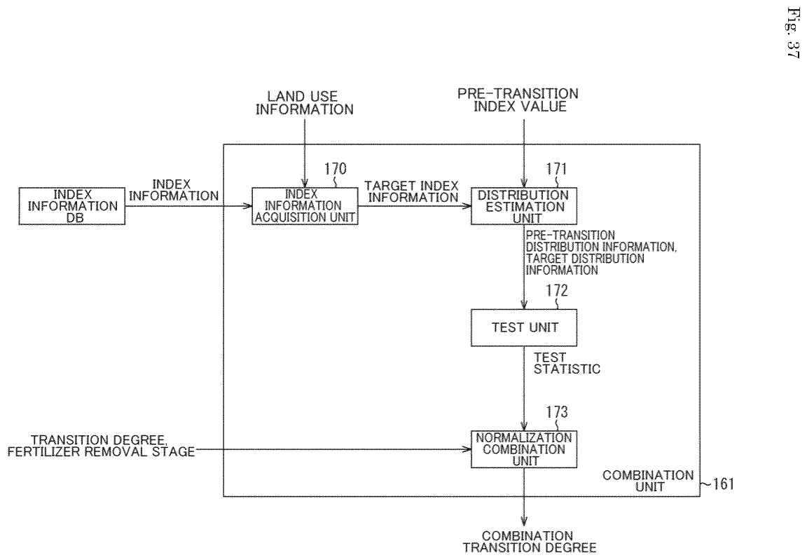

FIG. 35 is a diagram illustrating an example of the fertilizer removal stage table referred to by the similarity calculation unit 152 of FIG. 33.

In the fertilizer removal stage table of FIG. 35, the yield (per unit area in general) of each crop appearing in the fertilizer removal stage is stored as a yield pattern in association with each fertilizer removal stage.

The similarity calculation unit 152 handles, as multivariate data, the yield of each crop as the yield pattern of each section of the yield profile and the yield of each crop as the yield pattern associated with each fertilizer removal stage of the fertilizer removal stage table. Based on the multivariate data, the similarity calculation unit 152 calculates similarity between the yield pattern of each section and the yield pattern associated with each fertilizer removal stage of the fertilizer removal stage table similarly to the similarity calculation unit 132 of FIG. 29.

Here, as illustrated in FIG. 34, in the yield profile generation unit 151, for each section, a yield profile in which the yield of each crop harvested in the section is described as a yield pattern of the section is generated. However, as the yield profile, it is possible to generate a yield profile in which the yield of each crop harvested in the entire target farm field is described as a yield pattern of the target farm field. In this case, the similarity calculation unit 152 calculates the similarity between the yield pattern of the target farm field and the yield pattern associated with each fertilizer removal stage of the fertilizer removal stage table. Then, the stage determination unit 153 determines that the fertilizer removal stage associated with the yield pattern corresponding to the highest similarity among the similarities between the yield pattern of the target farm field and the yield pattern associated with each fertilizer removal stage of the fertilizer removal stage table is the fertilizer removal stage of the target farm field.

### <Example of Sixth Functional Configuration of Server 12>

FIG. 36 is a block diagram illustrating an example of a sixth functional configuration of the server 12.

In the drawing, the elements corresponding to those in FIG. 28 are designated by the same characters and their description will not be repeated.

In FIG. 36, the server 12 includes an acquisition unit 41, an evaluation unit 42, a generation unit 43, an evaluation unit 121, and a combination unit 161. Therefore, the server 12 of FIG. 36 is common to the case of FIG. 28 in including the acquisition unit 41 to the generation unit 43 and the evaluation unit 121, and is different from the case of FIG. 28 in newly providing the combination unit 161.

The transition degree of the index value is supplied from the evaluation unit 42 to the combination unit 161, and the fertilizer removal stage is supplied from the evaluation unit 121.

The combination unit 161 combines the transition degree of the index value from the evaluation unit 42 and the fertilizer removal stage from the evaluation unit 121, and calculates a combination transition degree as a new transition degree. The transition degree of the index value and the fertilizer removal stage are combined by, for example, obtaining a product of the transition degree of the index value and the fertilizer removal stage. The combination unit 161 supplies the combination transition degree to the generation unit 43. In this case, the generation unit 43 generates a presentation UI that presents the combination transition degree and the like from the combination unit 161, and transmits the presentation UI to the terminal 11.

The transition degree of the index value can be regarded as indicating the degree of influence of the ecosystem management as described in FIG. 4, and the fertilizer removal stage can also be regarded as indicating the degree of influence of the ecosystem management as described in FIG. 28. Therefore, the combination transition degree obtained by combining the transition degree of the index value and the fertilizer removal stage represents the degree of influence of the ecosystem management (attention management) in which both the index value and the fertilizer non-application state are taken into consideration. In addition, the combination transition degree is an evaluation result of the degree of influence of the ecosystem management in which the index value and the state of fertilizer removal are balanced, and is a highly reliable evaluation result.

In the combination of the transition degree of the index value and the fertilizer removal stage, the fertilizer removal stage can be combined after the fertilizer removal stage is normalized by the maximum value of the fertilizer removal stage. Regarding the transition degree of the index value, when the difference degree between the distribution of the attention index values and the distribution of the pre-transition index values as the transition degree represents the presence or absence of a significant difference in distribution as 1 or 0, the transition degree can be combined as it is. On the other hand, when the difference degree between the distribution of the attention index values and the distribution of the pre-transition index values is the test statistic, the difference (hereinafter, also referred to as average mean difference) between the average mean values of the attention index values and the pre-transition index values, or the like, the transition degree can be combined after normalization with the maximum value (estimated value) such as the test statistic or the average mean difference.

FIG. 37 is a block diagram illustrating a configuration example of the combination unit 161 in a case where a test statistic is adopted as the difference degree between the distribution of the attention index values and the distribution of the pre-transition index values indicating the transition degree of the index value.

In FIG. 37, the combination unit 161 includes an index information acquisition unit 170, a distribution estimation unit 171, a test unit 172, and a normalization combination unit 173.

In a case where the test statistic is adopted as the difference degree between the distribution of the attention index values and the distribution of the pre-transition index values, in addition to the attention index value and the pre-transition index value, the land use information is transmitted from the terminal 11 to the server 12, as in the case of FIG. 25. As described in FIG. 25, the land use information indicates the land use method of the target farm field when the attention management is performed on the target farm field, and includes (information of) the agricultural method practiced in the land of the target farm field and the crop planted by the agricultural method, similarly to the land use history in FIG. 22. The land use information is acquired by the acquisition unit 41 and supplied to the combination unit 161. Further, the acquisition unit 41 supplies the pre-transition index value to the combination unit 161.

The index information acquisition unit 170 is supplied with the land use information. The index information acquisition unit 170 refers to the index information DB to acquire, as target index information of a target index value of the attention management, index information indicated by the land use information and associated with a land use method of the target farm field when the attention management is performed. The index information acquisition unit 170 supplies the target index information to the distribution estimation unit 171.

The target index information is supplied from the index information acquisition unit 170, and the pre-transition index value are supplied from the acquisition unit 41 to the distribution estimation unit 171. Similarly to the distribution estimation unit 51 in FIG. 7, the distribution estimation unit 171 calculates pre-transition distribution information regarding the distribution of the pre-transition index values based on the pre-transition index value and supplies the pre-transition distribution information to the test unit 172. Furthermore, the distribution estimation unit 171 specifies target distribution information regarding the distribution of the target index values based on the target index information from the index information acquisition unit 170, and supplies the target distribution information to the test unit 172.

The test unit 172 performs the statistical test of a difference between the distribution of the pre-transition index values and the distribution of the target index values based on the pre-transition distribution information and the target distribution information from the distribution estimation unit 171. The test unit 172 supplies the distribution of the test statistic obtained by the statistical test of the difference between the distribution of the pre-transition index values and the distribution of the target index values to the normalization combination unit 173.

The normalization combination unit 173 is supplied with the distribution of the test statistic from the test unit 172, is supplied with the transition degree of the index value from the evaluation unit 42, and is supplied with the fertilizer removal stage from the evaluation unit 121. The normalization combination unit 173 normalizes the test statistic as the transition degree from the evaluation unit 42 with the maximum value of the distribution of the test statistic (maximum value of the test statistic) obtained by the statistical test of the difference between the distribution of the pre-transition index values and the distribution of the target index values from the test unit 172. Furthermore, the normalization combination unit 173 normalizes the fertilizer removal stage from the evaluation unit 121 with the maximum value of the fertilizer removal stage. Then, the normalization combination unit 173 calculates a combination transition degree as a new transition degree by combining the normalized transition degree and the normalized fertilizer removal stage. As the combination transition degree, for example, a product of the transition degree after normalization and the fertilizer removal stage after normalization can be adopted.

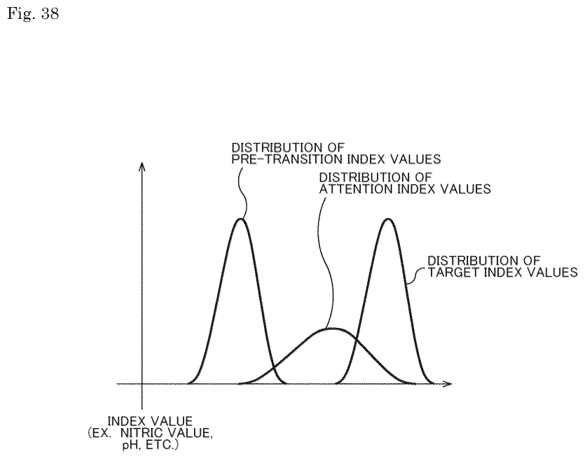

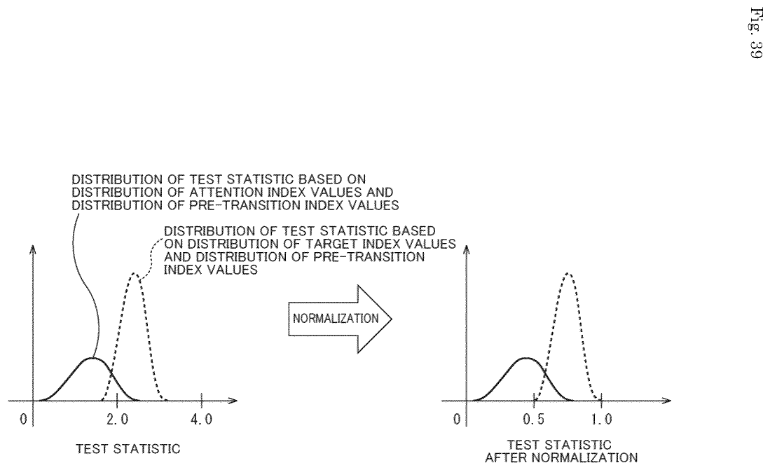

FIG. 38 is a diagram illustrating an example of the distribution of the target index values, the distribution of the pre-transition index values, and the distribution of the attention index values.

As the attention management is performed, the distribution of the index values is changed from the distribution of the pre-transition index values to the distribution of the attention index values, and the ecosystem management is performed aiming at the distribution of the target index values. In this case, the maximum value of the test statistic as the transition degree is the maximum value of the test statistic obtained by the statistical test of the difference between the distribution of the pre-transition index values and the distribution of the target index values.

FIG. 39 is a diagram for explaining an example of normalization of a test statistic as a transition degree in the normalization combination unit 173.

FIG. 39 illustrates an example of the distribution of the test statistic based on the distribution of the attention index values and the distribution of the pre-transition index values, and the distribution of the test statistic based on the distribution of the target index values and the distribution of the pre-transition index values.

The distribution of the test statistic based on the distribution of the attention index values and the distribution of the pre-transition index values is the distribution of the test statistic obtained by the statistical test of the difference between the distribution of the attention index values and the distribution of the pre-transition index values.

The distribution of the test statistic based on the distribution of the target index values and the distribution of the pre-transition index values is distribution of the test statistic obtained by a statistical test of a difference between the distribution of the target index values and the distribution of the pre-transition index values, and is obtained by the test unit 172.

The normalization combination unit 173 normalizes (divides) a test statistic (a test statistic based on the distribution of the attention index values and the distribution of the pre-transition index values) as the transition degree with the maximum value of the distribution of the test statistic based on the distribution of the target index values and the distribution of the pre-transition index values obtained by the test unit 172. As a result, the test statistic as the transition degree is a value in a range of 0 to 1.

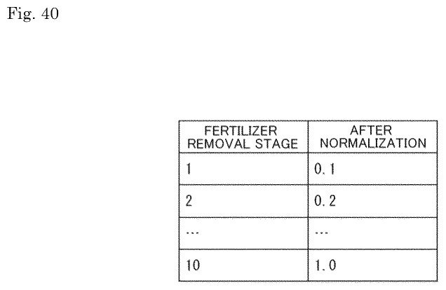

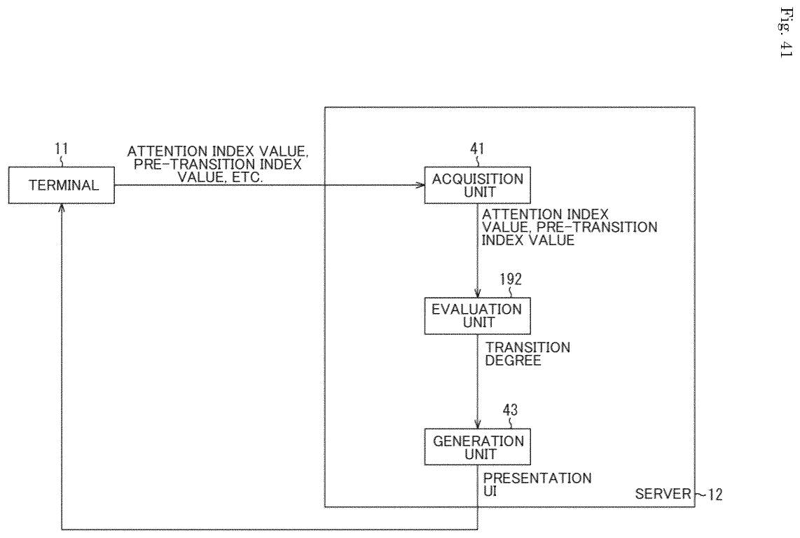

FIG. 40 is a diagram for explaining an example of normalization of the fertilizer removal stage by the normalization combination unit 173.

For example, in a case where the fertilizer removal stage is 10 stages of 1 to 10, the normalization combination unit 173 normalizes the fertilizer removal stage with 10, which is the maximum value of the fertilizer removal stage, to set the value to a range of 0 to 1.

As described above, the normalization combination unit 173 performs the multiplication of the test statistic as the transition degree normalized to the range of 0 to 1 and the fertilizer removal stage as a combination to calculate the combination transition degree.

### <Example of Seventh Functional Configuration of Server 12>

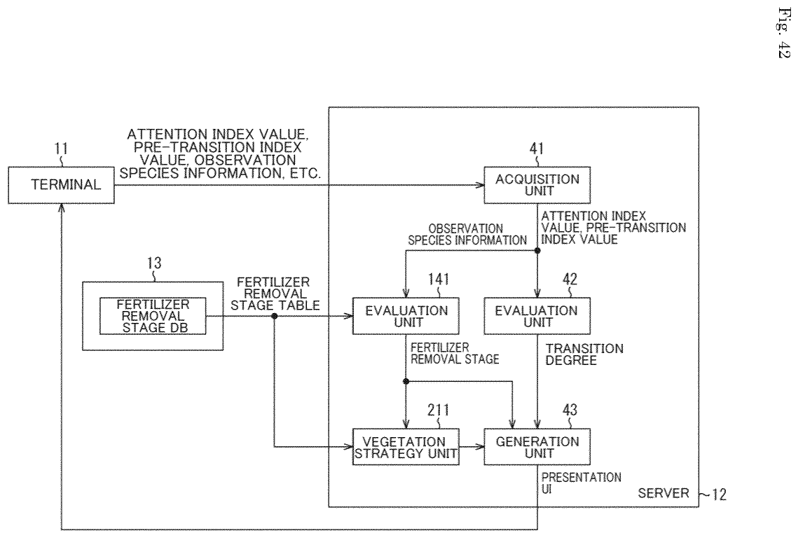

FIG. 41 is a block diagram illustrating an example of a seventh functional configuration of the server 12.

In the drawing, the elements corresponding to those in FIG. 5 are designated by the same characters and their description will not be repeated.

In FIG. 41, the server 12 includes an acquisition unit 41, a generation unit 43, and an evaluation unit 192. Therefore, the server 12 of FIG. 41 is common to the case of FIG. 5 in including the acquisition unit 41 and the generation unit 43, and is different from the case of FIG. 5 in that an evaluation unit 192 is provided instead of the evaluation unit 42.

The evaluation unit 42 in FIG. 5 evaluates the transition degree of the index value for the entire target farm field, and the evaluation unit 192 evaluates the transition degree of the index value for each section of the target farm field based on the distribution of the attention index values of each section and the distribution of the pre-transition index values. Then, the evaluation unit 92 supplies the transition degree for each section to the generation unit 43.

In the evaluation (calculation) of the transition degree of the index value for each section, a value based on (the magnitude of) a difference V1 between the average values as the center difference degree between a distribution DD1 of the attention index values of the sections and a distribution DD2 of the pre-transition index values and (the magnitude of) a difference V2 between the standard deviations as the variation difference degree between the distributions DD1 and DD2 can be calculated as the transition degree. In addition, for example, a value based on both the difference V1 between the average values and the difference V2 between the standard deviations, a value indicating the presence or absence of a significant difference between the distributions DD1 and DD2 by a statistical test, or a value based on a test statistic obtained by the statistical test can be calculated as the transition degree.

When the pre-transition index value can be acquired for each section, distribution estimated for each section from the pre-transition index value that can be acquired for each section can be adopted as the distribution of the pre-transition index values of each section.

In a case where the information (for example, the average value, the standard deviation, and the like) of the distribution of the pre-transition index values of the entire target farm field can be acquired, the distribution of the pre-transition index values can be commonly adopted as the distribution of the pre-transition index values of each section.

In a case where the pre-transition management (alternatively, the land use method when the pre-transition management has been performed in the target farm field) is known, as described in FIG. 21, the distribution of the pre-transition index values specified based on the index information associated with the land use method when the pre-transition management has been performed in the index information DB can be commonly adopted as the distribution of the pre-transition index values of each section.

According to the transition degree of each section, the user can compare the degree of influence of the attention management received by each section, and the transition degree of each section is the support information of the optimization of the ecosystem management of each section.

### <Example of Eighth Functional Configuration of Server 12>

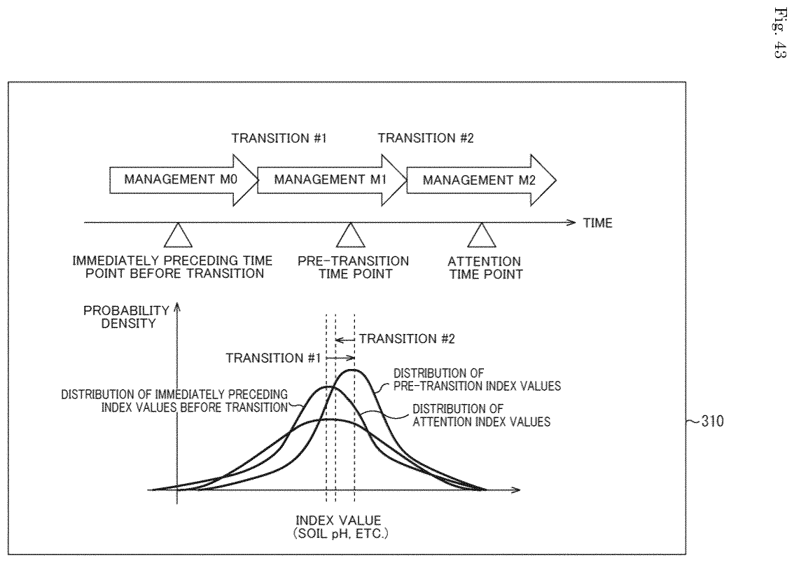

FIG. 42 is a block diagram illustrating an example of an eighth functional configuration of the server 12.

In the drawing, the elements corresponding to those in FIG. 28 are designated by the same characters and their description will not be repeated.

In FIG. 42, the server 12 includes an acquisition unit 41, an evaluation unit 42, a generation unit 43, an evaluation unit 121, and a vegetation strategy unit 211. Therefore, the server 12 of FIG. 42 is common to the case of FIG. 28 in including the acquisition unit 41 to the generation unit 43 and the evaluation unit 121, and is different from the case of FIG. 28 in newly providing the vegetation strategy unit 211.

The fertilizer removal stage of the target farm field is supplied from the evaluation unit 121 to the vegetation strategy unit 211. The vegetation strategy unit 211 refers to the fertilizer removal stage table of the fertilizer removal stage DB, and generates a vegetation strategy (including a planting plan) of the target farm field based on the fertilizer removal stage of the target farm field from the evaluation unit 121.

For example, the vegetation strategy unit 211 can generate, as the vegetation strategy, a list of all the plant species constituting the vegetation pattern associated with the fertilizer removal stage next to the fertilizer removal stage of the target farm field or the plant species having the coverage equal to or greater than the threshold in the fertilizer removal stage table.

The vegetation strategy unit 211 supplies the vegetation strategy to the generation unit 43. In this case, the generation unit 43 generates a presentation UI that presents the vegetation strategy and the like from the vegetation strategy unit 211, and transmits the presentation UI to the terminal 11.

When the user introduces the plant species according to the vegetation strategy into the target farm field, fertilizer removal by bioremediation of the plant species according to the vegetation strategy and the microbial species living in symbiosis with the plant species is promoted (expected).

Note that, in FIG. 42, the server 12 can be configured without the evaluation unit 42. In a case where the server 12 is configured without the evaluation unit 42, it is not necessary to transmit the attention index value and the pre-transition index value from the terminal 11 to the server 12.

### <Presentation UI>

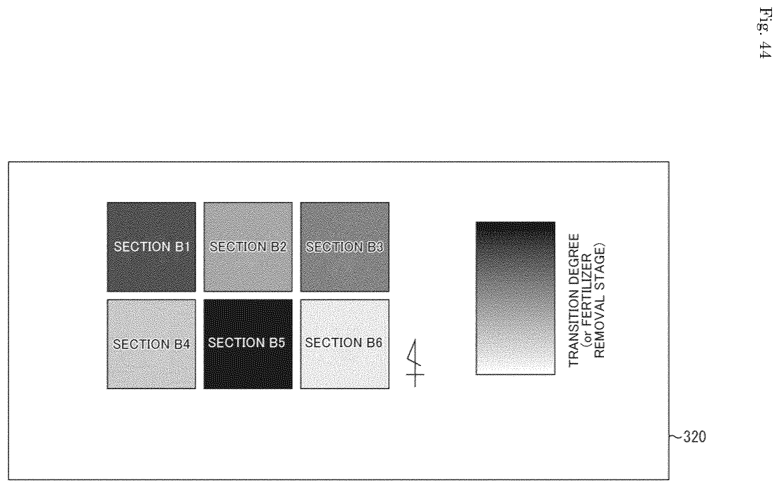

FIG. 43 is a diagram illustrating a first display example of the presentation UI.

The generation unit 43 can generate a presentation UI that presents various types of information regarding the target farm field including the transition degree of the index value of the target farm field. According to the presentation UI, various types of information regarding the target farm field can be presented to the user in an easy-to-understand manner.

In a presentation UI 310 of FIG. 43, as the information regarding the target farm field, the ecosystem management performed in the target farm field is indicated along a time axis by an arrow having a length corresponding to a period of the ecosystem management. In FIG. 43, first, the ecosystem management M0 is performed, and thereafter, the ecosystem management M0 transitions to the ecosystem management M1. Further, the ecosystem management transitions from the ecosystem management M1 to the ecosystem management M2. The ecosystem management M0 is, for example, natural leaving, and the ecosystem management M1 is, for example, conventional farmings or organic farmings. The ecosystem management M2 is, for example, Synecoculture (registered trademark).

On the time axis, a time point at which the index value is acquired in a period in which each ecosystem management is performed is indicated by a triangle. In FIG. 43, the ecosystem management M0 to M2 are immediately preceding management before transition, pre-transition management, and attention management, respectively. Then, an immediately preceding time point before transition at which the immediately preceding index value before transition is acquired, a pre-transition time point at which the pre-transition index value is acquired, and an attention time point at which the attention index value is acquired are illustrated.

In the presentation UI 310, the distribution of the index values, that is, the distribution of the attention index values, the distribution of the pre-transition index values, and the distribution of the immediately preceding index values before transition are further displayed as the information regarding the target farm field. In the distribution of the index values, a transition (movement) of a center (for example, the average value) of the distribution of the index values accompanying the transition of the ecosystem management is indicated by an arrow.

In FIG. 43, (the center of) the distribution of the index values moves from left to right along with transition #1 from the ecosystem management M0 to the ecosystem management M1. Further, along with transition #2 from the ecosystem management M1 to the ecosystem management M2, the distribution of the index values moves from the right to the left, that is, toward the center of the distribution of the index values in the ecosystem management M0. From this, the user can grasp that the index value transitions (changes) in a direction in which the influence of the conventional farming or the organic farming as the ecosystem management M1 is removed by the implementation of Synecoculture (registered trademark) as the ecosystem management M2.

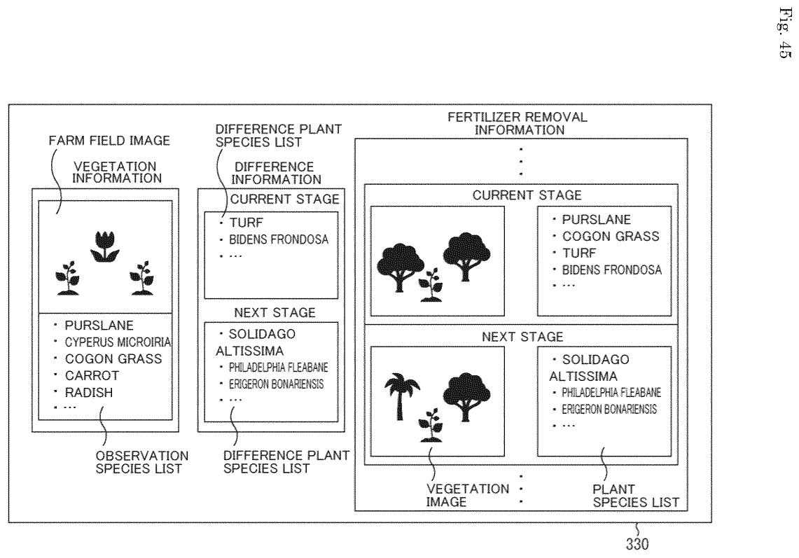

FIG. 44 is a diagram illustrating a second display example of the presentation UI.

In a presentation UI 320 of FIG. 44, the transition degree for each section is displayed in the form of a heat map as the information regarding the target farm field. That is, the transition degree of the section is displayed in a color or brightness corresponding to the transition degree in each section (in FIG. 44, sections B1 to B6) appearing in the bird's-eye view image of the target farm field.

In the presentation UI, in addition to the transition degree, various parameters such as the fertilizer removal stage and the average value of the distribution of the index values can be similarly displayed.

FIG. 45 is a diagram illustrating a third display example of the presentation UI.

In a presentation UI 330 of FIG. 45, vegetation information, difference information, and fertilizer removal information are displayed on the left, the center, and the right, respectively, as the information regarding the target farm field.

The vegetation information is information regarding vegetation of the target farm field, and in FIG. 45, the vegetation information includes a farm field image in which vegetation of the target farm field is captured, and an observation species list which is a list of (species names of) observation species of the target farm field. The observation species list can include the coverage of the observation species in addition to the observation species.

The difference information is information regarding a difference between the observation species of the target farm field and the plant species constituting the vegetation pattern associated with the fertilizer removal stage in the fertilizer removal stage table. That is, the difference information is information regarding plant species (hereinafter, also referred to as a difference plate species) that is not included in the observation species of the target farm field among the plant species among the plant species (hereinafter, also referred to as fertilizer removal plant species) constituting the vegetation pattern associated with the fertilizer removal stage in the fertilizer removal stage table. In FIG. 45, the difference information includes a difference plant species list that is a list of difference plant species for the current fertilizer removal stage (current stage) of the target farm field, and a difference plant species list that is a list of difference plant species for the next fertilizer removal stage (next stage). The next fertilizer removal stage is a stage in which the fertilizer removal is advanced by one stage from the current stage.

The fertilizer removal information is information of each fertilizer removal stage. In FIG. 45, the fertilizer removal information includes a plant species list which is a list of typical plant species (for example, a fertilizer removal plant species having a coverage equal to or greater than a threshold value) among the fertilizer removal plant species constituting the vegetation pattern associated with each fertilizer removal stage in the fertilizer removal stage table. Further, the fertilizer removal information includes a vegetation image showing typical vegetation of the vegetation pattern associated with each fertilizer removal stage in the fertilizer removal stage table.

As described above, the fertilizer removal information includes the plant species list and the vegetation image for each fertilizer removal stage of the fertilizer removal stage table. In FIG. 45, the plant species list and the vegetation image for the current fertilizer removal stage (current stage) of the target farm field and the plant species list and the vegetation image for the next fertilizer removal stage (next stage) are displayed so as to be distinguishable from each other. The plant species list and the vegetation image for the other fertilizer removal stage can be scrolled and displayed.

As described above, in the presentation UI 330, the fertilizer removal stage of the target farm field can be presented by displaying the plant species list and the vegetation image for the current fertilizer removal stage (current stage) of the target farm field so as to be distinguishable from the plant species list and the vegetation image for other fertilizer removal stages, instead of displaying the value itself of the fertilizer removal stage.

The user can grasp the current vegetation of the target farm field by referring to the vegetation information. Furthermore, the user can grasp the current fertilizer removal stage of the target farm field by referring to the fertilizer removal information. Further, the user can use the difference information as auxiliary information for making a vegetation strategy. For example, for the purpose of progressing the fertilizer removal, the user can set up a vegetation strategy in which the difference plant species in the difference plant species list for the current fertilizer removal stage (current stage) of the farm field is introduced so that the coverage becomes 10%, and the difference plant species in the difference plant species list for the next fertilizer removal stage (next stage) is introduced so that the coverage becomes 20%.

All or some of the above-described configuration examples can be combined as long as no contradiction occurs. For example, in the third functional configuration example of the server 12 of FIG. 25, instead of the pre-transition index value, the land use history is transmitted from the terminal 11 as in the case of FIG. 21, and the distribution of the pre-transition index values can be specified based on the land use history. Furthermore, for example, in the example of the fifth functional configuration of the server 12 in FIG. 32, the combination unit 161 can be provided as in the case of FIG. 36. Furthermore, for example, in the example of the sixth functional configuration of the server 12 in FIG. 36, a vegetation strategy unit 211 can be provided as in FIG. 42.

### <Presentation UI Presenting Functional Diversity>

The paper shows that the higher the biological diversity of the plant on the earth's surface of the ecosystem, the more biomass, and the biomass is stabilized even after time elapses. Taking advantage of this knowledge, one goal of Synecoculture (registered trademark) is to enhance the biological diversity of plants on the ground. Regarding the enhancement of the biological diversity, it is recommended to enhance the functional diversity in the community ecology by using knowledge of the community ecology. In community ecology, it is considered important to enhance functional diversity in order to enhance biomass and robustness in the ground surface.

For example, in a case where some operation (work) is performed on the ecosystem in order to increase the functional diversity, it is necessary for the user to grasp the functional diversity of the ecosystem in order to confirm how the functional diversity of the ecosystem is changed by the operation. Therefore, it is desirable to express functional diversity in some form and present it to the user.

As an expression method of functional diversity, a method of calculating various indexes has been proposed, and further, a proposal of a new expression method has been requested. Hereinafter, a presentation UI that presents functional diversity by a new expression method will be described.

For example, the presentation UI that presents the functional diversity can be generated by causing the user to periodically or irregularly perform the vegetation survey of the ecosystem such as the agricultural farm and using the survey result (vegetation survey result) of the vegetation survey. The user can input the vegetation survey result and transmit the vegetation survey result to the server 12 by operating the terminal 11. The server 12 can generate a presentation UI that presents functional diversity by using the vegetation survey result from the terminal 11, and transmit the presentation UI to the terminal 11 for display.

When the user inputs the vegetation survey result to the terminal 11, the server 12 can generate a presentation UI functioning as the input I/F of the input, transmit the presentation UI to the terminal 11, and display the presentation UI.

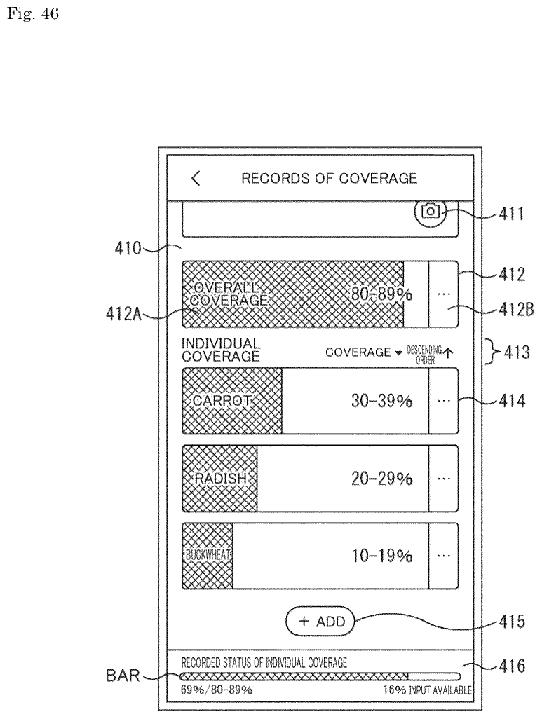

FIG. 46 is a diagram illustrating a display example of a presentation UI functioning as an input I/F for inputting a vegetation survey result.

In FIG. 46, a presentation UI 410 includes a photographing button 411, an overall coverage display unit 412, a sort button 413, an individual coverage display unit 414, an add button 415, and a status display unit 416 (as the GUI) arranged in this order from the top.

The presentation UI 410 can be generated for each ecosystem in units of survey in which the user conducts a vegetation survey. As the units of survey, for example, the user can determine an arbitrary range such as one agricultural farm, one farm field, and one ridge.

The photographing button 411 is operated when the terminal 11 captures an image. The image photographed by operating the photographing button 411 is stored in the terminal 11 in association with the presentation UI 410 including the photographing button 411. Therefore, in a case where the user operates the photographing button 411 included in the presentation UI 410 generated for the ecosystem of a certain unit U of survey and photographs the ecosystem of the unit U of survey, the image of the ecosystem of the unit U of survey obtained by the photographing is stored in association with the presentation UI 410 generated for the ecosystem of the unit U of survey. The terminal 11 can display the image associated with the presentation UI 410 by performing a predetermined operation on the presentation UI 410 generated for the ecosystem of the unit U of survey. As a result, the user can confirm the image of the ecosystem of the unit U of survey from the presentation UI 410 generated for the ecosystem of the unit U of survey.

Here, the unit of survey to which the vegetation survey result is input to the presentation UI 410 is also referred to as a target unit of survey. In the vegetation survey, for example, (species names of) plant species growing in the ecosystem of the target unit of survey, a coverage at which each plant species covers the ecosystem of the target unit of survey, and an overall coverage which is a coverage at which the entire plant growing in the ecosystem of the target unit of survey covers the ecosystem are observed (surveyed). In the vegetation survey, for example, it is possible to observe (the species name of) the plant species harvested in the ecosystem of the target unit of survey, the yield (weight) of each harvested plant species, and other necessary information.

The overall coverage display unit 412 is operated in a case where the overall coverage of the ecosystem of the target unit of survey is input. The overall coverage display unit 412 displays the overall coverage input by operating the overall coverage display unit 412.

The overall coverage display unit 412 has a horizontally long rectangular shape, and includes a slide bar 412A and a menu button 412B.

The slide bar 412A can be operated so as to slide in the lateral direction starting from the left end of the rectangle as the overall coverage display unit 412. The slide bar 412A can be moved (slid) so that the coverage can be input stepwise in increments of 10% with a value having a width of 10%, such as 0 to 9%, 10 to 19%, . . . , for example. The user can input the overall coverage by operating the slide bar 412A. The menu button 412B is operated, for example, when the overall coverage is input again (corrected).

Note that the slide bar 412A can be configured such that 0 to 100% coverage can be input continuously instead of stepwise such as in 10% increments. However, what the user can obtain by observing (looking at) the ecosystem of the target unit of survey is a coverage having a certain degree of error. As described above, the overall coverage is input stepwise by a value having a width in consideration of a certain degree of error in the input overall coverage. The same applies to the individual coverage ratio described later.

The sort button 413 is operated when sorting the individual coverage display unit 414 arranged below the sort button 413. The sorting of the individual coverage display unit 414 can be performed in descending order or ascending order of the coverage, the species name of the plant species, and the like. In FIG. 46, the individual coverage display unit 414 is sorted in descending order of coverage.

The individual coverage display unit 414 is operated in a case where an individual coverage of one plant species having a coverage covering the ecosystem of the target unit of survey is input. The individual coverage display unit 414 displays the individual coverage input by operating the individual coverage display unit 414. In addition, the individual coverage display unit 414 is operated when the individual coverage display unit 414 inputs a species name (carrot, radish, buckwheat, etc.) of a target plant species for which the individual coverage is to be displayed, and displays the species name. The individual coverage display unit 414 is configured similarly to the overall coverage display unit 412, and the individual coverage can be input similarly to the case of inputting the overall coverage in the overall coverage display unit 412.

The add button 415 is operated when the individual coverage display unit 414 is added to the presentation UI 410. In a case where the user newly observes the plant species to which the individual coverage is not input in the ecosystem of the target unit of survey, the user can operate the add button 415. In this case, in the presentation UI 410, a new individual coverage display unit 414 is additionally arranged according to the operation of the add button 415. The user can input the species name of the newly observed plant species and the individual coverage of the plant species by operating the new individual coverage display unit 414. In a case where the number of the individual coverage display units 414 arranged in the presentation UI 410 increases and cannot be arranged, a scroll bar for scrolling and displaying the individual coverage display unit 414 is displayed in the presentation UI 410.

The status display unit 416 displays the input (recording) status of the individual coverage in the form of a bar (bar graph) extending rightward from the left end as a start point.

In theory, in a case where the individual coverages of all the plant species growing in the ecosystem of the target unit of survey are input, a total value of the individual coverages coincides with the overall coverage. The status display unit 416 displays the total value of the individual coverages displayed on each individual coverage display unit 414 in the form of a bar, using the overall coverage displayed on the overall coverage display unit 412 as the maximum value of the bar. In addition, the status display unit 416 can display the total value of the overall coverage and the individual coverage as a numerical value or display a numerical value obtained by subtracting the total value of the individual coverage from the overall coverage as the remaining value to which the individual coverage can be input.

In the vegetation survey of the ecosystem of the target unit of survey, the user first observes the overall coverage and inputs the coverage to the presentation UI 410. Thereafter, the user sequentially observes the individual coverage of each plant species and inputs the coverage to the presentation UI 410. In the presentation UI 410, each time the user inputs the individual coverage of the plant species, the bar of the status display unit 416 changes (extends) according to the total value of the individual coverages input so far. The user can easily grasp the progress of the observation of the individual coverage by viewing the bar of the status display unit 416. For example, the user can grasp how much the individual coverage has been observed and how much more needs to be performed.

Furthermore, the user can determine whether to terminate the observation of the individual coverage of the plant species by viewing the bar of the status display unit 416. For example, when the bar of the status display unit 416 reaches the left end or reaches near the left end, the user can terminate the observation of the individual coverage of the plant species. As a result, it is possible to complete the observation of the individual coverage of the plant species in the ecosystem of the target unit of survey in a short time.

That is, every time the user finds a new plant species for which the individual coverage is not observed in the ecosystem of the target unit of survey, the user observes the individual coverage of the new plant species. The new plant species include plant species that can be easily found at a glance, and also include plant species that cannot be easily found without detailed observation because, for example, the plant species are hidden behind other plant species. Since it is not possible to grasp all of the plant species that inhabit the ecosystem of the target unit of survey in advance, if it is attempted to find all of the plant species that are difficult to find in addition to the plant species that are easy to find, a huge amount of unrealistic time is required for the vegetation survey. Therefore, it is desirable to terminate the observation of the individual coverage when a certain degree of observation has been completed. The user can grasp the progress of the observation of the individual coverage and determine whether to terminate the observation of the individual coverage by viewing the bar of the status display unit 416. As a result, the observation of the individual coverage can be completed in a short time.

In the presentation UI 410 of FIG. 46, the bar of the status display unit 416 indicates 69% that is the total value of the individual coverages input to the individual coverage display unit 414, where the maximum value of the bar (the right end of the bar) is 80 to 89% (for example, 89% as the maximum value) that is the overall coverage. In this case, since the total value of the individual coverages input to the individual coverage display unit 414 has not reached the maximum value of the bar of the status display unit 416, the user can determine that the observation of the individual coverage should be continued.

The individual coverage input to the individual coverage display unit 414 is a value having a width of 10% as described in the overall coverage display unit 412. As the total value of the individual coverages input to the individual coverage display unit 414, for example, an addition value of 9% and a total value (in FIG. 46, 30%+20%+10%) of minimum values of individual coverages of values having a width of 10% can be adopted.

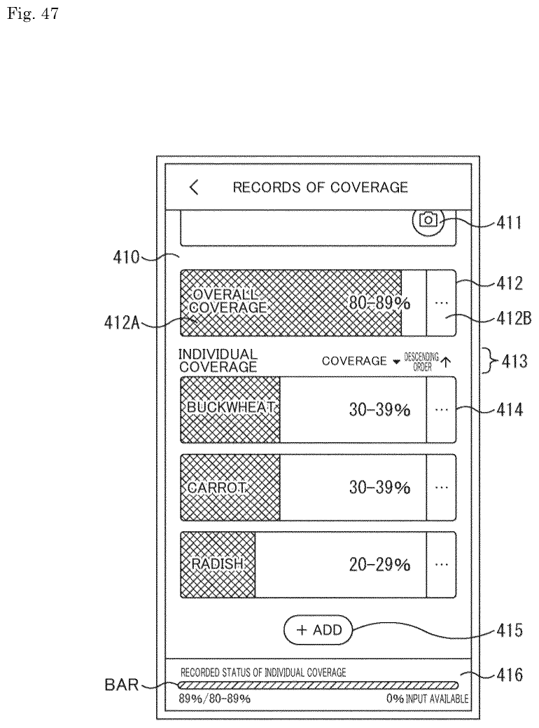

FIG. 47 is a diagram illustrating the presentation UI 410 in a state in which the individual coverage is input until the total value of the individual coverages input to the individual coverage display unit 414 coincides with the maximum value of the bar of the status display unit 416.

In the presentation UI 410 of FIG. 47, the individual coverage is input until the total value of the individual coverages input to the individual coverage display unit 414 coincides with the maximum value (89%) of the bar of the status display unit 416. Therefore, the bar of the status display unit 416 extends (reaches) to the right end indicating the maximum value of the bar.

In this case, the user may determine that the observation of the individual coverage may be terminated.

When the individual coverage is input until the total value of the individual coverages input to the individual coverage display unit 414 coincides with the maximum value of the bar of the status display unit 416, the bar of the status display unit 416 can be displayed in a display state different from the case of FIG. 46 in which the total value of the individual coverages does not reach the maximum value of the bar of the status display unit 416 in order to facilitate understanding. For example, the bar of the status display unit 416 in FIG. 47 can be displayed in a color, luminance, or the like different from those in the case of FIG. 46. Specifically, for example, when the bar of the status display unit 416 in FIG. 46 is displayed in green, the bar of the status display unit 416 in FIG. 47 can be displayed in yellow.

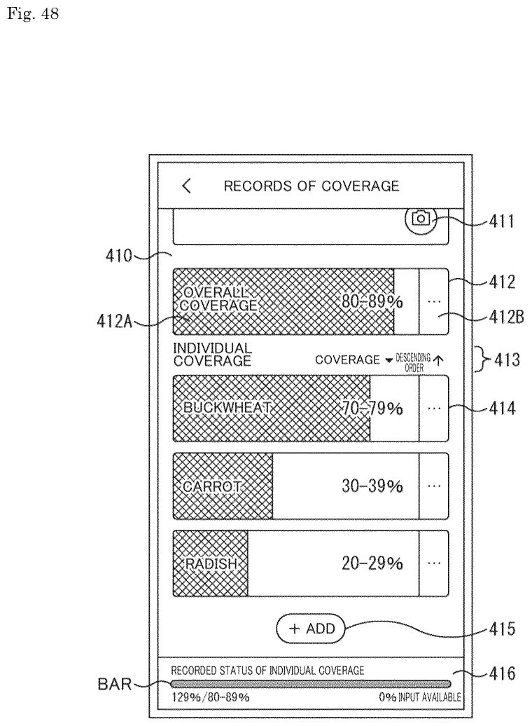

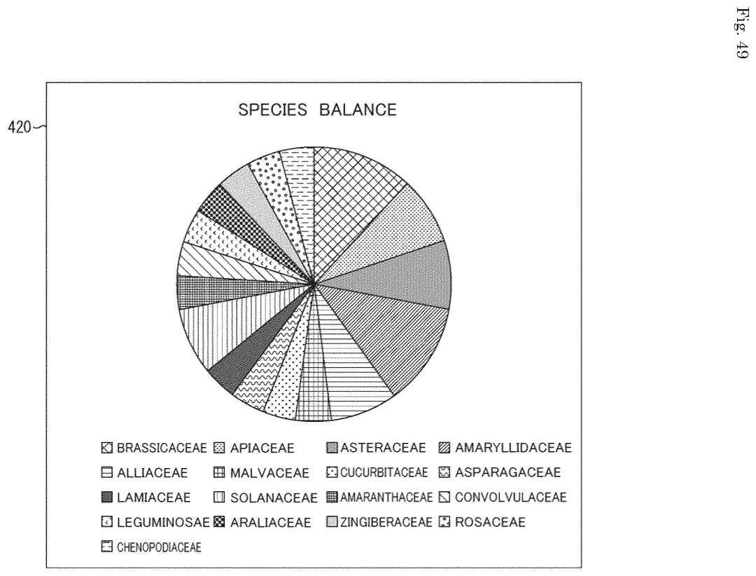

FIG. 48 is a diagram illustrating a presentation UI 410 in a state where the individual coverage is input until the total value of the individual coverages input to the individual coverage display unit 414 exceeds the maximum value of the bar of the status display unit 416.

In the presentation UI 410 of FIG. 48, the individual coverage is input until the total value of the individual coverages input to the individual coverage display unit 414 exceeds the maximum value (89%) of the bar of the status display unit 416. Since the bar of the status display unit 416 cannot extend beyond the right end indicating the maximum value of the bar, the bar of the status display unit 416 extends to the right end indicating the maximum value of the bar.

In this case, it is difficult to distinguish from the state in which the individual coverage is input until the total value of the individual coverages input to the individual coverage display unit 414 coincides with the maximum value of the bar of the status display unit 416. Therefore, when the total value of the individual coverages exceeds the maximum value of the bar of the status display unit 416, the bar of the status display unit 416 can be displayed in a display state different from the case of FIG. 47 in which the total value of the individual coverages reaches the maximum value of the bar of the status display unit 416. For example, the bar of the status display unit 416 in FIG. 48 can be displayed in a color, luminance, or the like different from those in the case of FIG. 47. Specifically, for example, when the bar of the status display unit 416 in FIG. 47 is displayed in yellow, the bar of the status display unit 416 in FIG. 48 can be displayed in red.

In addition, in the case of FIG. 47 in which the total value of the individual coverages coincides with the maximum value of the bar of the status display unit 416, and in the case of FIG. 48 in which the total value of the individual coverages exceeds the maximum value of the bar of the status display unit 416, in order to notify the user that the observation of the individual coverages may be terminated, display can be performed in a display state that attracts the attention of the user, such as blinking the bar of the status display unit 416.

The vegetation survey result input to the presentation UI 410 is transmitted from the terminal 11 to the server 12. The terminal 11 can transmit the vegetation survey result to the server 12 in association with the survey date when the vegetation survey has been conducted.

As described above, in the vegetation survey, the plant species growing in the ecosystem of the target unit of survey, the individual coverage of the plant species, the overall coverage of the ecosystem of the target unit of survey, the yield of the harvested plant species, and the like are observed. Here, in the vegetation survey, a plant species observed in the ecosystem of the target unit of survey is also referred to as an observed plant species. The vegetation survey result transmitted from the terminal 11 to the server 12 can include (the species name of) the observed plant species, the individual coverage, the overall coverage, the yield, and the like as necessary.

When the user performs an operation on the presentation UI 410 so as to present the functional diversity, the server 12 generates the presentation UI that presents the functional diversity by using the vegetation survey result from the terminal 11, and transmits the presentation UI to the terminal 11 for display.

Hereinafter, a display example of a presentation UI that presents functional diversity will be described, but which presentation UI is to be displayed can be selected, for example, by the user operating the terminal 11.

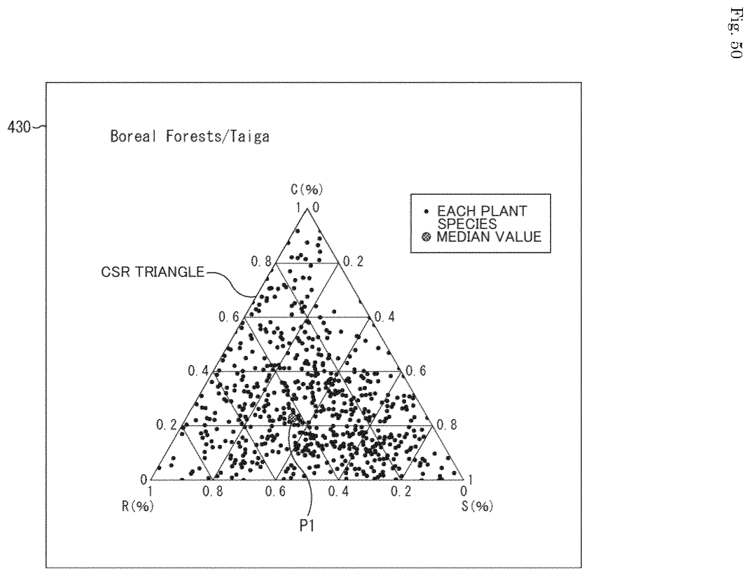

FIG. 49 is a diagram illustrating a first display example of the presentation UI that presents functional diversity.

The server 12 classifies the observed plant species as the vegetation survey result of the predetermined survey date from the terminal 11 at the family level and performs statistical processing. For example, the server 12 counts the number of species of the observed plant species for each family, and generates a pie chart (circle chart for the number of species for each family) representing the number of species of the observed plant species belonging to each family. The server 12 generates a presentation UI 420 that displays a pie chart of a species number for each family, and transmits the presentation UI 420 to the terminal 11 for display. The user can designate the survey date of the vegetation survey result used to generate the presentation UI 420 by operating the terminal 11.

In the pie chart of a species number for each family displayed by the presentation UI 410, the number of sectors is equal to the total number of families of the observed plant species, and the central angle of the sector is proportional to the number of species of the observed plant species belonging to the family represented by the sector.

The pie chart of a species number for each family of the ecosystem of the target unit of survey expresses (one aspect of) the functional diversity of the ecosystem. That is, the number of species of the observed plant species belonging to each family can be regarded as one kind of index expressing the genetic diversity of the ecosystem of the target unit of survey. Further, the genetic diversity of the ecosystem of the target unit of survey simply expresses the functional diversity of the ecosystem. Therefore, it can be said that the pie chart of a species number for each family representing the number of species of the observed plant species of the ecosystem of the target unit of survey for each family represents (the construction degree of) the functional diversity of the ecosystem.

As the number of observed plant species belonging to each family is uniform and the number of families is larger, functional diversity is higher. Therefore, according to the presentation UI 420 that displays the pie chart of a species number for each family, the user can grasp the degree of functional diversity of the ecosystem of the target unit of survey by the uniformity and the number of sectors (central angles) of the pie chart of a species number for each family. For example, the user can grasp that the functional diversity of the ecosystem of the target unit of survey is high by confirming that the number of species of the observed plant species of the ecosystem of the target unit of survey is not biased to a specific family or the number of families is large.

Note that, in a case where the functional diversity is high, it is presumed that the construction of the extended ecosystem is in progress. Therefore, the pie chart of a species number for each family expressing functional diversity can be used as an index indicating the construction degree of the extended ecosystem.

Since the presentation UI 420 that presents the functional diversity is generated using the observed plant species, the user can easily generate the presentation UI 420 by observing at least the plant species growing in the ecosystem of the target unit of survey in the vegetation survey. Therefore, with the presentation UI 420, the user can easily grasp functional diversity without taking much time and cost.

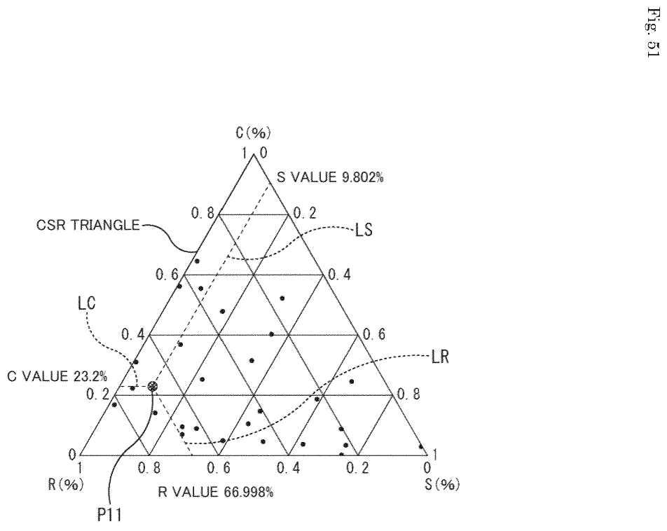

FIG. 50 is a diagram illustrating a second display example of the presentation UI that presents functional diversity.

The server 12 generates a CSR triangle obtained by plotting (the CSR value representing the survival strategy of) the observed plant species as the vegetation survey result of the predetermined survey date from the terminal 11. The server 12 generates a presentation UI 430 that displays the CSR triangle, and transmits the presentation UI 430 to the terminal 11 for display. The user can designate the survey date of the vegetation survey result used to generate the presentation UI 430 by operating the terminal 11.

The CSR triangle is a triangle representing the classification of plants according to a hypothesis regarding the survival strategy of plants in plant ecology. The vertexes C, S, and R of the CSR triangle represent survival strategies. C represents a competition strategy and S represents a stress strategy. R represents a ruderal strategy.

The server 12 generates a CSR triangle in which an observed plant species is plotted on a point having a C value, an S value, and an R value as coordinates, representing the degree (index) of C, S, and R of the observed plant species. The C value, the S value, and the R value are also collectively referred to as CSR values. The server 12 can calculate a representative value of the CSR values for all of the observed plant species, for example, a statistical value such as a median value or an average value, and plot the value in the CSR triangle. In the CSR triangle of FIG. 50 (the same applies to the CSR triangle of the drawing described later), a small point represents the CSR value of the observed plant species, and a large point P1 represents a median value as a representative value of the CSR values of all the observed plant species.

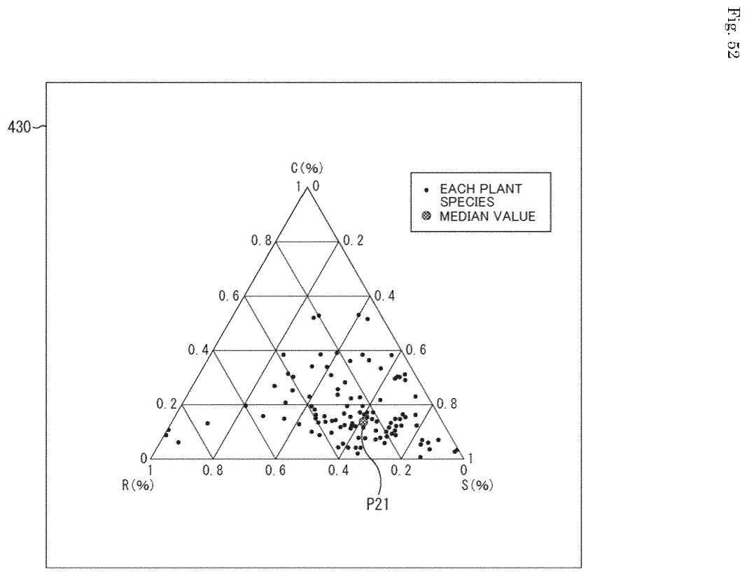

FIG. 51 is a diagram for explaining the CSR triangle.

In the CSR triangle, the CS axis from vertex C to vertex S represents an S value, and the SR axis from vertex S to vertex R represents an R value. The RC axis from vertex R to vertex C represents a C value.

The CSR value is expressed in %, and a larger value indicates a greater degree of adopting a competition strategy (C), a stress strategy(S), and a ruderal strategy (R). In the drawing, 0, 0.2, 0.4, 0.6, 0.8, and 1 represent 0%, 20%, 40%, 60%, 80%, and 100% as CSR values.

The CSR value can take a value satisfying the formula C value+S value+R value=100%.

For a point on the CSR triangle, an intersection of a straight line LC passing through the point and parallel to the SR axis and the RC axis represents a C value. An intersection of a straight line LS, which passes through a point on the CSR triangle and is parallel to the RC axis, and a CS axis represents an S value. An intersection of a straight line LR, which passes through a point on the CSR triangle and is parallel to the CS axis, and the SR axis represents an R value. In FIG. 51, the CSR value (C value, S value, R value) of the point P11 is (23.2%, 9.802%, 66.998%).

The CSR triangle displayed on the presentation UI 430 expresses (one aspect of) functional diversity of the ecosystem of the target unit of survey.

For example, in a case where an appropriate artificial operation (watering, securing sunlight, disturbance (harvest, pruning, etc.), introduction of a predetermined plant species (sowing, etc.), etc.) is not performed on the ecosystem of the target unit of survey and the functional diversity of the ecosystem is low, it is presumed that the distribution of (the point representing) the CSR values of the observed plant species is biased to any one of specific positions, for example, vertexes C, S, and R in the CSR triangle. Furthermore, it is presumed that the median value as the representative value of the CSR values of all the observed plant species is located at a place greatly deviated from the center (center of gravity) of the CSR triangle.

The user can grasp the degree of functional diversity of the ecosystem of the target unit of survey by the degree to which the distribution of the CSR values of the observed plant species is uniformly distributed in the CSR triangle and the proximity of the median value as the representative value of the CSR values of all the observed plant species to the center of the CSR triangle. For example, the user can grasp that the functional diversity of the ecosystem of the target unit of survey is high by confirming that the distribution of the CSR values of the observed plant species is uniformly distributed in the CSR triangle and that the median value as the representative value of the CSR values of all the observed plant species is close to the center of the CSR triangle. For example, in FIG. 50, the distribution of the CSR values of the observed plant species is uniformly distributed in the CSR triangle, and the median value as the representative value of the CSR values of all the observed plant species is close to the center of the CSR triangle. Therefore, the user can grasp that the functional diversity of the ecosystem of the target unit of survey is high, and further, that the management including the operation for the ecosystem of the target unit of survey is appropriate.

Since the presentation UI 430 that presents the functional diversity is generated using the observed plant species, similarly to the presentation UI 420, it is possible to easily generate the presentation UI 430 by the user observing at least the plant species growing in the ecosystem of the target unit of survey in the vegetation survey. Therefore, according to the presentation UI 430, the user can easily grasp functional diversity without taking much time and cost.

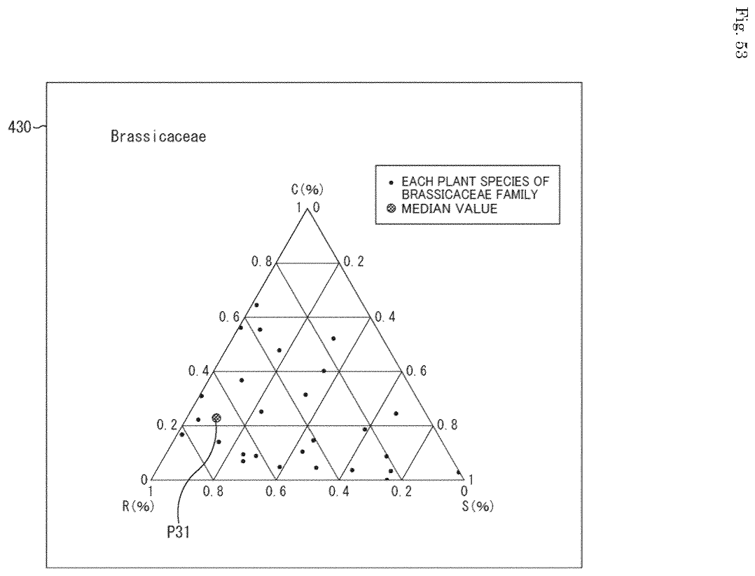

FIG. 52 is a diagram illustrating another display example of the presentation UI 430.

In FIG. 52, in the CSR triangle displayed on the presentation UI 430, the distribution of the CSR values of the observed plant species is biased toward the vertex S. Furthermore, a point P21 representing a median value as a representative value of the CSR values of all the observed plant species is also located toward the vertex S.

Therefore, according to the presentation UI 430 in FIG. 52, the user can grasp that the ecosystem of the target unit of survey is in an environment in which the plant species having a large degree of adopting the stress strategy(S) is likely to grow. In other words, for example, the user can grasp that the ecosystem of the target unit of survey is an environment in which stress due to stress factors such as lack of sunlight and lack of moisture is strong. As a result, in order to enhance the functional diversity of the ecosystem of the target unit of survey, the user can grasp that it is necessary to perform an operation (intervention) for removing a stress factor as an operation on the ecosystem, for example, securing sunlight by performing grass cutting or pruning of tall tree, watering, or the like.

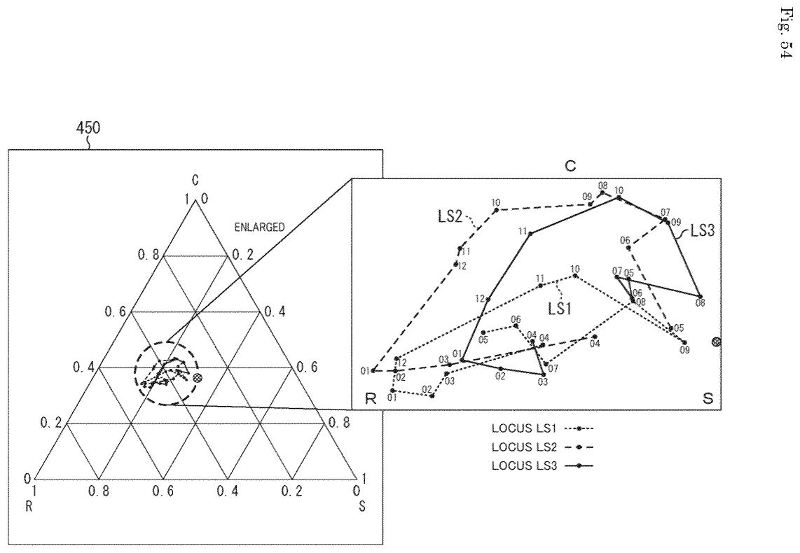

FIG. 53 is a diagram illustrating still another display example of the presentation UI 430.

In the presentation UI 430 of FIG. 50, a CSR triangle obtained by plotting CSR values of all the observed plant species as a vegetation survey result on a predetermined survey date is displayed. On the other hand, in the presentation UI 430 of FIG. 53, the CSR triangle obtained by plotting CSR values of observed plant species belonging to a specific family among observed plant species as a vegetation survey result on a predetermined survey date is displayed. In the CSR triangle obtained by plotting the CSR value of the observed plant species belonging to a specific family, a representative value of the CSR value of the observed plant species belonging to the specific family, for example, a statistical value such as a median value or an average value can be plotted. The point P31 represents a median value as a representative value of the CSR value of the observed plant species belonging to the specific family.

In the CSR triangle displayed on the presentation UI 430 of FIG. 53, the CSR value of the observed plant species belonging to the brassicaceous family and the median value as the representative value of the CSR value are plotted.

The survey date of the vegetation survey result used to generate the presentation UI 430 and the specific family can be designated by the user operating the terminal 11.

As the specific family, one or more families may be designated. In a case where a plurality of families is designated as the specific family, as the representative value of the CSR value, for each of the plurality of families as the specific family, in addition to displaying the representative value of the CSR value of the observed plant species belonging to the family, representative values of the CSR values of all the observed plant species belonging to each of the plurality of families can also be displayed.

The median value as the representative value (hereinafter, also referred to as a family representative value) of the CSR value of the observed plant species belonging to a predetermined family can be calculated, for example, as follows.

The C value, S value, and R value as the median values of the CSR values of the observed plant species belonging to the predetermined family m are represented as Cm, Sm, and Rm. The number of the observed plant species belonging to the family m is represented as n.

In the calculation of the median values Cm, Sm, and Rm as the family representative values of the family m, (the coordinates on the CSR triangle represented by) the C value Ci, the S value Si, and the R value Ri of each observed plant species i (i=1, 2, . . . , n) belonging to the family m are converted into xy coordinates (xi, yi) according to Expression (A1).

$$xi = 100 - ( Ci / 2 + Ri ) \qquad ( A1 )$$

$$yi = √ 3 / 2 * Ci$$

Furthermore, the median values xm and ym of the x coordinate xi and the y coordinate yi are calculated according to Expression (A2).

$$xm = median ( \{ x 1 , x 2 , … , xn \} ) \qquad ( A2 )$$

$$ym = median ( \{ y 1 , y 2 , … , yn \} )$$

median( ) represents a median value in parentheses.

The (xy coordinates represented by) median values xm and ym are converted into (coordinates on the CSR triangle represented by) median values Cm, Sm, and Rm as family representative values according to Expression (A3).

$$Cm = 2 / √ 3 * ym \qquad ( A3 )$$

$$Rm = 100 - ( Cm / 2 + xm )$$

$$Sm = 100 - ( Cm + Rm )$$

As described above, the median values Cm, Sm, and Rm as the family representative values can be calculated.

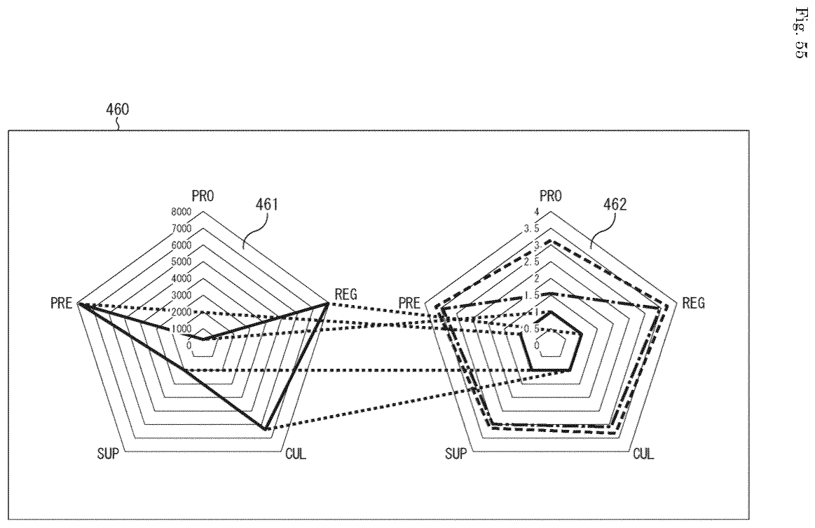

FIG. 54 is a diagram illustrating a third display example of the presentation UI that presents functional diversity.

A presentation UI 450 of FIG. 54 is common to the presentation UI 430 of FIG. 50 and the like in displaying the CSR triangle. However, the presentation UI 450 is different from the presentation UI 430 that displays the CSR triangle plotting the CSR value of the observed plant species as the vegetation survey result on the predetermined survey date in that the presentation UI 450 displays the CSR triangle plotting the locus of the representative value of the CSR value of the observed plant species of the ecosystem of the target unit of survey.

The server 12 calculates the ecosystem representative value for each unit period obtained by dividing the predetermined survey period by using the observed plant species as the vegetation survey result of the predetermined survey period from the terminal 11 and the coverage (individual coverage) of each observed plant species. The ecosystem representative value is a representative value of the CSR value of the observed plant species observed in the unit period in the ecosystem of the target unit of survey.

For example, the server 12 uses the observed plant species as the vegetation survey result for one year from January to December as the survey period and the coverage of each observed plant species, and calculates the ecosystem representative value for each month as the unit period with each month of one year as the unit period.

Further, the server 12 plots the ecosystem representative value of each month as a unit period of one year as a survey period, and generates a CSR triangle in which a locus of the ecosystem representative value in which the ecosystem representative value of each month is connected by a line segment is drawn. The server 12 generates a presentation UI 450 that displays the CSR triangle, and transmits the presentation UI 450 to the terminal 11 for display. The user can designate a survey period or a unit period by operating the terminal 11.

As the ecosystem representative value of the unit period, for example, a statistical value obtained by statistically processing the CSR value of the observed plant species using the coverage of the observed plant species of the unit period can be adopted. The statistical value as the ecosystem representative value of the unit period can be calculated, for example, as follows.

A C value, an S value, and an R value as the ecosystem representative value of the unit period are represented as Cs, Ss, and Rs.

In addition, here, in order to simplify the description, it is assumed that the family m to which the observed plant species observed during the survey period belongs is one of the three families m1, m2, and m3. The C value, the S value, and the R value as the family representative values of the family m #j (j=1, 2, 3) calculated according to Expressions (A1) to (A3) from the observed plant species observed in the month as the unit period are represented as Cm #j, Sm #j, and Rm #j.

The cumulative coverage obtained by accumulating the coverage of the observed plant species belonging to the family m #j among the observed plant species observed on each day of the month d (d=1, 2, . . . , 12) as the unit period over the unit period d is represented as Adm #j. The overall coverage cumulative value obtained by accumulating the cumulative coverage Adm #j of each family m #j in the unit period d over all the families m1, m2, and m3 is expressed as Ad (=Adm1+Adm2+Adm3).

The C value Cs, the S value Ss, and the R value Rs as the ecosystem representative values of the unit period d are calculated according to Expression (A4).

$$Cs = ( Adm 1 / Ad ) * Cm 1 + ( Adm 2 / Ad ) * Cm 2 + ( Adm 3 / Ad ) * Cm 3 \qquad ( A4 )$$

$$Ss = ( Adm 1 / Ad ) * Sm 1 + ( Adm 2 / Ad ) * Sm 2 + ( Adm 3 / Ad ) * Sm 3$$

$$Rs = ( Adm 1 / Ad ) * Rm 1 + ( Adm 2 / Ad ) * Rm 2 + ( Adm 3 / Ad ) * Rm 3$$

According to Expression (A4), (the cumulative coverage Adm #j obtained from) the coverage of the observed plant species is used as the weight of the weighted addition of the family representative value (Cm #j, Sm #j, Rm #j) when the ecosystem representative value (Cs, Ss, Rs) of the unit period d is calculated.

As described above, the server 12 calculates the CSR value (C value Cs, S value Ss, R value Rs) as the ecosystem representative value of each month as the unit period of one year as the survey period. The server 12 plots (points indicating) the ecosystem representative value of each month, and generates a CSR triangle in which a locus of the ecosystem representative value in which the ecosystem representative value of each month is connected by a line segment in a monthly order is drawn. In FIG. 54, a two-digit number represents a month as a unit period.

In FIG. 54, a locus LS1 is an example of a locus of an ecosystem representative value in a case where a place where all the plants on the ground are cut is set as a target unit of survey. A locus LS2 is an example of a locus of an ecosystem representative value in a case where a place shielded from direct sunlight by 70% is set as a target unit of survey. A locus LS3 is an example of a locus of an ecosystem representative value in a case where a place to which no human operation is applied is set as a target unit of survey.

For example, it is presumed that an ecosystem in a place where all the plants on the ground are harvested is an environment in which plant species having a large degree of adopting the ruderal strategy (R) are likely to grow. The locus LS1 of the ecosystem representative value in a case where the place where all the plants on the ground are cut is set as the target unit of survey is positioned closer to the vertex R than the other loci LS2 and LS3, and it is possible to confirm that the ecosystem is in the environment as estimated.

The CSR triangle displayed on the presentation UI 450 expresses (one aspect of) functional diversity of the ecosystem of the target unit of survey.

For example, in a case where an appropriate artificial manipulation is not performed on the ecosystem of the target unit of survey and the functional diversity of the ecosystem is low, it is presumed, in the CSR triangle, that the locus of the ecosystem representative value is located in a place relatively deviated from the center of the CSR triangle.

The user can grasp the degree of functional diversity of the ecosystem of the target unit of survey by the closeness of the locus of the ecosystem representative value to the center of the CSR triangle. For example, the user can grasp that the functional diversity of the ecosystem of the target unit of survey is high by confirming that the locus of the ecosystem representative value is close to the center of the CSR triangle.

Furthermore, according to the presentation UI 450, the user can confirm the transition of the ecosystem representative value for one year as the survey period, and furthermore, the vegetation transition of the plant species adopting the survival strategy that is easy to grow in each season or each month in the ecosystem of the target unit of survey, based on the locus of the ecosystem representative value. The vegetation transition of the ecosystem of the target unit of survey can be used as reference information of an operation (water, sunshine, disturbance, and the like) to be performed on the ecosystem in each season or each month.

The presentation UI 450 is generated using the coverage of the observed plant species in addition to the observed plant species used for generation of the presentation UI 420 and the presentation UI 430. Since the coverage of the observed plant species is input to the presentation UI 410 together with the observed plant species, the presentation UI 450 presenting functional diversity can be easily generated. Therefore, according to the presentation UI 450, the user can easily grasp functional diversity without taking much time and cost.

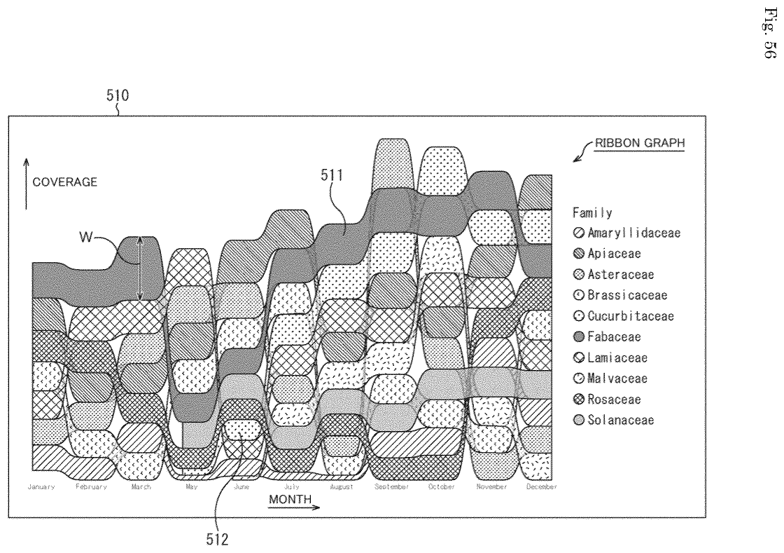

FIG. 55 is a diagram illustrating a fourth display example of the presentation UI that presents functional diversity.

The server 12 calculates a service prediction value obtained by predicting a service intensity indicating a degree to which the ecosystem service is exhibited in the ecosystem of the target unit of survey (a degree of a benefit as the ecosystem service) from the observed plant species as the vegetation survey result of the predetermined survey date from the terminal 11. The server 12 generates a presentation UI 460 for displaying the service prediction value, and transmits the presentation UI 460 to the terminal 11 for display. The user can designate the survey date of the vegetation survey result used to generate the presentation UI 460 by operating the terminal 11.

For example, the server 12 detects a biological species having a biological interaction with the observed plant species by using the interaction information, that is, information in which another biological species having a biological interaction with the biological species for each biological species is associated with the biological interaction, and calculates a value based on the number of the biological species as the service prediction value.

The service prediction value is calculated for each type of the ecosystem service. That is, the ecosystem service includes five types of ecosystem services of a supply service (PRO), an adjustment service (REG), a cultural service (CUL), an infrastructure service (SUP), and a conservation service (PRE). As the service prediction value, a service prediction value of each of the five types of ecosystem services is calculated.

As the service prediction value of the supply service, for example, the number of biological species that can contribute to the supply service is calculated among the biological species (hereinafter, also referred to as an interaction biological species group) obtained by combining the observed plant species and the biological species of the plants and the animals having the biological interaction between the observed plant species. Similarly, as the service prediction value of each of the adjustment service, the cultural service, the infrastructure service, and the conservation service, the number of biological species that can contribute to each of the adjustment service, the cultural service, the infrastructure service, and the conservation service is calculated among the interaction biological species group.

As the survey date (hereinafter, also referred to as “creation survey date”) of the vegetation survey result used to generate the presentation UI 460, one day or a plurality of days can be designated. As the plurality of days, individual days can be designated, or a period including a plurality of consecutive days can be designated.

In a case where one day as the creation survey date is designated, the server 12 calculates the service prediction value of each of the five types of ecosystem services from the observed plant species as the vegetation survey result of the one creation survey date. The server 12 generates a radar chart 461 in which points representing service prediction values of the five types of ecosystem services are plotted and a graph in which the points are connected is drawn. The server 12 generates the presentation UI 460 that displays the radar chart 461. In the radar chart 461, PRO, REG, CUL, SUP, and PRE represent the supply service, the adjustment service, the cultural service, the infrastructure service, and the conservation service, respectively. The same applies to the radar chart 462 described later.

In a case where a plurality of days as the creation survey dates are designated, the server 12 calculates the service prediction value of each of the five types of ecosystem services for each of the plurality of creation survey dates. In addition, the server 12 selects one of the plurality of creation survey dates as a reference date serving as a reference for comparison. The reference date can be designated by the user operating the terminal 11. The server 12 generates a radar chart 461 in which points representing service prediction values of the five types of ecosystem services for the reference date are plotted and a graph in which the points are connected is drawn.

Further, for each of the plurality of creation survey dates, the server 12 calculates a ratio (ratio value) of the service prediction value for the creation survey date with the service prediction value for the reference date as a reference (1) for each type of ecosystem service. The server 12 generates a radar chart 462 in which points representing the ratio of the service prediction value of each of the five types of ecosystem services for each of the plurality of creation survey dates are plotted and a graph in which the points are connected is drawn. In the radar chart 462, the ratio of the service prediction value of each of the five types of ecosystem services for the reference date is 1.0.

Then, the server 12 generates the presentation UI 460 that displays the radar chart 461 and the radar chart 462.

In the presentation UI 460 of FIG. 55, the radar chart 461 and the radar chart 462 are displayed. Furthermore, in FIG. 55, a point indicating the service prediction value of the ecosystem service for the reference date indicated in the radar chart 461 and a point indicating the ratio of the service prediction value of the ecosystem service for the reference date indicated in the radar chart 462 are connected by a broken line in order to facilitate understanding of the correspondence relationship.

Three graphs are drawn in the radar chart 462 of FIG. 55, and thus, three days corresponding to the three graphs are designated as the creation survey dates.

The radar chart 461 displayed on the presentation UI 460 expresses (one aspect of) functional diversity of the ecosystem of the target unit of survey.

For example, in a case where an appropriate artificial operation is not performed on the ecosystem of the target unit of survey and functional diversity of the ecosystem is low, it is presumed that the graph drawn on the radar chart 461 has a shape greatly collapsed from the regular pentagon.

The user can grasp the degree of functional diversity of the ecosystem of the target unit of survey by the shape of the graph drawn on the radar chart 461. For example, the user can grasp that the functional diversity of the ecosystem of the target unit of survey is high by confirming that the graph drawn on the radar chart 461 is relatively close to the regular pentagon.

Furthermore, according to the radar chart 462 displayed on the presentation UI 460, the user can grasp the degree of change in the service intensity of the ecosystem service of the creation survey date other than the reference date with the service intensity of the ecosystem service of the reference date as a reference. Therefore, according to the radar chart 462, for example, in a case where the user introduces a new plant species on a day after the reference day in the ecosystem of the target unit of survey and designates the day as one day of the generation survey day, the user can grasp the degree of change in the service intensity of the ecosystem service caused by (one of) the introduction of the new plant species.

Since the presentation UI 460 that presents the functional diversity is generated using the observed plant species similarly to the presentation UI 420 and the presentation UI 430, the user can easily generate the presentation UI 460 by observing at least the plant species growing in the ecosystem of the target unit of survey in the vegetation survey. Therefore, according to the presentation UI 460, the user can easily grasp functional diversity without taking much time and cost.

### <Presentation UI Presenting Time Series of Vegetation Survey Result>

FIG. 56 is a diagram illustrating a display example of a presentation UI that presents a time series of vegetation survey results.

The server 12 calculates a total value of vegetation survey results of a predetermined survey period from the terminal 11 for each unit period obtained by dividing the predetermined survey period. The server 12 generates a presentation UI 510 that displays the total value for each unit period in time series, and transmits the presentation UI 510 to the terminal 11 for display. The survey period and the unit period can be designated, for example, by the user operating the terminal 11.

For example, using the observed plant species as the vegetation survey result for one year from January to December as the survey period and the coverage of each observed plant species, the server 12 calculates the total value of the coverage for each family for each month as the unit period with each month of one year as the unit period.

That is, for each month as a unit period, for each family to which the observed plant species observed in the month belongs, the server 12 adds the coverages observed in the month of the observed plant species belonging to the family, thereby calculating the total value of the coverages for each family.

The server 12 generates a ribbon graph in which the total value of the coverage for each family for each month as the unit period is arranged in the order of the month as the unit period, and generates the presentation UI 510 that displays the ribbon graph.

In the ribbon graph displayed in the presentation UI 510 of FIG. 56, the horizontal axis represents time, that is, a time series of months (January, February, . . . , December) as a unit period in the survey period, and the vertical axis represents (a total value of) the coverage.

One ribbon of the ribbon graph represents a time series of total values of coverages of the observed plant species belonging to one family. For example, in FIG. 56, a ribbon 511 is a ribbon of Fabaceae representing a time series of the total value of the coverage of the observed plant species belonging to the cucurbitaceous family, and a ribbon 512 is a ribbon of the fabaceous family representing a time series of the total values of the coverages of the observed plant species belonging to the cucurbitaceous family.

In the ribbon graph, the width (thickness) W of each ribbon represents the total value of the coverages. In the ribbon graph, since the ribbons are arranged in the vertical direction in the order of the length of the width, the widest ribbon, that is, the ribbon having the largest total value of the coverage is located at the top in each month.

According to the presentation UI 510 in which the ribbon graph as described above is displayed, the user can grasp the transition of the seasonal characteristics such as the family to which the plant species growing in the ecosystem of the target unit of survey belongs and the configuration of the family, and can use the grasped information as a reference of the vegetation strategy.

For example, in the ribbon graph of FIG. 56, the ribbon 511 of the fabaceous family is positioned relatively high throughout the period of one year as the survey period. Therefore, for example, in a case where stable harvest throughout the year is required in the ecosystem of the target unit of survey, the user can determine that it is desirable to adopt a vegetation strategy that prioritizes the plant species belonging to the fabaceous family.

In addition, for example, in the ribbon graph of FIG. 56, the ribbons 512 of the cucurbitaceous family rapidly increase from June to September, and thereafter, are stabilized at a high level until December. Therefore, for example, the user can set up a vegetation strategy in which the plant species belonging to the cucurbitaceous family is harvested from October to December in which (the total value of) the coverages is high in the ecosystem of the target unit of survey. In addition, for example, in order to harvest plant species belonging to the cucurbitaceous family from October to December, the user can employ a vegetation strategy of sowing plant species belonging to the cucurbitaceous family and introducing seedlings from March to April before June when a rapid increase in coverage starts.

In the presentation UI 510, in addition to displaying a ribbon graph of one survey period, ribbon graphs of a plurality of survey periods can be arranged and displayed simultaneously. For example, the presentation UI 510 can display a ribbon graph for one year of this year and a ribbon graph for one year of last year, display a ribbon graph for the past three years (this year, last year, year before last) including this year, and the like.

According to the presentation UI 510, it is possible to prompt the user to compare the ribbon graph of this year (one year) with the ribbon graph of last year (one year) and consider the change in the environment of the ecosystem of the target unit of survey.

For example, in the ribbon graph displayed on the presentation UI 510, in a case where the ribbon of a predetermined family rapidly increases in the ribbon graph of last year but does not increase in the ribbon graph of this year, it is possible to give an opportunity for the user to consider how the temperature, the precipitation, and the like of the ecosystem of the target unit of survey have changed between last year and this year as a cause of such change.

As described above, the user can consider the change in the environment of the ecosystem of the target unit of survey and use the consideration for determining the plant species to be introduced into the ecosystem in the future. For example, in a case where the user grasps that the precipitation in the ecosystem has decreased by considering the change in the environment of the ecosystem of the target unit of survey, the user can determine to introduce a plant species resistant to dryness.

In FIG. 56, the coverage of the observed plant species is used to generate the ribbon graph, but other vegetation survey results can be used to generate the ribbon graph. For example, the yield of the plant species (harvested plant species) harvested in the ecosystem of the target unit of survey can be adopted to generate the ribbon graph. In this case, for example, the server 12 uses (the species name of) the harvested plant species as the vegetation survey result for one year from January to December as the survey period and the yield of each harvested plant species, and calculates the total value of the yield for each family for each month as the unit period with each month of one year of the survey period as the unit period. Then, the server 12 generates a ribbon graph in which the total value of the yield for each family for each month as the unit period is arranged in the order of the month as the unit period.

Note that which vegetation survey result is used to generate the ribbon graph can be designated by the user operating the terminal 11, for example.

The processing performed by the computer in accordance with the program described herein may not necessarily be performed chronologically in the order described as the flowcharts. In other words, the processing performed by the computer in accordance with the program also includes processing that is performed in parallel or individually (e.g., parallel processing or processing by objects).

Furthermore, the program may be a program processed by one computer (processor) or may be distributed and processed by a plurality of computers. Furthermore, the program may be sent to a remote computer to be executed.

Moreover, in this description, a system means a set of a plurality of components (including devices and modules (parts)) regardless of whether all the components are contained in the same casing. Accordingly, a plurality of devices accommodated in separate casings and connected via a network and one device in which a plurality of modules are accommodated in one casing both constitute systems.

Embodiments of the present technology are not limited to the above-described embodiment, and various modifications can be made within the scope of the present technology without departing from the essential spirit of the present technology.

For example, the present technology may be configured as cloud computing in which a plurality of devices shares and cooperatively processes one function via a network.

In addition, each step described in the above flowchart can be executed by one apparatus or executed in a shared manner by a plurality of apparatuses.

Furthermore, in a case where a plurality of processes is included in one step, the plurality of processes included in the one step can be executed by one device or can be shared and executed by a plurality of devices.

The advantageous effects described in the present specification are merely exemplary and are not limited, and other advantageous effects may be achieved.

Note that the present technology can relate to at least the goal 1 “No Poverty”, the goal 2 “Zero Hunger”, the goal 13 “Climate Action”, and the goal 15 “Life on Land” among the goals of the SDGs (Sustainable Development Goals) adopted at the UN summit in 2015.

Synecoculture (registered trademark) used in the present technology makes it possible to cultivate plants by controlling ecosystems so as to promote biological diversity and withstand climate change caused by natural disasters such as drought and sediment disaster. In addition, it is possible to increase a fixed amount of a greenhouse gas (GHG) in order to create a state in which plants are mixed densely, and further, it is possible to contribute to reduction of an emission amount of a greenhouse gas without using a fertilizer or a pesticide.

The present technology can be configured as follows.

<1>

An information processing device including:
an evaluation unit that evaluates, based on a plurality of the index values relating to soil or organisms at a predetermined time point of a predetermined target place and a plurality of the index values at a time point later than the predetermined time point, a transition degree of the index values.

<2>

The information processing device according to <1>, in which
the target place is a place where attention management that is predetermined ecosystem management is performed, and
the evaluation unit evaluates the transition degree, based on an attention index value which is the index value at an attention time point in a period in which the attention management is performed and a pre-transition index value which is the index value at a pre-transition time point in a period in which pre-transition management which is ecosystem management immediately before transition to the attention management is performed.

<3>

The information processing device according to <2>, in which
the evaluation unit evaluates the transition degree, based on distribution of the attention index values and distribution of the pre-transition index values.

<4>

The information processing device according to <3>, in which
the evaluation unit evaluates the transition degree, based on one or both of a difference degree between centers of distribution of the attention index values and distribution of the pre-transition index values and a difference degree between variations of distribution of the attention index values and distribution of the pre-transition index values.

<5>

The information processing device according to <3> or <4>, in which
the evaluation unit evaluates the transition degree, based on an immediately preceding index value before transition, which is the index value at a time point within a period in which ecosystem management immediately before the pre-transition management is performed.

<6>

The information processing device according to <5>, in which
the evaluation unit evaluates the transition degree, based on whether distribution of the pre-transition index values is different from distribution of the immediately preceding index values before transition.

<7>

The information processing device according to <6>, in which
the evaluation unit:
evaluates, when distribution of the pre-transition index values is different from distribution of the immediately preceding index values before transition, the transition degree, based on both a difference degree between centers and a difference degree between variations of distribution of the attention index values and distribution of the pre-transition index values; and
evaluates, when distribution of the pre-transition index values is not different from distribution of the immediately preceding index values before transition, the transition degree, based on a difference degree between variations of distribution of the attention index values and distribution of the pre-transition index values.

<8>

The information processing device according to any one of <3> to <7>, in which
the evaluation unit specifies distribution of the pre-transition index values, based on a land use history of a land use method for the target place.

<9>

The information processing device according to <3>, in which
the evaluation unit evaluates the transition degree, based on distribution of target index values which is the index value aimed in the attention management.

<10>

The information processing device according to <9>, in which
the evaluation unit evaluates the transition degree, based on a distance between centers of distribution of the attention index values and distribution of the target index values, and a distance between centers of distribution of the attention index values and distribution of the pre-transition index values.

<11>

The information processing device according to <3>, in which
the evaluation unit evaluates the transition degree, based on the attention index value and the pre-transition index value of each of a plurality of sections set in the target place.

<12>

The information processing device according to <11>, in which
the evaluation unit evaluates the transition degree, based on one or both of distribution of index average values which are average values of the index values of the sections and distribution of index deviations which are standard deviations of the index values of the sections.

<13>

The information processing device according to any one of <3> to <12>, in which
the evaluation unit evaluates the transition degree by a statistical test.

<14>

The information processing device according to <2> or <3>, in which
the evaluation unit evaluates the transition degree for each of a plurality of sections set in the target place, based on the attention index value and the pre-transition index value.

<15>

The information processing device according to any one of <1> to <14>, further including:
another evaluation unit that evaluates a fertilizer removal stage of the target place, based on a plant species observed in the target place or a yield of a crop.

<16>

The information processing device according to <15>, further including:
a combination unit that combines the transition degree and the fertilizer removal stage and calculates a new transition degree.

<17>

The information processing device according to <15> or <16>, further including:
a vegetation strategy unit that generates a vegetation strategy of the target place, based on a fertilizer removal stage of the target place.

<18>

The information processing device according to any one of <1> to <17>, further including:
a generation unit that generates a presentation user interface (UI) that presents the transition degree.

<19>

An information processing method including:
evaluating a transition degree of index values, based on a plurality of the index values relating to soil or organisms at a predetermined time point of a predetermined target place and a plurality of the index values at a time point later than the predetermined time point.

<20>

A program for causing a computer to function as an evaluation unit that evaluates a transition degree of index values, based on a plurality of the index values relating to soil or organisms at a predetermined time point of a predetermined target place and a plurality of the index values at a time point later the predetermined time point.

### REFERENCE SIGNS LIST

10 Information processing system
11-1 to 11-4 Terminal
12 Server
13 DE
14 Network
21 Communication unit
22 Computation unit
23 Input/output unit
24 Storage
25 Positioning unit
26 Sensor unit
31 Communication unit
32 Computation unit
33 Input/output unit
34 Storage
41 Acquisition unit
42 Evaluation unit
43 Generation unit
51 Distribution estimation unit
52 Comparison unit
72 Evaluation unit
80 Index information acquisition unit
81 Distribution estimation unit
92 Evaluation unit
110 Index information acquisition unit
111 Distribution estimation unit
112 Comparison unit
121 Evaluation unit
131 Vegetation profile generation unit
132 Similarity calculation unit
133 Stage determination unit
141 Evaluation unit
151 Yield profile generation unit
152 Similarity calculation unit
153 Stage determination unit
161 Combination unit
170 Index information acquisition unit
171 Distribution estimation unit
172 Test unit
173 Normalization combination unit
192 Evaluation unit
211 Vegetation strategy unit
310, 320, 330 Presentation UI
410 Presentation UI
411 Photographing button
412 Overall coverage display unit
412A Slide bar
412B Menu button
413 Sort button
414 Individual coverage display unit
415 Add button
416 Status display unit
420, 430, 450, 460 Presentation UI
461,462 Radar chart
511,512 Ribbon

1. An information processing device comprising:
an evaluation unit that evaluates, based on a plurality of the index values relating to soil or organisms at a predetermined time point of a predetermined target place and a plurality of the index values at a time point later than the predetermined time point, a transition degree of the index values.

2. The information processing device according to claim 1, wherein
the target place is a place where attention management that is predetermined ecosystem management is performed, and
the evaluation unit evaluates the transition degree, based on an attention index value which is the index value at an attention time point in a period in which the attention management is performed and a pre-transition index value which is the index value at a pre-transition time point in a period in which pre-transition management which is ecosystem management immediately before transition to the attention management is performed.

3. The information processing device according to claim 2, wherein
the evaluation unit evaluates the transition degree, based on distribution of the attention index values and distribution of the pre-transition index values.

4. The information processing device according to claim 3, wherein
the evaluation unit evaluates the transition degree, based on one or both of difference degree between centers of distribution of the attention index values and distribution of the pre-transition index values and a difference degree between variations of distribution of the attention index values and distribution of the pre-transition index values.

5. The information processing device according to claim 3, wherein the evaluation unit evaluates the transition degree, based on an immediately preceding index value before transition, which is the index value at a time point within a period in which ecosystem management immediately before the pre-transition management is performed.

6. The information processing device according to claim 5, wherein
the evaluation unit evaluates the transition degree, based on whether distribution of the pre-transition index values is different from distribution of the immediately preceding index values before transition.

7. The information processing device according to claim 6, wherein
the evaluation unit:
evaluates, when distribution of the pre-transition index values is different from distribution of the immediately preceding index values before transition, the transition degree, based on both a difference degree between centers and a difference degree between variations of distribution of the attention index values and distribution of the pre-transition index values; and
evaluates, when distribution of the pre-transition index values is not different from distribution of the immediately preceding index values before transition, the transition degree, based on a difference degree between variations of distribution of the attention index values and distribution of the pre-transition index values.

8. The information processing device according to claim 3, wherein
the evaluation unit specifies distribution of the pre-transition index values, based on a land use history of a land use method for the target place.

9. The information processing device according to claim 3, wherein
the evaluation unit evaluates the transition degree, based on distribution of target index values which is the index value aimed in the attention management.

10. The information processing device according to claim 9, wherein
the evaluation unit evaluates the transition degree, based on a distance between centers of distribution of the attention index values and distribution of the target index values, and a distance between centers of distribution of the attention index values and distribution of the pre-transition index values.

11. The information processing device according to claim 3, wherein
the evaluation unit evaluates the transition degree, based on the attention index value and the pre-transition index value of each of a plurality of sections set in the target place.

12. The information processing device according to claim 11, wherein
the evaluation unit evaluates the transition degree, based on one or both of distribution of index average values which are average values of the index values of the sections and distribution of index deviations which are standard deviations of the index values of the sections.

13. The information processing device according to claim 3, wherein
the evaluation unit evaluates the transition degree by a statistical test.

14. The information processing device according to claim 2, wherein
the evaluation unit evaluates the transition degree for each of a plurality of sections set in the target place, based on the attention index value and the pre-transition index value.

15. The information processing device according to claim 1, further comprising:
another evaluation unit that evaluates a fertilizer removal stage of the target place, based on a plant species observed in the target place or a yield of a crop.

16. The information processing device according to claim 15, further comprising:
a combination unit that combines the transition degree and the fertilizer removal stage and calculates a new transition degree.

17. The information processing device according to claim 15, further comprising:
a vegetation strategy unit that generates a vegetation strategy of the target place, based on a fertilizer removal stage of the target place.

18. The information processing device according to claim 1, further comprising:
a generation unit that generates a presentation user interface (UI) that presents the transition degree.

19. An information processing method comprising:
evaluating a transition degree of index values, based on a plurality of the index values relating to soil or organisms at a predetermined time point of a predetermined target place and a plurality of the index values at a time point later the predetermined time point.

20. A program for causing a computer to function as an evaluation unit that evaluates a transition degree of index values, based on a plurality of the index values relating to soil or organisms at a predetermined time point of a predetermined target place and a plurality of the index values at a time point later than the predetermined time point.
